(19) United States
(12) Patent Application Publication
(10) Pub. No.: US 2016/0004958 A1
(43) Pub. Date: Jan. 7, 2016

(54) Digital quaternary fractal computer for applications of artificial intelligence

(71) Applicant: Lawrence Byng, Kahului, HI (US)

(72) Inventor: Lawrence Byng, Kahului, HI (US)

(21) Appl. No.: 14/714,364

(22) Filed: May 18, 2015

Related U.S. Application Data
(60) Provisional application No. 62/019,443, filed on Jul. 1, 2014.
(60) Provisional application No. 62/019,889, filed on Jul. 2, 2014.
(60) Provisional application No. 62/021,017, filed on Jul. 4, 2014.
(60) Provisional application No. 62/021,095, filed on Jul. 4, 2014.
(60) Provisional application No. 62/021,213, filed on Jul. 7, 2014.
(60) Provisional application No. 62/038,364, filed on Aug. 18, 2014.

(51) Int. Cl. G06N 3/063; G06N 99/00

(52) U.S. Cl. CPC G06N 3/063; G06N 99/005; G06N 99/002

(57) ABSTRACT

A digital quaternary fractal computer unit, system and method for applications of artificial intelligence. The digital quaternary fractal computer comprises optical, nano-scale and quantum embodiments. The system of computation is unique to the device and employs relativistic, quaternary and fractal mechanisms to perform computation. The full theory of relative quaternary fractal computation and encoding is documented in the various references herein.

Several methods are also disclosed which evolved out of, and help enhance, the various embodiments. It is emphasized that this abstract is provided to enable a searcher to quickly ascertain the subject matter of the technical disclosure and is submitted with the understanding that it will not be used to interpret or limit the scope or meaning of the claims.

### CROSS-REFERENCE TO RELATED PROVISIONAL APPLICATIONS

This application claims priority benefit of provisional U.S. Patent Application Ser. No. 62/019,443, entitled BYNG FRACTAL COMPUTER ARCHITECTURE, filed on Jul. 1, 2014, which application is hereby incorporated by reference in its entirety, including all Figures, Tables, and Claims.

This application claims priority benefit of provisional U.S. Patent Application Ser. No. 62/019,889, entitled BYNG FRACTAL CPU, filed on Jul. 2, 2014, which application is hereby incorporated by reference in its entirety, including all Figures, Tables, and Claims.

This application claims priority benefit of provisional U.S. Patent Application Ser. No. 62/021,017, entitled BYNG FRACTAL HYPER COMPUTER, filed on Jul. 4, 2014, which application is hereby incorporated by reference in its entirety, including all Figures, Tables, and Claims.

This application claims priority benefit of provisional U.S. Patent Application Ser. No. 62/021,095, entitled BYNG FRACTAL N-DIMENSIONAL HYPER COMPUTER, filed on Jul. 4, 2014, which application is hereby incorporated by reference in its entirety, including all Figures, Tables, and Claims.

This application claims priority benefit of provisional U.S. Patent Application Ser. No. 62/021,213, entitled BYNG FRACTAL COMPUTER REFINEMENTS, filed on Jul. 7, 2014, which application is hereby incorporated by reference in its entirety, including all Figures, Tables, and Claims.

This application claims priority benefit of provisional U.S. Patent Application Ser. No. 62/038,364, entitled BYNG FRACTAL COMPUTER REFINEMENTS, filed on Aug. 18, 2014, which application is hereby incorporated by reference in its entirety, including all Figures, Tables, and Claims.

### DESCRIPTION

Before describing the various aspects of the fractal computer unit, system and method, some introductory concepts and terminology are explained.

The term “signal channel” is used herein to describe a device or medium that conducts data signals using electricity or light or a combination of electricity and light. Typically said device can be an electrical wire or an optical fiber.

The term “signal channel intersection” is used herein to describe the precise location where two perpendicular signal channels intersect. The perpendicular signal channels at the intersections are not connected together directly.

The term “switch” as used herein, describes a device that allows signals of only one polarization to pass from the input of the device to the output of the device. A switch can be fabricated from a number of devices that match this functional description including, an electronic transistor device or functional equivalent or an FGMOSFET device or functional equivalent or an optical transistor.

The term “phase shifter” as used herein, describes a device that takes signals from an input signal channel, shifts said signals by a time delay equal to a certain phase of the operational frequency of said phase shifter and then outputs the shifted signals to an output signal channel.

The term “phase switch” as used herein, describes a device that allows signals that have different phases of a single polarization to pass from the input of the device to the output of the device. A phase switch can be fabricated from a number of devices that match this functional description including, an electronic transistor device or functional equivalent or an FGMOSFET device or functional equivalent or an optical transistor. Optionally at least one terminal of said switch is connected to at least one phase shifter device.

The term “Fractal Computer Unit” or “FCU” as used herein, describes a device that has all of the functionality of a computer that processes information according to a fractal computation method.

The terms “Fractal” and “Fractally” as used herein, describe devices, methods, processes and data signals that form a self similar structure across different scales (spatial) and/or frequencies (temporal).

The terms “Fractal data” as used herein, describe the structure of a data signal that can be self similar at different frequencies. Said data signal is usually in the form of a burst of data of varying duration.

The terms “Fractal circuit” as used herein, describes the structure of a set of computationally related phase switch devices that form a self similar spatial pattern at different scales.

The terms “trunk information potential” as used herein, describes the structure of a set of computationally related phase switch devices that have a relatively low trigger threshold.

The terms “branch information potential” as used herein, describes the structure of a set of computationally related phase switch devices that have a relatively high trigger threshold.

The term “may” is used in a permissive sense (i.e., meaning having the potential to), rather than the mandatory sense (i.e., meaning must).

The terms “include”, “including”, and “includes” mean including, but not limited to.

The term “Comprising” is open-ended and does not foreclose additional structure or steps.

The following terms are taken directly from the theory of fractal computation published by the inventor of the present invention. A reference to this thesis of the inventor is provided in the literature references herein. A short summary of some essential terms as they relate to the present invention is provided as follows:

The term “alpha” and α describes a positive polarization signal, process or device type.

The term “beta” and β describes a negative polarization signal, process or device type.

The term “principal” as used herein, describes an inclusive or additive component, signal, process or device type.

The terms “context” or “delta” or δ describes an exclusive or subtractive component, signal, process or device type.

The terms “alpha”, “beta”, α,β are frequently paired with the terms “principal”, “context”, “delta” or δ. When the terms “alpha”, “beta”, α,β are used individually without reference to a paired term, the term “principal” is implied by omission. When there is a pairing of terms such as “delta alpha”, δα, “delta beta”, δβ or “beta context” or “alpha principal”, the meaning is as specified.

A “signal channel” is defined herein as a means for propagating a data signal along a path. Said data signal can be either a digital data signal an analog wave signal or a combination of the two. Signal channel can be formed from many materials. The list of materials comprising, electrical wires, optical fiber, microwave waveguide, space medium though which light propagates such as a vacuum, and a crystal lattice.

A topological surface is a topological space in which every point has as open neighborhood homeomorphic to some open subset of the Euclidean plane Ê2. Such a neighborhood, together with the corresponding homeomorphism, is known as a coordinate chart. It is through this chart that the neighborhood inherits the standard coordinates on the Euclidean plane. These coordinates are known as local coordinates and these homeomorphisms lead us to describe surfaces as being locally Euclidean.

The term “Two dimensional manifold surface quadrilateral mesh” is abbreviated to a surface quadrilateral mesh. A planar quadrilateral (PQ) mesh is a special case of surface quadrilateral mesh.

The term “x axis”. In this description, an x contour of a surface quadrilateral mesh is equivalent to an x axis in locally Euclidean terminology. The term x axis in the description refers to both cases; the surface mesh x contour and the euclidean x axis.

The term “y axis”. In this description, a y contour of a surface quadrilateral mesh is equivalent to a y axis in locally Euclidean terminology. The term y axis in the description refers to both cases; the surface mesh y contour and the euclidean y axis.

The term “z axis”. In this description, a z contour of a surface quadrilateral mesh is equivalent to a z axis in locally Euclidean terminology. The term z axis in the description refers to both cases; the surface mesh z contour and the euclidean z axis.

### FIELD OF THE INVENTION

The present invention relates to systems, devices and methods for the fractal computation. More specifically, the invention comprises the specifications for the new fractal computer units (FCU), systems and methods to optionally replace a conventional computer's CPU, memory and data routing. The FCU comprises CPU, memory and routing capabilities in one unit, forming a fully functional fractal computing unit. For the purposes of clarity, any references to a fractal computer are to be understood to comprise references to a fractal computer unit or FCU, a fractal computer system and a fractal computation method.

### BACKGROUND OF THE INVENTION

### Description of the Related Art

The state of the relevant prior art relates to the area of artificial intelligence, or more specifically the areas of artificial brains, machine learning and related computer architectures. Artificial brain and machine learning technologies, can be broadly speaking divided into two schools: the first represented by the latest manifestations of neural networks known as ‘deep learning’ such as the Google brain project and a second represented by the brain chips inspired by biological systems and operating on a principle of ‘spiking neurons’, such as the the IBM Brain chip from the Synapse project developed jointly by IBM and DARPA. A closely closely related aspect of the brain chips relates to new computer architectures that are different from the conventional Von Neumann computer architecture that has formed and continues to form the basis of all modern day computers and computer systems.

Deep learning has its roots in ‘neural networks’ that date back about sixty years to the late nineteen-fifties. Deep learning was formed when in 2006, Geoff Hinton made an important advance with a new technique that allowed neural networks to be divided into layers. This was achieved by combining data inputs from one layer of a neural network into an input of an adjacent layer wherein each input has different weights and functions applied to them. The very narrow area of static image recognition is an area where deep learning has had some limited success in the form of convoluted neural networks or CNNs. Similarly, natural language processing has achieved some success through the use of recurrent neural networks or RNNs. Although any advance in these areas are greatly hyped by the press, the reality of what can be achieved using these techniques is still limited. The much publicized Google system that learned to recognize cats for example, worked about seventy percent better than its predecessors but was still only able to recognize less than a half of the objects on which it was specifically trained and it did even worse when the objects were rotated or moved to the left or to the right of an image. There has been much criticism of deep learning techniques in particular that the approach is not based on any theory and essentially manifests as a black box that performs processing to match inputs with pre-trained data. Most of the confirmations of this approach are done empirically rather than theoretically. There are also other limitations. Deep learning methods are not able to reliably recognize or sort objects when the set of possibilities is large. The IBM Watson computer is another example. The IBM Watson computer was famously used to compete against human competitors in the game of ‘Jeopardy’ and actually won the competition. This was widely publicized as a major breakthrough however, the reality is that deep learning was used as only part of a large set of computational techniques. Other problems relate to the need for extensive training data, NLP has not progressed to the point where natural language is understood. Image recognition simulations require vast amounts of processing power such as vast banks of computers or even a large power hungry supercomputers to perform the software simulations of the neural networks. This is very inefficient compared to the biological equivalent system like the brain, which can perform similarly but using much less power. Other limitations of this technology are caused when very small and insignificant perturbations in the input signal can cause huge changes in output classification and cause the neural network to incorrectly classify the inputs. Such techniques lack ways of representing causal relationships and have no obvious ways of performing logical inferences and are not able to integrate abstract knowledge.

Brain chips are in general a derivation of ‘neuromorphic’ computing which either use neural network technology as described above, or a system based on ‘spiking’ neurons. The European union is pursuing neuromporphic computing in a big way. One example is the billion euro Human Brain Project (HBP). However, according to Steve Furber, a scientist from the university of Manchester in the UK, “The European sense is that this whole area is still held back because the basic principles of operation in the brain are still a mystery, and if only we could crack that, then we′d make giant leaps forward”. These ambitious neuromorphic projects are idealized abstractions of the biological brains. The neuromorphic projects typically track ‘spikes’ the short pulses that carry information between the biological neurons. None of the new chips reproduce the detailed spikes found in the biological systems. The state of the art assumes that only the timing of spikes is important. Also these chips do not use a clock signals to coordinate the interaction of signals of the chip. This limits the throughput of data across the bus. In addition, versions of these chips such as the IBM brain chip ‘true north’ does not have the ability for on chip learning. The spiking neuron approach has only approximated a processing method using the notion of a spike in the broadest of contexts and has not demonstrated significant advancement over other technologies. The concept of spiking neurons itself is somewhat a generalized concept and is not the result of any new computation theory and cannot be described as a theory. ‘spiking neurons’ are essentially only an observed aspect. Indeed after researching the theoretical basis of both neural networks and brain chip technology it is apparent that these devices are not the result of theoretical basis of how the brain works but are instead largely the result of trial and error from one incarnation to another with empirical results guiding the way forward. Although this approach has has some success, it will not lead to a radically new method of computation. Indeed Einstein famously remarked “A theory can be proved by experiment, but no path leads from experimentation to the birth of a new theory.”. The state of the art is and will remain limited by this fundamental lack of theoretical basis. This is evident from the limited success of the implementations based on of these technologies.

With regards to the related area of computer architectures, the Von Neumann architecture is the predominant computer architecture at present. However this architecture relies on a logic core and operates sequentially on data fetched from memory via a data bus. This architecture leads to what has famously been referred to as the Von Neumann bottleneck, which places a limit on how much data can be moving around from memory to CPU by the data bus at any given time. This is a fundamental limiting constraint of the architecture and to move beyond this constraint, a new architecture is needed. In contrast ‘neuromorphic’ computing distributes both computation and memory among an enormous number of relatively primitive ‘neurons’. Each neuron communicating with hundreds of thousand of other neurons using ‘synapses’. Carver Mead of the California Institute of technology who coined the term ‘neuromorphic’ computing has recognized the enormous energy stinginess of biological computing as one objective for neuromorphic computing. Most of the energy used in conventional computing is from the overhead of moving charge and transporting data between memory and CPU. The new chips such as the IBM brain chip and the Neurogrid from Stamford university require programming with the use of corelets or ‘neural compilers’. The same is true for another similar chip from a project at Qualcomm. They are developing a ‘neural core processor’ called ‘zeroth’ which will require teams of developers to write the applications that run on these chips. Much of the focus appears to be on how to scale these devices which at present is limited.

The prior art is a conventional computer system built on the Von Neumann architecture. In this model, memory data and routing are handled separately by separate components connected via a data bus. This creates limitation on the scalability, performance and efficiency on the computers built from this architecture. Additionally the Von Neumann architecture, even allowing for a vast array of highly complex software simulations, has suffered from an inability to effectively process certain types of data that humans are instinctively able to process with ease. Specifically natural language and vision are two areas where conventional technology, even after many decades of research by the brightest minds on the planet, have failed to provide a mechanism, system or method that allows these types of information to be processed as effectively and to the same degree as humans.

As is evident from the above, there are many limitation of the current state of the art technology in these technology areas.

### SUMMARY OF THE INVENTION

The above limitations have been overcome by a fractal computer device, system and method of the present invention. A summary of these is herein described.

Over approximately the last thirty five years, the inventor has perfected the techniques for AI complete or strong AI. This is encompassed in revolutionary new fractal computational theory for AI complete problems that is both original and unique. This end to end theory provides the formal solution basis for the complete array of AI challenges and problems, including natural language understanding, vision, audition, problem solving, learning, reasoning and knowledge. Natural language and image recognition using fractal computation techniques are provided as specific examples. These are often given as the two most phenomenally complex tasks for AI, the solving of which forms the definition of AI complete of strong AI. The Fractal computing device, system and method of the present invention are novel and innovative embodiments enabling AI complete. The full theory of the invention is contained in the referenced thesis detailed at the end of this summary. A full definition is not included in this description so as not to obscure the present invention.

The theory was developed to represent knowledge, reasoning, thought processes and natural language understanding and has been extended to encompass vision and hearing. The two main challenges in the area of AI complete comprising vision and natural language, have been theoretically solved with this revolutionary fractal computation theory. The theory is formed from a few basic principles. With these basic principles and solutions for these two phenomenally difficult problems in hand, the broad range of AI challenges are now seen as derivatives of these core principles of this the new theory. The detailed solutions are described in my books and thesis. All references area provided at the end of this summary. The present invention is an embodiment of this theory. The theoretical basis for the general concepts of the fractal computer system, unit and method was set forth in a thesis entitled “Human Thought Modeling. A Model Based Approach to Machine Intelligence” by the inventor Lawrence Byng, submitted for publication via ebook on May 20, 2014. Although this thesis presented the theoretical underpinnings for a fractal computation system, device and method, with the exception of the provisional patents incorporated by reference herein, heretofore no one has solved the technical problems associated with such a computational device, system and method in practice.

To help illustrate the innovative and novel aspects of the present invention, the following is a high level example of AI complete as applied to the case of computer vision. This example provides a high level overview of the main aspects of the fractal device, system and method of the present invention.

Data is input in the form of a fractally encoded set of waves. All the data points in the fractally encoded data are relative to each other in the sense of time. In this regard, the input data provides a time based or temporal aspect. The data waves propagate through the computing device which serves as the spatial aspect. Together these form a spatio-temporal computer. Phase waves interact with the data waves creating interference patterns. These interference patterns are distributed across a grid of signal channels and fractal computing components. The grid modulating these patterns is now a virtual grid defined by two variable phase waves. This virtual grid has two delimiters defining the domain of the computation, each delimiter represented by one of the variable phase waves. The first delimiter sets the maximum resolution for a pattern definition, while the second delimiter sets the maximum resolution for the holes in the image or distribution pattern of the first set of patterns. For simplicity of explanation the following is an oversimplified illustration: think of an image as comprised of dots and holes. The image is formed by a dot and a hole in which to place this dot. At a very simple level, the dot and the hole defines the image. Now lets expand this so that the dot can be a simple pattern and the holes can be a pattern of holes distributed around the image. Now we might have four simple patterns that will fit inside any of four points of the distribution pattern. The maximum resolution of both the patterns and the distribution of these patterns can be varied by the relevant phase wave. Another key aspect in this example is that each part of the pattern is defined relative to its neighboring points (including across scale) at the resolution of the pattern. This is encoded in a fractal hierarchical data format as a pattern. The data pattern will have a fractal tree representing it and the distribution pattern will also have a fractal tree representing it. A picture can now be defined by two fractal data trees: one for the pattern and one for the pattern distribution. At any step the resolution of these trees can be enhanced or reduced by modifying the variable phase waves. The lower resolution data trees will form part of all higher resolution data trees. This provides further form in the fractal structure of the data. The fractal encoding of these fractal data trees is then processed by signal channel intersections in a circuit. The parts of a pattern that occur most frequently form definition as a fractal trunk information potential 442. This is the result of emergent behavior from repeated concurrence of the input patterns with the fractal signal channel intersections forming the circuits of the computer. An entire set of images can now be defined as two pattern trees each of which has emerged from the repeated presence of patterns relative to a point. The point is not defined in the pattern trees, it can be anywhere on the picture. The pattern tree is relative to this point. This trunk information potential 442 will grow to represent the frequently occurring parts of the patterns both for the pattern definition as well as the distribution pattern definition. Think of this fractal trunk information potential 442 as a potential. A solution is defined as the completion of a circuit between two defined points or signal channel intersections on the grid. When the trunk information potential 442 or potential completes a circuit, a solution (a pattern match) has been found. It is very important to remember that at all times, the points in the patterns at all scales are relative to each other. Or in other words relative to a point in the pattern. This forms the basis of a fovea based image recognition system. In such a system, the extra resolution provided by the fovea serves to enhance resolution of an already defined set of patterns. When the patterns are large and complex, the patterns can be broken up into smaller fragments. These fragments can form individual components in the fractal data tree.

### Quaternary Instruction Set

A central part of this fractal computation system is the quaternary counting system which is used as the basis of the quaternary data format and quaternary computation systems and quaternary fractal methods and instruction set. The quaternary data format is both relative and fractal and I have coined the term relative quaternary fractal encoding or RQF encoding for short to describe this data format. The instruction set of the fractal computer comprises primarily four different types of switch 205 components. Two main polarity types of α,β (alpha and beta) and two process modifier types of principal and context which attach to the main types. When the process modifier attaches to the main polarity type, this is denoted as δα,δβ (delta alpha or alpha context and delta beta or beta context). When only the main polarity type is present without the process modifier type, this denotes the principal α,β (alpha principal, beta principal). Within these four main types there are four phase subtypes which determine how the inputs are to combine depending on the phases of the inputs. For each matches of a given type and subtype, there can be many variants with each variant responding to a different input frequency combination.

### Fractal Computing Device and System

The fundamental component or building block of the fractal computer is the phase switch 206. There are two main types one for each of the principal polarization types α,β. There are two subtypes one for each of the context process types δα,δβ. This forms essentially only four component primitives which are connected at the intersections of signal channels on a grid. Each switch 205 acts as a complete computer in its own right by providing all the required functions of memory, CPU and signal routing from input to output in a single component or hybrid component. A phase switch 206 is referred to as a fractal computing unit or FCU and is the building block for the fractal computer. The FCU will route an input data signal from input to output if the FCU and data signal match in four respects. These four aspects are: location, wave frequency, wave phase and polarization. Processing is coordinated across a plurality of computational units by a phase clock. A fractal computation unit will take on a different appearance depending on where it is being referenced from and during which part of the phase of the system processing it is being referenced. This forms the basis of a relativistic computation model. The FCUs can be scaled in an unlimited manner leading to an essentially infinite scaling capability for the fractal computer. This allows the creation of scalable computers and architectures that allow the computation devices to be linked together in greater and greater, even unlimited numbers to create vastly powerful computational systems. To achieve this, each FCU unit can be tiled together to form larger groups that function as a single FCU unit. For example one FCU unit could be built from four smaller FCU units arranged in a two by two grid.

### Fractal Method

In accordance with an aspect of the present invention, there is provided a method of processing comprising the steps of:

a) setting the adjustable phase clock frequency.
b) enabling the wave propagation components.
c) providing an input data signal to an input signal channel.
d) the signal interacting with at least one switch 205 as well as the phase clock signal, thus allowing data to flow onto an output signal channel.
e) the data flowing through the switch 205 forms a data wave which propagates outward in four directions from the location of the switch 205 and across the grid of signal channels.
f) when the input and output signal match to a predefined pulse pattern and location, this completes a circuit between the input and output signal channels and allows current or light to flow as a pulse from input to output signal channel or vice versa. Said current or light is a programming pulse that increases the threshold or charge in the polarization component which affects gate sensitivity or threshold.
g) over a period of time, multiple successful matches of input data with expected results will further increase the charge in the polarization component, which will eventually lead to the permanent formation of an on switch 205 in said polarization component. This switch 205 now forms part of the fractal computation mechanism and can be utilized by the playback system.

### Fractal Pattern Matching

The programming model employs the techniques of concurrence and emergence to create a fractal data processing structure. The data processing structure achieves its fractality in part by virtue of the fact that it is able to recognize patterns in the input data regardless of their spatial scale or frequency scale (harmonic frequency basis). That is not to say that all processing is always scale independent, but the fractal computer is able to tune its ability to process both scale independently as well as based on scale using the variable phase waves. This tuning ability allows processing to traverse a computational fractal space and circuit. Scale independent processing is referred to as scale agnostic. The scale agnostic processing is at the basis of the self similarity concept of fractals. In fact the definition of a fractal is that it is self similar at different scales. It matters not if these scales are time scales as in frequency or spatial scales. The fractal computer uses both as aspects of a spatio-temporal computing device. In general the fractal computer will look for patterns in the input data that match or are a close match with existing patterns. Processing will reuse the part of the fractal structure that matches and can define new instance specific structure for the particular instance being processed by defining a new context.

### Fractal Circuit

Each part of the circuitry can be used many times by multiple different fractal circuits in the same fractal computer to perform completely different tasks. All that is required is a slight modification to the fractal circuity context to accommodate a completely new function based on the processing within this new context of the fractal circuit. A fractal circuit is considered to be the combination of a collection of signal channels and switches 205 which are used in conjunction with the fractal data signals. There are two components to the fractal circuit that for the potential, the trunk information potential 442 and the circuit stem. The trunk information potential 442 is a circuit that is frequently used and has formed the basis of many computation in the past for the fractal computer. It has ‘emerged’ as a potential for future computations. In the case when a trunk information potential 442 is not able to find the complete solution or complete pattern match, the trunk information potential 442 can be extended with a branch information potential 443. The branch information potential 443 provides instance specific extensions to the trunk information potential 442 allowing completion of the circuit. Multiple such completions of circuits using the same trunk information potential 442 and branch components over a period of time, will eventually program the branch information potential 443 to become a trunk information potential 442. In this way the potential gradually expands and forms the basis of learned experience. This is the mechanism of learning and it happens automatically and intrinsically from the effects of concurrence and emergence in the fractal computer.

On Chip Learning. Self Programming

The actual mechanics of the programming also happen automatically in the form of adjustments to conductivity in the internal switch 205ing components of the fractal computer. The principal of concurrence is one of the main components of this mechanism. That is to say that if two pieces of data frequently appear at the same location in the same time phase, they are remembered by the computer and begin to form the basis of a information potential 441 or fractal program within the fractal computer. This takes the form of a fractal circuit. Programming occurs when an expectation in the form of a location and a wave pulse matches with the processed data signal location and wave pulse. When this occurs in the learning phase, a programming pulse is routed through the components that generated the output signal and in the process reinforces the links involved in the computation. The programming pulse is divided evenly among all phase switches 206 in the fractal circuit. The emergent effects of this favor the most efficient structures containing the least number of phase switches 206 that produce the result.

Parallelism Solved

The fractal computer also provides an intrinsic solution to the problems relating to parallelism, namely how to divide a program into components that con be performed in parallel and how to synchronize these without running into race conditions. This is done automatically and without the need to write and program complex programs into the computer to perform these tasks. This happens intrinsically as part of the computation and self learning or self programming system. An aspect of this massive parallelism is facilitated by a phase clock and data signal channels that are able to channel data in a number of different phases as well as the use of multiple frequencies facilitating enormous data throughput and processing signal channel intersection independence while using shared data signal channels.

General Computing Platform

The fractal computational mechanism is flexible and can perform a diverse range of tasks and has a wide range of capabilities including natural language understanding, vision, audition, problem solving, learning, reasoning and knowledge. These capabilities are enabled by the fractal computation method employed by the fractal computer. The fractal computer method forms the basis of a system of logic from which the internal program structures in the fractal computer are defined. The program structures are the fractal circuits. These fractal circuits can also be programmed with fractal computation algorithms from an external source or preprogrammed to perform predefined tasks.

### Optimizations

Size, power, speed and scaling optimizations. The small number of core components allows for a high degree of optimization for density or size, low power consumption as well as speed. In conjunction with the minimal instruction set, the logic operation of these core components facilitate the massive parallelism in the architecture. In addition, the hardware provides a computing platform for the ‘native’ or in hardware processing of human language and vision, as well as other human brain function such as learning, problem solving and understanding. The full specifics of these mechanisms as well as the minimal instruction set and logic design are included in the fractal computation thesis written by the inventor referenced herein. The full specifics are not included so as not to obscure the invention.

Most of the energy used by a conventional computer is related to moving the data around from memory to CPU and back again. The only data moving though the fractal computer and data bus are the fractally encoded data signals from inputs and fractal encoded data signal outputs. The mapping from input data signal to processing and back is direct without many intermediate steps. The only step would be a short switch 205ing delay and a phase delay for the purpose of matching inputs and providing properly phased coherent outputs. This delay is a fraction of the wavelength period of the operating frequency of the phase switch 206. In some instances, the phase switch 206 used to route the signals acts as a memory cell. In the FCU, memory and CPU are combined. These aspects reduce the power requirements for operating the FCU. With lower power consumption, the constraints relating to frequency scaling that are present in the power hungry conventional computer architectures are removed. The FCU can thus be operated with a fraction of the power used in a conventional computer and use maximum frequencies higher than possible with conventional computers. The FCU architecture is radically different from the conventional Von Neumann architecture. Conventional computer architecture separates CPU and memory components in a computer and connects these together using a data bus. This architecture has been proven to be very effective for conventional processing techniques. With the combining of memory and CPU into a single unit in the fractal computer, the FCU and fractal computer architecture have removed one of the most significant roadblocks to scaling known as the Von Neumann bottleneck. Although a conventional CPU can be used to perform complex fractal processing, doing this with conventional CPU technology has a cost in terms of computer speed as the CPU does not function fractally. Using conventional computer architecture, the complex mathematical equations and processing techniques required to perform fractal processing have to be emulated in computer software. Although this can be done, doing this in conventional computer architecture has a cost in term of computer speed. The present invention provides these powerful and sophisticated fractal capabilities in hardware with the new fractal computer architecture. This provides speed improvements by performing powerful and sophisticated fractal processing in hardware within the FCU itself.

### Flexible Construction Techniques

The fractal computer can be constructed from off the shelf components including, electrical wires, and VLSI circuit integration technology. It can be constructed from optical components such as optical fibers, periodically polled crystals, optical lasers and other fiber optic devices. The fractal computer can use either alternating current electricity, polarized light or digital electrical signals or digital light techniques. The input and output signal channels can be connected to other components in the computer, to sensor and output devices, to conventional computers, devices and interfaces as well as other components and devices presently invented or otherwise. The computer can also be constructed at the atomic scale using atomic scale components and effects. A fractal computational mechanism that can be constructed from quantum scale components utilizing quantum effects, such an embodiment of the present invention may indeed be possible in the form of a deterministic quantum computer or Bohmian computer. The fabrication technology for such a device, even after many decades of research and development, is however still in its infancy. Once this technology has matured and has been adequately developed, a quantum implementation of the fractal computation mechanism may be the most powerful mechanism by which computation can be achieved with these devices.

### High Level Construction Overview

The internal organization of the system is formed by groups of signal channels oriented perpendicular to each other forming a grid. The grid is comprised of a first group of signal channels and a second group of signal channels. Each signal channel can conduct or transfer data signals comprising one or more frequencies and one or more polarities. Said first group of signal channels is comprised of one or more signal channels oriented in the same direction or parallel with respect to other signal channels in said first group of signal channels. Said second group of signal channels is comprised of one or more signal channels oriented in the same direction or parallel with respect to other signal channels in said second group of signal channels. Said first group of signal channels and said second group of signal channels are oriented perpendicular to each other so that each and every signal channel in said first group of signal channels is oriented perpendicular to each and every signal channel in said second group of signal channels. There is an internal phase clock which connects to all signal channels of both groups and transmits the phase signal from the phase clock to each of the signal channels simultaneously. Data signals flow along the signal channels of the grid where they can interact with components connected to the signal channels at the signal channel intersections. There are clusters of components formed at each intersection of perpendicular signal channels on the grid. These clusters contain a mixture of α,β,δα,δβ components that respond at different frequencies, different polarities and different phase combinations. Generally data is input on one signal channel and output to another signal channel. There are three main modes of operation. Firstly a ‘learning’ mode, comprising the grid, one or more wave propagation devices at the signal channel intersections and the phase clock. Said wave propagation device is comprised of one or more phase switches 206. Said phase switch 206 is comprised of a switch 205 component such as a transistor component or functional equivalent thereof and one or more phase shift components such as a resistor capacitor pair or functional equivalent thereof, each phase shift component is connected to one or more terminals of said transistor component. Said phase clock comprising both positive and negative data signals of regular frequency.

Embodiments of the subject matter and the functional operations described in this specification can be implemented in analog electronic circuitry, digital electronic circuitry, analog optical devices, digital optical devices or as a hybrid of analog, digital, electronic and optical devices, including the structures disclosed in this specification and their structural equivalents, or in combinations of one or more of them. Further background information related to the present invention can be found in the following references:

[1] Lawrence Byng. Amazon Publication No. ASIN B00KGKFHPC entitled “Human Thought Modeling. A Model Based Approach to Machine Intelligence”, the inventor, Lawrence Byng describes a method whereby language, thought and problem solving can be performed using a system of fractal computation.

[2] Lawrence Byng. Amazon Publication No. ASIN: B00L094ZRE entitled “Human Thought Modeling. Blueprint for a human mind”, the inventor, Lawrence Byng describes a method whereby language, thought and problem solving can be performed using a system of fractal computation.

[3] Lawrence Byng. Amazon Publication No. ASIN: B00MLU1BAU entitled “Studies in Fractal Computation Theory: Fractal Vision”, the inventor, Lawrence Byng describes a method whereby vision can be performed using a system of fractal computation.

[4] Lawrence Byng. Amazon Publication No. ISBN: 1503035433/EAN13:9781503035430 entitled “The Fractal Hyper Computer”, the inventor, Lawrence Byng describes a method whereby audition can be processed using a system of fractal computation.

These and other objects of the present invention will become apparent to those of ordinary skill in the art from an examination of the specification, accompanying drawings, and appended claims. It is to be understood that both the foregoing general description and the following detailed description are explanatory and are not restrictive of the invention as claimed.

### BRIEF DESCRIPTION OF THE SEVERAL VIEWS OF THE DRAWINGS

The present invention may take form in various components and arrangement of components and in various steps and arrangement of steps. The drawings are only for purposes of illustrating a preferred embodiment and are not to be construed as limiting the invention.

Embodiments of the present invention will now be described in relation to the accompanying drawings in which:

FIG. 1A shows two waves of alternating polarity.

FIG. 1B shows two different switches 205 in two different states.

FIG. 2 shows eight alpha components for the alpha phase and the beta phase.

FIG. 3 shows eight beta components for the alpha phase and the beta phase.

FIG. 4A shows eight frequency doublings with the lowest frequency at the base and each higher frequency above that.

FIG. 4B shows eight frequency doublings with the highest frequency at the base and each lower frequency above that.

FIG. 5A shows a large surface quadrilateral mesh 64 used by the FCU components.

FIG. 5B shows a zoomed in portion of the surface quadrilateral mesh 64 showing that the signal channels forming the X and Y axes are not connected.

FIG. 6 shows the alternating arrangement of signal channels forming a surface quadrilateral super mesh.

FIG. 7 shows an alternative surface quadrilateral mesh 64 arrangements showing an additional surface quadrilateral mesh 64 arranged at 45 degrees with respect to the first and second.

FIG. 8A shows a data signal comprising three component waveforms

FIG. 8B shows a first adjacent pair of waveforms.

FIG. 8C shows a second adjacent pair of waveforms

FIG. 9A shows the signals used to represent a data pattern.

FIG. 9B shows a first pair of waveforms

FIG. 9C shows a second pair of waveforms

FIG. 10A Shows a further representation of the parts of the wave present for a data signal shown filled in black

FIG. 10B shows the data tree represented by this data

FIG. 11A shows the arrow used to represent the alpha signal propagation.

FIG. 11B shows the arrow used to represent the beta polarization signal propagation.

FIG. 11C shows a section of the surface quadrilateral mesh 64

FIG. 12 shown the arrangement of phase switches 206 the data wave propagation.

FIG. 13A shows an alternative embodiment using electronic components to do the data wave propagation.

FIG. 13B shows an alternative embodiment using electronic components to do the data wave propagation.

FIG. 14 shows a logical representation of the phase shift oscillators with their connection to the surface quadrilateral mesh 64.

FIG. 15A shows four FCU components connected with four data buses.

FIG. 15B shows four FCU components that are adjacent and connected using optimally short data bus connections.

FIG. 15C shows the A and B type FCUs tiled in a six by two layout. In this example, all twelve FCUs form a single larger FCU.

FIG. 16A shows four FCUs in an alternative arrangement using a central data bus as well as four side buses.

FIG. 16B shows a configuration of 2 FCU components joined by two data buses.

FIG. 16C shows the configuration of FIG. 16B arranged fractally at different scales in a nested and fractal configuration.

FIG. 17 shows four FCU components comprising a spheroid. In the illustration, the spheroid has been flattened out from top to bottom so that the individual components can be seen.

FIG. 18 shows the side view of the spheroid component.

FIG. 19A shows a spheroid with tiled A and B components forming a uniform tiling.

FIG. 19B shows a tubular arrangement of type A and type B components.

FIG. 20 shows three fractal computer systems arranged together.

FIG. 21 shows the four switches 205 in combination with the phase shift components.

FIG. 22A shows the type A and type B switches 205.

FIG. 22B shows the phase shifters.

FIG. 22C shows the switch 205 and phase shifters connected to form a phase switch 206.

FIG. 23 shows how the different signals are extracted from the surface quadrilateral super mesh.

FIG. 24 shows the fixed phase clock signal.

FIG. 25 shows the variable phase clock signal.

FIG. 26 shows the connections to the quadrilateral super mesh

FIG. 27 shows the components used in the phase switch 206.

FIG. 28A shows a detailed principal phase switch.

FIG. 28B shows a detailed context phase switch.

FIG. 29 shows the principal component and the context component connected together to form a pair.

FIG. 30 shows the phase switch 206 components stacked in a group of four layers.

FIG. 31 shows a group of phase switches 206 connected throughout a super mesh.

FIG. 32 shows a single phase switch 206 with three gate signals,

FIG. 33 shows the three connection points connected to the signal channels of the surface quadrilateral super mesh 84.

FIG. 34 shows a simple data signal.

FIG. 35 shows two data signals.

FIG. 36 shows a single signal comprising two adjacent waves.

FIG. 37 shows a single data signal comprising three adjacent waves.

FIG. 38 shows two more data signals.

FIG. 39 shows two oppositely polarized signals having wave components of the same frequency.

FIG. 40 shows a more complex pair of data signals

FIG. 41 shows two polarized components

FIG. 42A shows the two variable phase waves.

FIG. 42B shows two data signals propagating through a sequence of nine signal channels on one of the axes of the surface quadrilateral super mesh 84.

FIG. 42C shows the effect of the variable phase wave with respect to the surface of the surface quadrilateral super mesh 84.

FIG. 43 shows the arrangement of the information potential and the trunk, branch, principal and context potentials.

FIG. 44 shows a hexahedron super mesh formed from three surface quadrilateral super mesh 84.

FIG. 45 shows two X,Y surface quadrilateral super meshes 84 being coupled together.

FIG. 46 shows two X,Z surface quadrilateral super meshes 84 being coupled together.

FIG. 47 shows two Y,Z surface quadrilateral super meshes 84 being coupled together.

FIG. 48 shows a higher level view of the hexahedron super mesh.

FIG. 49 shows the rotation of the signals forming the principal components.

FIG. 50 shows the rotation of the signals forming the context components.

FIG. 51 shows the alpha phase switch 213 of the four dimensional spatio-temporal fractal computer represented as atoms or quantum scale components with an up spin.

FIG. 52 shows the beta phase switch 214 of the four dimensional spatio-temporal fractal computer represented as atoms or quantum scale components with a down spin.

REFERENCE NUMERALS IN THE DRAWINGS

| | | | |
|---|---|---|---|
| | | 2 | alpha component of wave |
| 3 | beta component of wave | 4 | principal component of |
| | | | wave |
| 5 | context component of wave | 6 | alpha switch |
| 7 | beta switch | | |
| 11 | PNP transistor | 12 | NPN transistor |
| 13 | positive gate polarity | 14 | negative gate polarity |
| 23 | input signal | 24 | gate signal |
| 25 | output signal | | |
| 33 | phase shift component | | |
| 41 | group of frequency | 42 | individual frequency |
| | doublings | | |
| 61 | signal channel | 62 | data bus |
| 63 | signal channel intersection | 64 | surface quadrilateral mesh |
| 81 | first surface quadrilateral | 82 | second surface quadrilateral |
| | mesh | | mesh |
| 83 | third surface quadrilateral | 84 | surface quadrilateral super |
| | mesh | | mesh |
| 101 | wave of frequency f | 102 | wave of frequency f × 2 |
| 103 | wave of frequency f × 4 | 104 | alpha polarization |
| 105 | beta polarization | 106 | wave alpha component of |
| | | | signal |
| 107 | wave beta component of | | |
| | signal | | |
| | | 110 | alpha quaternary data bit |
| 111 | beta quaternary data bit | | |
| 121 | alpha propagation symbol | 122 | beta propagation symbol |
| 123 | data signal origin | | |
| | | 128 | phase shift oscillator |
| 129 | propagation unit connection | | |
| | point | | |
| 141 | alpha FCU (type A) | 142 | beta FCU (type B) |
| 143 | compound FCU (type AB) | 144 | central data bus |
| 145 | side data bus | 146 | lower density bus |
| 147 | higher density bus | 148 | first data bus |
| 149 | second data bus | 150 | FCU |
| 161 | top of flattened spheroid | 162 | bottom of flattened |
| | | | spheroid |
| 163 | lateral cross section | 164 | longitudinal cross section |
| 165 | first end | 166 | second end |
| | | 168 | un-flattened spheroid |
| 181 | first system | 182 | second system |
| 183 | third system | 184 | frequency multiplier/divider |
| | | 186 | clock |
| 201 | alpha principal phase | 202 | beta principal phase switch |
| | switch | | |
| 203 | alpha context phase switch | 204 | beta context phase switch |
| 205 | switch | 206 | phase switch |
| 207 | 90′ phase shift | 208 | 180′ phase shift |
| 209 | 270′ phase shift | | |
| 221 | first polarizer | 222 | second polarizer |
| 223 | alpha signal | 224 | beta signal |
| 225 | delta alpha signal | 226 | delta beta signal |
| 241 | clock signal | 242 | first fixed phase wave |
| 243 | second fixed phase wave | 244 | first fixed phase signal |
| 245 | second fixed phase signal | 246 | third fixed phase signal |
| 247 | fourth fixed phase signal | 248 | fifth fixed phase signal |
| 249 | sixth fixed phase signal | 250 | seventh fixed phase signal |
| 251 | eighth fixed phase signal | 252 | first clock phase shift |
| 253 | second clock phase shift | | |
| 261 | first variable phase wave | 262 | second variable phase wave |
| 263 | first variable phase signal | 264 | second variable phase signal |
| 265 | third variable phase signal | 266 | fourth variable phase signal |
| 267 | fifth variable phase signal | 268 | sixth variable phase signal |
| 269 | seventh variable phase | 270 | eighth variable phase signal |
| | signal | | |
| 271 | first frequency divider | 272 | second frequency divider |
| 281 | modulator | 282 | demodulator |
| 283 | carrier wave signal | | |
| 285 | low pass filter | 286 | high pass filter |
| 287 | notch filter | 288 | threshold amplifier |
| 289 | detailed principal phase | 290 | detailed context phase |
| | switch | | switch |
| 301 | first phase switch signal | 302 | second phase switch signal |
| | channel | | channel |
| 303 | third phase switch signal | 304 | fourth phase switch signal |
| | channel | | channel |
| 305 | phase switch pair | | |
| 321 | first layer | 322 | second layer |
| 323 | third layer | 324 | fourth layer |
| 341 | first gate signal | 342 | second gate signal |
| 343 | third gate signal | | |
| 361 | first phase switch | 362 | second phase switch |
| | connection point | | connection point |
| 363 | third phase switch | | |
| | connection point | | |
| | | 386 | time axis |
| 387 | wave amplitude/polarity | 388 | first wave function |
| | axis | | |
| 389 | second wave function | 390 | conforming wave equation |
| 391 | 0′ wave phase | 392 | 90′ wave phase |
| 393 | 180′ wave phase | 394 | 270′ wave phase |
| 401 | phase difference | 402 | wave period |
| 403 | first polarization | 404 | second polarization |
| | function | | function |
| 405 | first polarized half wave | 406 | second polarized half wave |
| 407 | first full wave | 408 | second full wave |
| 421 | signal channels along a | 422 | first strobe induced signal |
| | first axis | | |
| 423 | second strobe induced | 424 | third strobe induced signal |
| | signal | | |
| 425 | fourth strobe induced | 425 | first time slice |
| | signal | | |
| 426 | second time slice | 427 | third time slice |
| 428 | fourth time slice | | |
| 441 | information potential | 442 | trunk information potential |
| 443 | branch information | 444 | trunk principal potential |
| | potential | | |
| 445 | trunk context potential | 446 | branch principal potential |
| 447 | branch context potential | | |
| 461 | XY surface quadrilateral | 462 | XZ surface quadrilateral |
| | mesh | | mesh |
| 463 | YZ surface quadrilateral | 464 | XYZ signal channel |
| | mesh | | intersection |
| 465 | hexahedron mesh | 466 | data bus side of adjoining |
| | | | mesh |
| 481 | first rotation | 482 | second rotation |
| 483 | spin up | 484 | spin down |

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

As will be appreciated by someone skilled in the art, aspects of the present invention may be embodied as a system, a device or a method. Accordingly, aspects of the present invention may take the form of an entirely hardware embodiment, an entirely software embodiment (including firmware, resident software, micro-code) or an embodiment combining software and hardware aspects that may all generally be referred to herein as a “circuit”, “module”, “device”, “system”. Furthermore, aspects of the present invention may take the form of a computer program product embodied in one or more computer readable medium(s) having computer readable program code embodied thereon. Said computer readable mediums including but not limited to, storage medium, hard disk, CDROM, random access memory (RAM), read only memory (ROM), Electronically alterable memory (EAROM), Electronically programmable memory (EPROM), or any combination thereof

Herein, various embodiments of the present invention are provided in the form of a fractal computing system, a fractal computing unit and a fractal computing method.

For the purposes of clarity, different aspects of the preferred embodiments are detailed under capitalized section headings in the following description, to help assist with referencing the various aspects of the present invention. The detailed description starts with the individual components and builds these into the higher level components and structure forming the fractal computer. Finally the detailed description of the fractal computation method is provided.

### Quaternary

The fractal computing unit, system and method of the present invention use a quaternary or base 4 counting system. For the purpose of explaining the invention, the four unique states are denoted by the greek letters alpha, beta, delta alpha and delta beta. These four states apply to many aspects of the present invention including the data format, data signals, the processing states of the components, the clock states and signal channel states.

In accordance with this quaternary number system, In an exemplary embodiment, there are four basic function types. These four function types are derived from a combination of two polarization types and two logic or processing types. The two polarization types comprise a first polarization and a second polarization opposite to said first polarization. These are known as the alpha and beta polarization types respectively. Further there are two component types an alpha and a beta. Each of these has two processing types comprising a first processing type for inclusive processing, and a second processing type for exclusive processing. These are referred to as the Principle type and the Context type respectively. These four basic function types are combined together to form the four basic components types. These are, Alpha Principal, Alpha Context, Beta Principal and Beta Context. These four basic component types are the building blocks of the fractal computer unit, system and method. An alpha fractal computation unit (A type FCU) comprises alpha principal and alpha context components. A beta fractal computation unit (B type FCU) comprises beta principal and beta context components. A combination type fractal computation unit (AB type FCU) comprises and alpha principal component, an alpha context component, a beta principal and a bet context component.

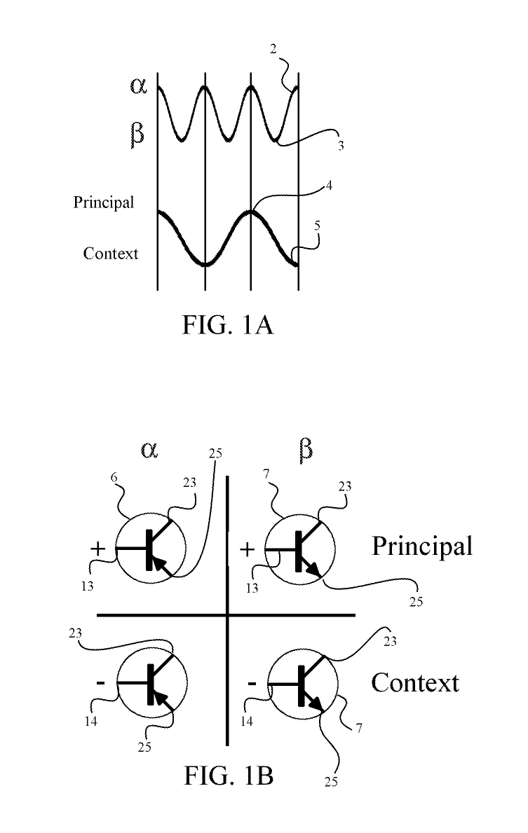

FIG. 1A shows two waves of alternating polarity. A single wave can represent either alpha and beta or principal and context. When the waves are used in combination at different frequencies, the four types can be represented. The first wave shows how alpha 2 and beta 3 are represented by the polarization of the wave 1. Alpha 2 being the positive part of the wave and beta 3 being the negative part. Principal 4 corresponds to the positive part of the wave and context 5 to the negative part.

FIG. 1B shows two different switches 205 in two different states. In the example, a transistor symbol 11,12 is used to represent the switches 205. The first is a PNP transistor 11 with a positive gate polarity 13. This corresponds to an Alpha principal component 6. The second is an NPN transistor 12 with a positive gate polarity 13. This corresponds to a Beta Principal 7. The third is a PNP transistor 11 with a negative base polarity 14. This corresponds to an alpha context. The fourth is an NPN 12 transistor with a negative base polarity 14. This corresponds to a beta context.

In another embodiment, the Alpha type comprises any of the following individually or in combination: a) a positive voltage, b) the positive part of a data pulse in the form of waveform signal, c) a transistor with a positive voltage emitter (PNP). The Beta type comprises any of the following individually or in combination: a) a negative voltage, b) the negative part of a data pulse in the form of a waveform signal, c) a transistor with a negative voltage emitter (NPN). The principal type comprises any of the following individually or in combination: a) a positive voltage at the base of the transistor, b) a high pass filter function in the phase shift components. The context type comprises any of the following individually or in combination: a) a negative voltage at the base of the transistor, b) a low pass filter function in the phase shift component.

Alternatively the four component types can be combined into a single component type able to channel signals in one polarization, another, or both or none. Similarly with a positive or negative gate polarization and with a high pass or lo pass function or even a notch filter function.

In another embodiment, The Alpha type comprising any of the following individually or in combination: a) polarized light of a first polarization, b) the part of a data signal comprising a light pulse of said first polarization, c) an optical switch equivalent of a transistor with an emitter of said first polarization. The Beta type comprising any of the following individually or in combination: a) polarized light of a second polarization which is opposite to said first polarization, b) the part of a data signal comprising a light pulse of said second polarization, c) a light switch equivalent of a transistor with an emitter of said second polarization. The Principle type comprising any of the following individually or in combination: a) the light equivalent of a transistor having said first polarization at the gate of said light equivalent of a transistor, b) a high pass filter function in the light equivalent of the phase shift components. The Context type comprises any of the following individually or in combination: a) the light equivalent of a transistor having said second polarization at the gate of said light equivalent of a transistor, b) a low pass filter function in the light equivalent of the phase shift components.

### Fractal Layout

Fractal computer units (FCUs) can be laid out in a fractal hierarchy of components. For example an FCU comprising two smaller FCUs can be combined with another FCU comprising two smaller FCUs to create a larger single FCU. This nesting of FCUs inside other FCUs is in theory unlimited. This creates a highly scalable and extensible physical architecture to the fractal computer system. In such configurations, the FCUs can be adjacent to each other or they can be separated by vast distances. The FCUs are considered part of the same system if any part of a signal or any whole signal or any combination thereof is transmitted from a first FCU and received by a second FCU.

### Polarization

The fractal computer is built from the two FCU types. A first FCU type functions in accordance with a first polarization. A second FCU types functions in accordance with a second polarization that is opposite to said first polarization. The fractal system must have both types present to function. These FCUs can be orderly distributed in a tiled lattice comprising FCUs of the same type. Alternatively the FCUs can be orderly distributed in a tiled lattice comprising FCUs of alternating type or indeed any regularly repeating pattern or sequence of repeating patterns of alternating types. Alternatively the FCUs can be distributed in an unordered manner. The essential feature is that the fractal computer has at least one of each FCU type along each of its two axes of operation. Each axis corresponding to the orientation of the X and Y grid of signal channels.

Processing. Principal and Context

There are two Principal type FCU components and two context type FCU components. The two principal type FCU components are known as alpha principal and a beta principal. The two context type FCU components are known as alpha context and a beta context.

A principal component comprising a switch 205 and a phase shift component of a given frequency, functions by allowing input data signals from an input signal channel that are contained within a given time length to propagate through the polarizing switch 205 onto an output signal channel. Said principal component functions in an inclusive manner with respect to signals. In this regard, said principal component allows all said data comprising frequencies of double or multiples thereof, to be transmitted from said input signal channel to said output signal channel. This functionality is in essence a high pass filter for all data frequencies of double the signal channel intersection frequency or multiples thereof.

A context component comprising a switch 205 and a phase shift component of a given frequency, functions by excluding all input data signals from an input signal channel that are contained within a given exclusion time length while allowing other signals outside said exclusion time length to propagate through said polarizing switch 205 onto an output signal channel. Said context component functions in an exclusive manner with respect to data comprising said input data and said output data. In this regard, said context component allows all said data comprising frequencies of half or multiples thereof of said signal channel intersection frequency given by the equation 1/(2ⁿ) where n is an integer and n≧1, to be transmitted from said input signal channel to said output signal channel while excluding those of the signal channel intersection frequency or above. This functionality is in essence a low pass filter for all data frequencies of half the signal channel intersection frequency or multiples thereof.

Alternatively a notch filter can be used for both the principal and the context phase switches 206. As the processing is sequential from one frequency doubling to the next, the data comprising the current operating frequency only needs to be filtered out from the data passed through the phase switch 206. As more switches 205 are traversed, the notch will form a wider band of frequencies comprising all those frequencies that match frequencies of processed data from the incoming data signal.

### Alpha Phase and Beta Phase

Processing has two phases, an alpha phase and a beta phase. During each phase, different combinations of components can interact. The two phases repeat back and forth continuously. The rate at which the phases alternate is controlled by a clock. The clock will typically run at a high frequency of over 3Ghz for high speed computation, although the clock can theoretically run at any speed.

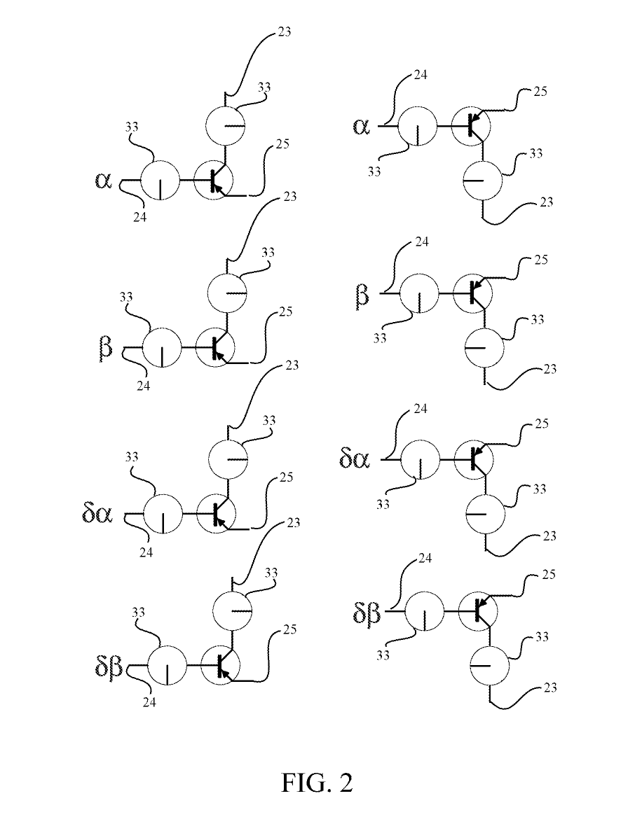

FIG. 2 shows eight alpha components for the alpha phase and the beta phase. Principal and context components are shown. Each component has two different inputs and an output. A first input 23 is for the data signal and second input 24 that receives an interference signal. The interference signal is a combination of clock signals and delayed data signals. The data signals are delayed with a phase shift component 33 that acts as a delay relative to a frequency. When the switch is in the active state, input signals are routed to the output 25.

### Eight Beta Types

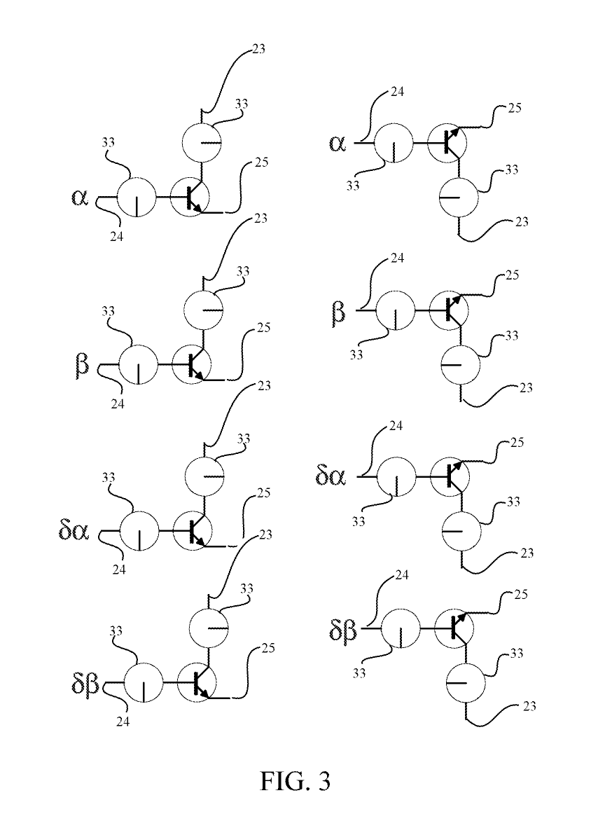

FIG. 3 shows eight beta components for the alpha phase and the beta phase. Principal and context components are shown. Each component has two different inputs. A first input is for the data signal and second input that receives an interference signal. The interference signal is a combination of clock signals and delayed data signals. Alpha and beta components differ in the polarization between the input signal and the output signal. Alpha components have a first polarization while beta components have a second polarization. A complete set of alpha and beta components comprises 16 individual components. These can be divided into two groups functionally and physically. The groups are differentiated by the polarization. Consequently this leads to three physical embodiments: an alpha only unit (A type FCU) comprising 8 components, a beta only unit (B type FCU) comprising 8 components, or an alpha beta unit (AB type FCU) that comprises all 16 components.

### Eight Doublings

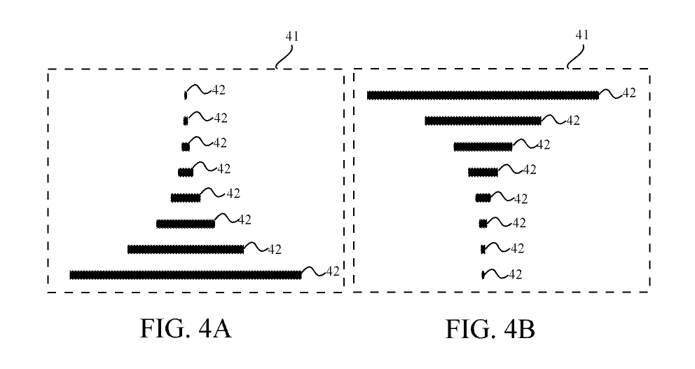

In the previous example, the alpha and beta types related to a single frequency. Although a fractal computer could be constructed from a single layer of components operating at a single frequency, typically, the fractal computer will be constructed from layers of components each layer having a different operating frequency. Each operating frequency 42 is a double or halving from the nearest adjacent frequency. FIG. 4A and FIG. 4B show eight frequency doublings 41. The number of frequency doublings can vary. This essentially forms the scope of complexity of a single FCU. At each signal channel intersection, there will be a plurality of phase switches where said plurality is either 8× the number of doublings or 16× the number of doublings depending on weather the FCU type is a single type (A or B) or a double type (AB). These doublings can be thought of as layers wherein each layer has a set of 8 (single type) or a set of 16 components (double types). Each FCU component at a signal channel intersection will respond to one of the frequencies in this spectrum of frequency doublings.

The Fractal computer can have any number of doublings. The greater the number of doublings, the more complex and more powerful the fractal computer. For example a fractal vision system may have a computation system with 20 doublings or more. The more doublings, the greater the complexity of the components at each intersection, as there needs to be an additional layer of components for every additional frequency doubling. FIG. 4A and FIG. 4B shows two arrangements of doubling, a first arrangement in FIG. 4A shows the lowest frequency at the base and each higher frequency above that. This type of processing is used by the principal components. FIG. 4B shows the highest frequency at the base and each lower frequency above that. The context components process from high frequency to low frequency.

Additional the components in each layer of a single type can be paired together. For example and single layer in the plurality of component at an intersection may have an alpha principal unit paired with an alpha context unit. Similarly a beta principal unit can be paired with a beta context unit. When paired together, the layer has one pair type or a second pair type or both pair types depending on whether the fractal unit is a single type fractal unit (A type or B type) or a double type fractal unit (AB type).

### Single Type.

An FCU can be built to perform the function of a single FCU type such as an alpha type or a beta type. These can even be tiled together in larger groups of alpha types or larger groups of beta types. In this approach, there need only be a plurality of phase switches corresponding to the number of doublings×eight switch types at each signal channel intersection.

### Double Polled

A signal channel intersection can have alpha and beta type present at each signal channel intersection intersection. In this configuration each signal channel intersection would have a plurality of phase switches corresponding to the number of doublings×16 (eight alpha and eight betas) at each signal channel intersection.

### Signal Channels

signal channels 61 are the components that relay the data signals among the various components of the fractal computer. Said signal channels have many connections to said components.

In an embodiment, the signal channels are electrical conductors such as electrical wires. These can be in any form of any electrical conducting material. The signal channels can be fabricated using existing VLSI circuit integration technologies onto a wafer or electronic chip. This allows fractal computers of huge processing power to be manufactured with existing technology.

In another embodiment, the signal channels comprising optical fibers that conduct light including infrared light and ultraviolet light.

In another embodiment, the signal channels comprising light pathways through transparent conducting film or optical crystals. These can be through any optical crystal including nano-scale crystals or nanocrystals such as quantum dots. The list of said crystals further includes but is not limited to, periodically polled crystals, Lithium Niobate Crystals, Lithium Tantalate Crystals, twisted nematic liquid crystal, optical lattice, rare earth doped laser materials, rare earth ion doped crystals. The list of Transparent Conducting film signal channels includes but is not limited to, indium tin oxide, carbon nanotube, graphene, flouride doped tin oxide, doped zinc oxide, nanowire.

### Grid and Data Bus

In an embodiment, A grid comprising two data buses 62; a first data bus 62 comprising signal channels running in the direction of the X axis and a second data 62 bus comprising signal channels running in the direction of the Y axis. The individual signal channels form a grid like structure called surface quadrilateral mesh 64. Said individual signal channels intersect where the two data buses run perpendicular forming signal channel intersections 63, however the signal channels are not directly interconnected with each other at said intersections. The signal channels can form connections with the components of the fractal computer. Said surface quadrilateral mesh 64 structure is formed on a flat surface.

### Grid

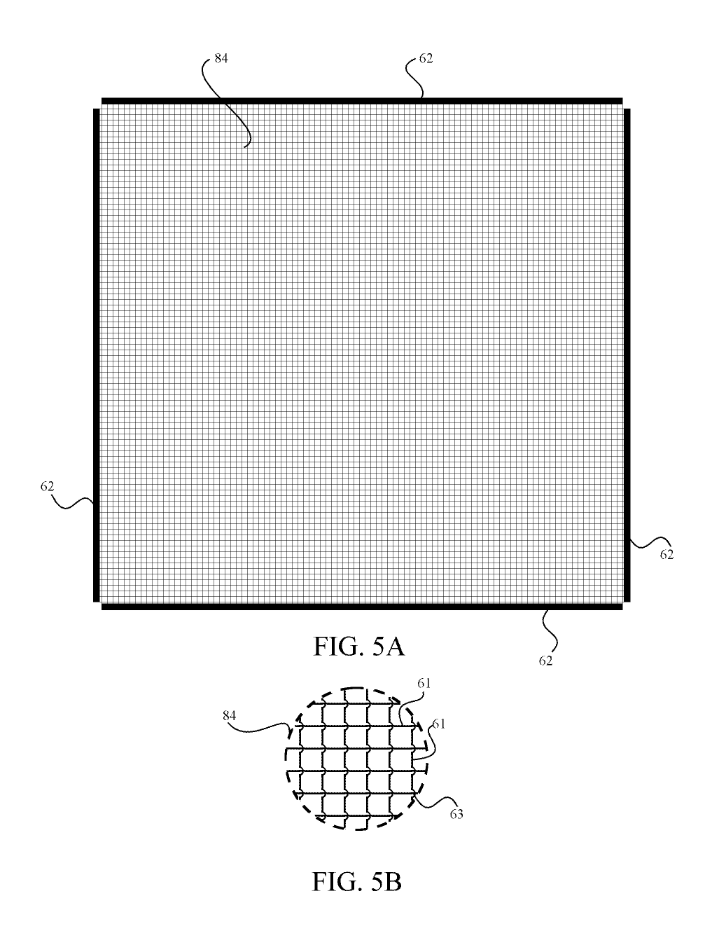

FIG. 5A shows a large surface quadrilateral mesh 64 used by the FCU components. The surface quadrilateral mesh 64 is shown with four data buses at the side. These data buses are connected to the surface quadrilateral mesh 64. Each data bus connects to a single axis of the surface quadrilateral mesh 64. An input signal can be received by any of the signal channels connected to the data bus. The data bus can be extremely short, and in some cases removed altogether. Two FCUs can be joined together by placing the FCUs adjacent to one another so that signals can communicate from one FCU to the next.

FIG. 5B shows a zoomed in portion of the surface quadrilateral mesh 64 showing that the signal channels forming the X and Y axes are not connected. The location around the intersection of perpendicular signal channels is the location for the phase switch 206 components. The surface quadrilateral mesh 64 can take the form of any surface quadrilateral mesh 64. Such a surface quadrilateral mesh 64 can be formed on a flat surface or on the surface of a large variety of structures including spheres, cubes, spheroids, flat surfaces, cylinders, cones.

The surface quadrilateral mesh 64 can be functionally sectioned into two surface quadrilateral mesh 64es. Each one operates in a different phase contrary to the other. One is intertwined with the other to form a surface quadrilateral super mesh 84.

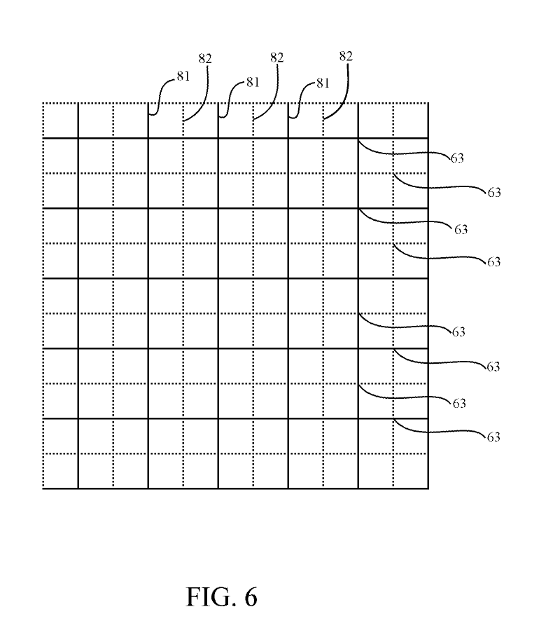

FIG. 6 shows the alternating arrangement of signal channels forming a surface quadrilateral super mesh. The solid lines represent a first surface quadrilateral mesh 81. The dashed lines represent a second surface quadrilateral mesh 82. The combination of solid and dotted lines and their arrangement represent the surface quadrilateral super mesh 84.

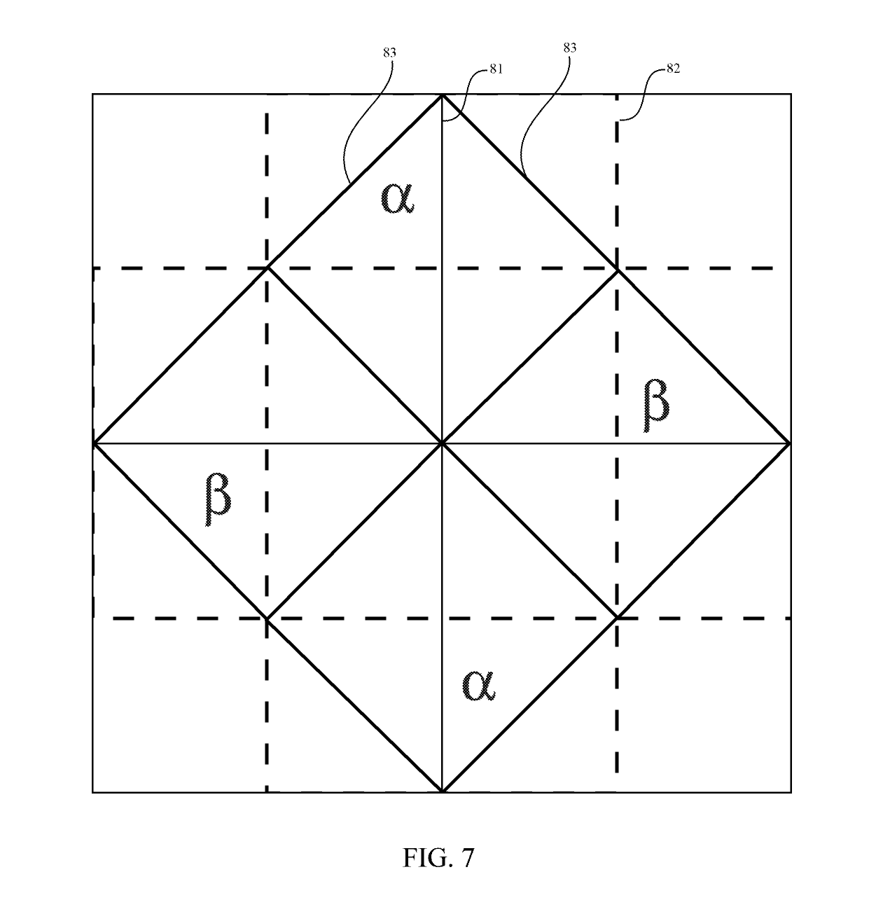

FIG. 7 shows an alternative surface quadrilateral mesh 64 arrangements showing a third surface quadrilateral mesh 83 arranged at 45 degrees with respect to the first 81 and second 82. In this instance, the surface quadrilateral super mesh 84 comprises three separate meshes. The third mesh is used for the purpose of propagating signals from one signal channel intersection to another.

### Spatial Temporal Device

In an embodiment, the fractal computer device comprising two spatial dimensions and one time dimension forming a three dimensional spatial temporal computing device. Said computing device further comprising at least one phase switch 206 device.

In another embodiment of the present invention, the fractal computing device comprising three dimensions of space and one dimension of time forming a four dimensional spatial temporal model.

### Two Dimensiona Spatial Temporal

In another embodiment, the FCU is a two dimensional fractal computer. This type of computer can be used for example in a hearing system as the first step for processing time varying data. As the waves of sound are processed by the variable phase waves, the data will form a spatial distribution of harmonics. The signal channels having the largest spatial distribution will be those that process the lower harmonics. As the resolution is increased by increasing the variable phase frequency, the higher harmonics in the time varying data will begin to appear at the signal channels of ½ the spatial distance, ¼ the spatial distance ⅛ the spatial distance until the maximum resolution has been reached. The two dimensional fractal computer for performing the initial processing on time varying sound data consists of a mesh of parallel signal channels operatively coupled to each other using the phase switch 206 components.

Further this two dimensional processing may be used to find patterns in sound data that have patterns of relative harmonic content such as vowel sounds. The initial processing in the ear may have all of the harmonics spatially distributed along a resonator channel. The harmonics of a certain base frequency can be aggregated onto a single signal channel, The waves themselves can be used as the variable phase frequency to provide a spatial distribution relative to the aggregated signal channel. Further, when this is combined with the variable phase signal, the recognition takes on a fractal characteristic in that it is able to recognize the same relative harmonic pattern regardless of the absolute pitch at which the vowel is being spoken. Expand this system to include aggregates for all 12 base frequencies or notes of the chromatic scale, and this can be embodied in a two dimensional fractal computer. This fractal computer can then output signals, wherein the spatial distribution represents patterns of relative harmonic content or vowels.

Further to this still, the phase one processing of such a system may produce a wave representing the strongest of the input waves received by the ear. This wave can then be used directly as the variable phase wave. This dynamically changing phase wave is able to follow the sound dynamically and automatically adjust the phase wave and recognize relative harmonic content. In short this provides full range of precessing for the initially stages of an auditory recognition system and an artificial hearing system. Each of the 12 base frequency origins can then be further aggregated into a single origin. The output patterns from this single origin point will represent relative harmonic content irrespective of the base frequency and irrespective of the harmonic frequency. It is a fractal computation system, for vowel sound pattern recognition. The aggregation mechanism can be done quite simply with just a few signal channel intersections in a three dimensional spatio-temporal fractal computer. Coupling a two dimensional fractal computer to a three dimensional fractal computer is simply a matter of operationally coupling at least one signal channel.

### Clock Signal

In an embodiment, signals comprising information are synchronized with a clock signal. The information signals comprise a carrier wave. Each of the individual data components of the information signal are synchronized with this carrier wave. The individual frequencies of the data components conform to the following equation: f=(frequency of said clock signal)/2ⁿ, wherein n is an integer and n≧1, and f is the frequency of at least one wave component of the information signal. Each information signal is comprised of one or more waves that conform to this equation. The clock signal is further used to create phase signals that are used by the signal channels to propagate data from one signal channel to another. For this purpose, the clock signal is split into phase shifted clock signals that feed into the signal channels. There can be one or more of the phase shifted signals depending on the spatial temporal dimension of the computer unit.

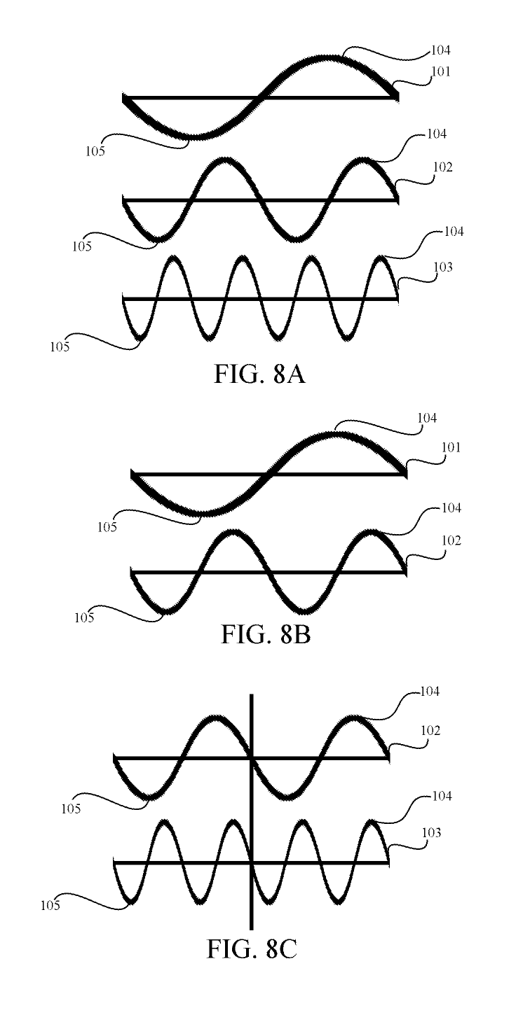

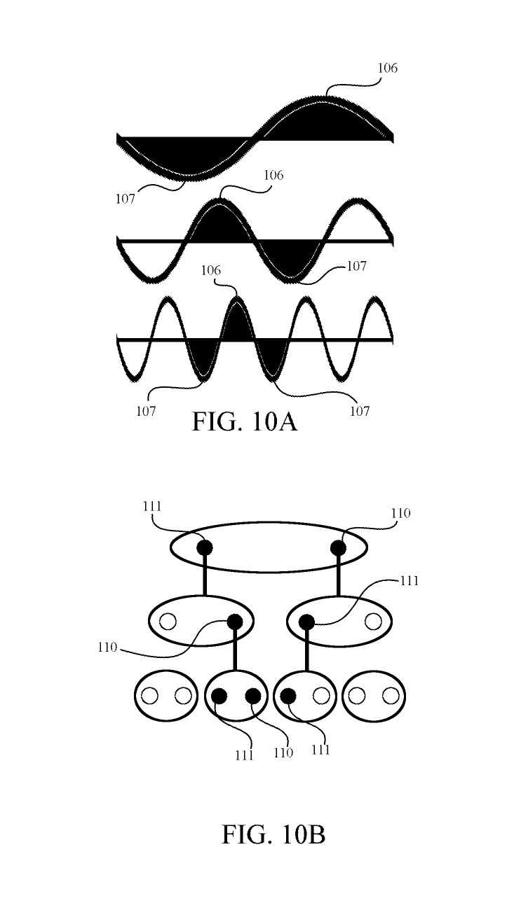

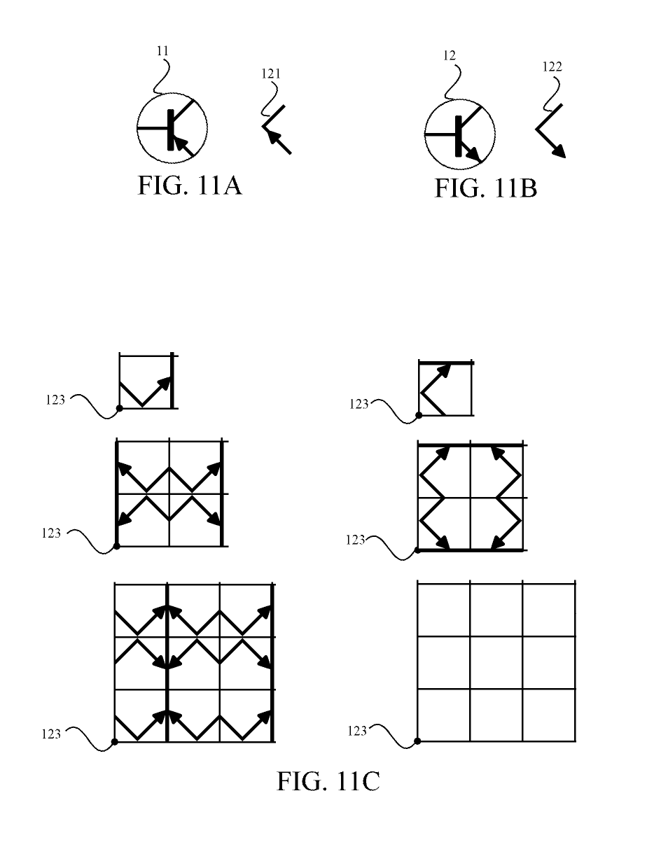

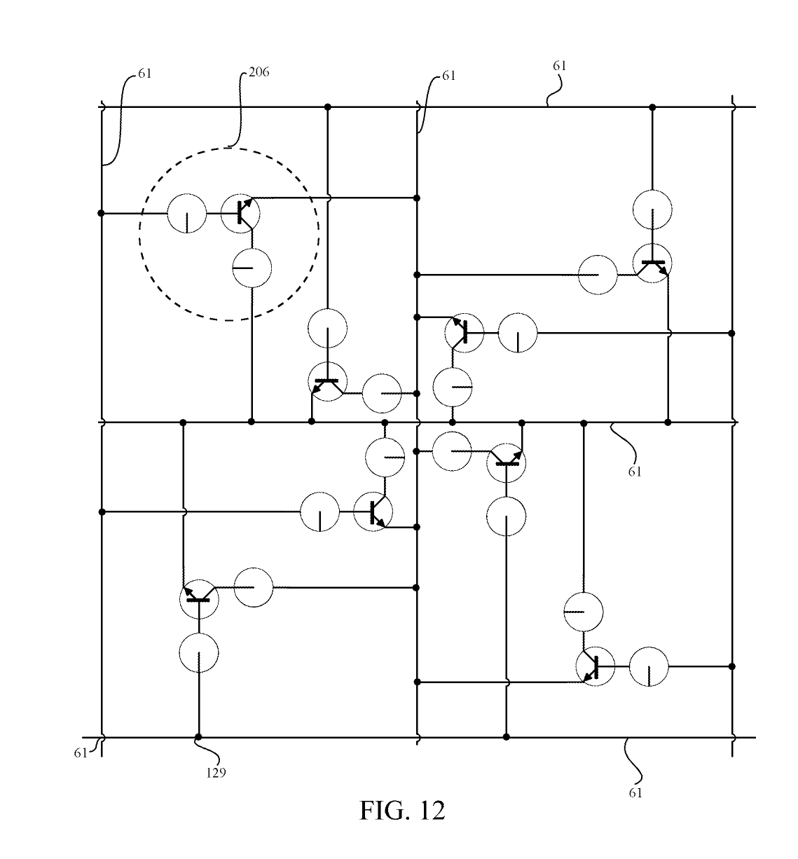

FIG. 8A, FIG. 8B and FIG. 8C shows three component waveforms comprising a data signal. Each of the waves corresponds to the equation: f=(frequency of said clock signal)/2ⁿ, wherein n is an integer and n≧1, and f is the frequency of at least one wave component. The data signal is comprised of any number of component waveforms that satisfy this equation. The example shows three FIG. 8A. The three waveforms form two adjacent pairs of signals as shown in FIG. 8B and FIG. 8C. Each signal pair having a wave of frequency f 101 and a paired wave of frequency f×2 102. Similarly a second pair may have a frequency f×2 102 and a frequency f×4 103. These pairs of waves form the basis of the data communication protocol and the basis of functionality in the fractal computer. These wave pairs can be thought of as links in a chain. Each link can be adjoined with another link forming a longer chain. The links also form a fractal tree data representation as shown in FIG. 10B. The data is represented by the waveform being present or not. Each waveform has a first alpha polarity part 104 and a second beta polarity 105 part. When these are present in a signal, they represent data. In this instance, the first polarity part 106 denotes an alpha bit 110 and the second polarity part 107 that denotes a beta bit 111. There are four combinations in each full wave cycle that represent the quaternary counting system of the fractal computer. These are: no signal, alpha only, beta only, alpha and beta.

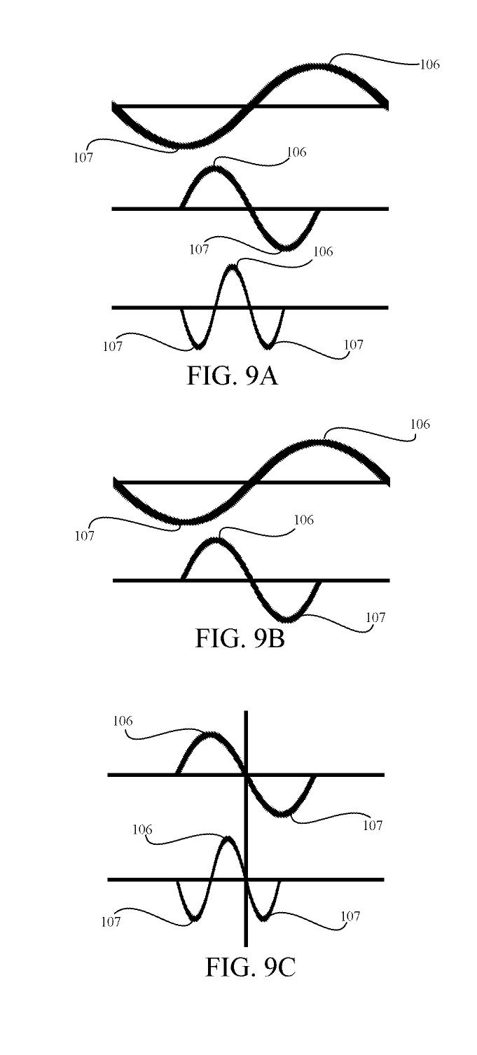

FIG. 9A, FIG. 9B and FIG. 9C shows the the signals used to represent a data pattern. The lowest signal (at the top) in FIG. 9A has both alpha and beta components. The beta part is from the first half of the wave, the alpha part is from the second half of the wave. The middle wave in FIG. 9A has an alpha part that relates to the beta part of the first wave and a beta part that relates to the alpha part of the first wave. This can be seen in FIG. 9B. The third wave of FIG. 9A has an alpha and a beta part that correspond to the alpha part of the second wave, and a beta part that corresponds to the beta part of the second wave. This can be seen in FIG. 9C.

FIG. 10A and FIG. 10B Shows a further representation of the parts of the wave present for a data signal. These wave parts are shown filled in black in FIG. 10A. The data tree represented by this data is shown in FIG. 10B. In FIG. 10B, each full wave is represented with an oval that has an alpha and a beta component. The diagram shows the beta component on the left and the alpha component on the right inside the oval.

### Data Wave Propagation

Each of the signal channels are connected to one of the four phase pulses. The signal channels are divided as follows. First the surface quadrilateral mesh 64 of signal channels is divided into two groups represented by the X and Y orientations of the signal channels respectively. Next, each of those groups of signal channels is divided into two so that alternating signal channels are connected to the same phase clock pulse. This creates four distinct groups of signal channels, each connected to its own phase clock pulse which is different from the phase pulse of the other three signal channel groups. Another way to put this is that for each of the two X and Y groups, if each of the signal channels were numbered in sequence for each X,Y group, the odd numbered signal channels of one group would connect to one phase clock and the even numbered signal channels of said one group would connect to a second phase clock. The odd numbered signal channels of second Y group would connect to one phase clock and the even numbered signal channels of said second Y group would connect to a second phase clock.

FIG. 11A, FIG. 11B and FIG. 11C shows how the data wave propagates from each signal channel intersection. The arrows used are an abbreviation of the switch 205 component. FIG. 11A shows the arrow used to represent the alpha signal propagation 121. FIG. 11B shows the arrow used to represent the beta polarization signal propagation 122. FIG. 11C shows how the data signals propagate from signal channel intersection to signal channel intersection. In FIG. 11C a section of the surface quadrilateral mesh 64 is shown. A data signal is produced at the lower left origin 123 of the surface quadrilateral mesh 64 and is represented by a dot in the diagram 123. This signal propagates outward in a similar manner to a ripple on a pond. The propagation has two phases, an alpha phase shown on the left of FIG. 11C and a beta phase shown on the right of FIG. 11C. Propagation is shown through two and a half cycles. During this timespan, the data signal propagates out to other signals channels by a process of interaction with adjacent signal channels. This is a local interaction. The propagation is shown just for the top right quadrant in relation to the origin signal. Propagation happens in all four quadrants relative to the origin point (top right, top left, bottom right, bottom left).

Each of the signal channel intersections of the surface quadrilateral mesh 64 has a plurality of phase switches tuned to the fixed phase clock frequency. That is to say that the operating frequency of the phase switches is the same as the fixed phase clock. Each of the four said phase switches are connected to form phase shift oscillators 128 that are in different phases with respect to each other. All of these phase shift oscillators share the signal channels of the surface quadrilateral mesh 64. This allows data pulses from a given location on the surface quadrilateral mesh 64 to propagate in the form of a wave to other parts of the surface quadrilateral mesh 64. The surface quadrilateral mesh 64 can be viewed as quantized space and the data wave will propagate at a maximum speed determined by the frequency of the phase pulse and the associated delay time in the phase shift oscillators as well as the physical distance between each signal channel intersection on the surface quadrilateral mesh 64. The state of each of the oscillators can initially be at rest or in oscillation. The oscillators comprise carefully tuned components so that a signal pulse at the oscillator input will cause the oscillator to ‘ring’ or resonate for a period of time but then return to the at rest or no oscillation state. The period of time taken for the oscillator to return to rest after resonating can be fixed or variable. The degree to which the oscillator rings will determine the magnitude of the geographic space over which the data wave will propagate.

FIG. 12 shows the arrangement of phase switches for the data wave propagation. The diagram shows only beta type propagation phase switches 206. A similar arrangement can be used with alpha phase switches. A Propagation mechanism can use either a single type (in a single type FCU) or it can use both types (in a double type FCU). The phase switches are connected to the signal channels at connection points 129 relative to the signal channel intersections.

The data wave will radiate outward from a phase switch 206. This radiation speed will be determined by the smallest of the time delay units. This time delay unit will be the shortest of all time delays used in the fractal computer. All signal channel intersections will have phase switches 206 that are permanently enabled at this highest frequency so that the waves will propagate outward.

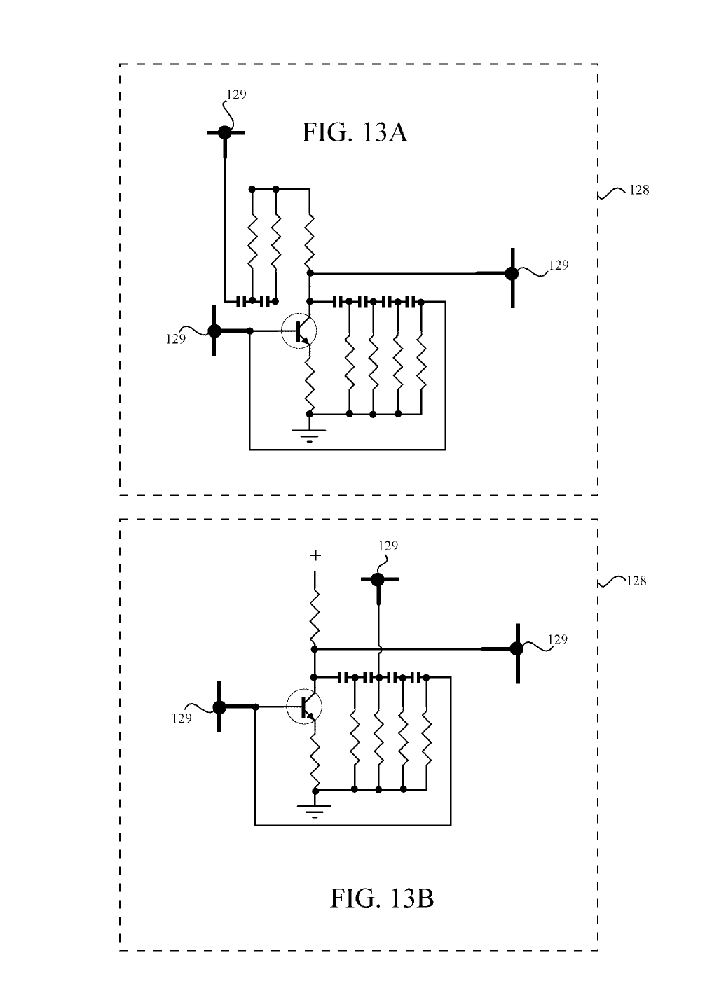

FIG. 13A and FIG. 13B shows an alternative embodiment using electronic components for the data wave propagation. The arrangement shown in FIG. 13A is for a phase shift oscillator. FIG. 13B shows a second configuration for a phase shift oscillator. In a further alternative embodiment, the equivalent functionality can be performed in a crystal lattice in an optical computer.

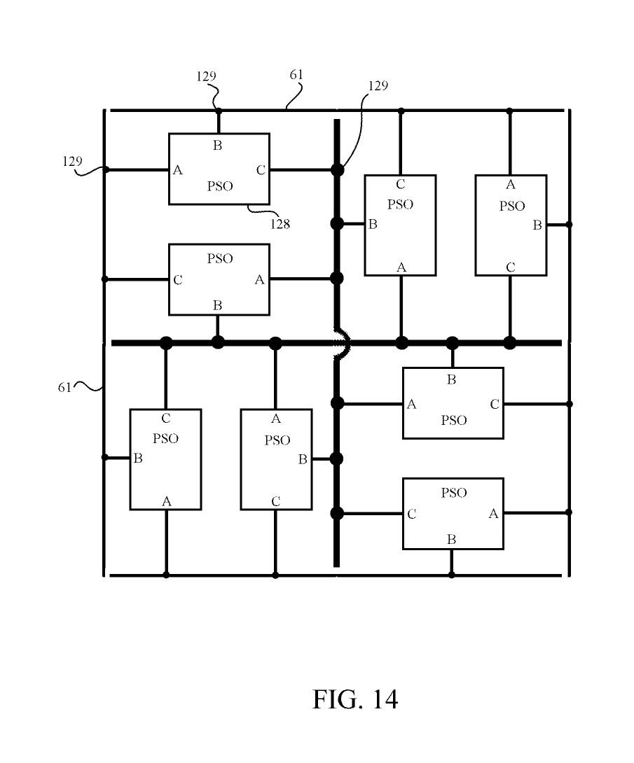

FIG. 14 shows a logical representation of the phase shift oscillators with their connection to the surface quadrilateral mesh 64.

Propagation can be described by time slicing through the smallest time quanta. At the first steep there is a signal that enters one of the signal channels. This signal through interaction with the phase signal can form inputs for a switch 205. Now that there are two signal channels with data flowing the propagation mechanism can take over as it requires two signal channels with some correlation in order to propagate the waves. Step 3 is the first of these propagation links. There are two links that start rotations in opposite directions. Step 4 is the continuation of this process. The wave propagates out from the initial switch 205 in all four directions at the same speed. The phase switches 206 are principal type FCU components. A phase switch and an FCU component 150 are the same thing. Propagation will continue outward until the signal weakens or falls off the edge of the surface quadrilateral mesh 64. The propagation so describes is in relation to a uniformly densely integrated tiled FCU of alternating alpha and beta FCU components.

In an alternative embodiment of the present invention, data propagation is implemented using the 2 inputs of the transistor without the phase wave. This can be implemented on one axis only. In this configuration a wave would propagate only along one axis depending on how the transistors are wired. Either the X axis or the Y axis. This would provide one dimension where data can be spread out fractally in relation to time. The data propagation can be understood as representing the time dimension as a spatial characteristic in relation to the surface quadrilateral mesh 64. It is therefore ideal for computations where data evolves over time such as sound processing or video processing. These systems use two dimensional spatial temporal device with one dimension of space and one dimension of time, or three dimensional spatial temporal device respectively.

Fractal Data pulses are presented to one of the signal channels after first being modulated by a carrier wave signal of the same frequency as the clock and synchronized with the fixed phase clock. The purpose of the carrier wave is to quantize the data pulses into the smallest data packets for wave propagation. When the quantized data pulses arrive at the nearest phase shift oscillator to the signal injection connection point, the amplitude of the data pulse in the quantized packet will be propagated to a neighboring phase shift oscillator. The data pulses of the input wave will propagate to all signal channel intersection points on the surface quadrilateral mesh 64. The propagation of this data wave is precisely controlled by the uniform layout of the surface quadrilateral mesh 64 and FCU components thereon and the precise phase clock and synchronized quantized data packets. The phase clock is also synchronized with the lower frequency data pulse waves so that it also is a double frequency multiple of the lowest data signal wave.

In an exemplary embodiment, the Fractal Computer comprises at least four FCU components 150. Each of these four FCU components are connected to a surface quadrilateral mesh 64 of signal channels comprising at least one horizontal signal channel and one vertical signal channel. Said signal channels are perpendicular to each other. There are two types of FCU; a type A 141 and a type B 142. These are arranged on an X,Y surface quadrilateral mesh 64. The fractal computer must have at least one of each type of FCU on each of the X and Y axes; The X axis must have at least one type A FCU component and at least one type B FCU component. The Y axis must have at least one type A FCU component and one type B FCU component.

In an exemplary embodiment, the four FCU component are arranged as a larger single square component. Each of the four data buses connect to one each type A FCU component and type B FCU component.

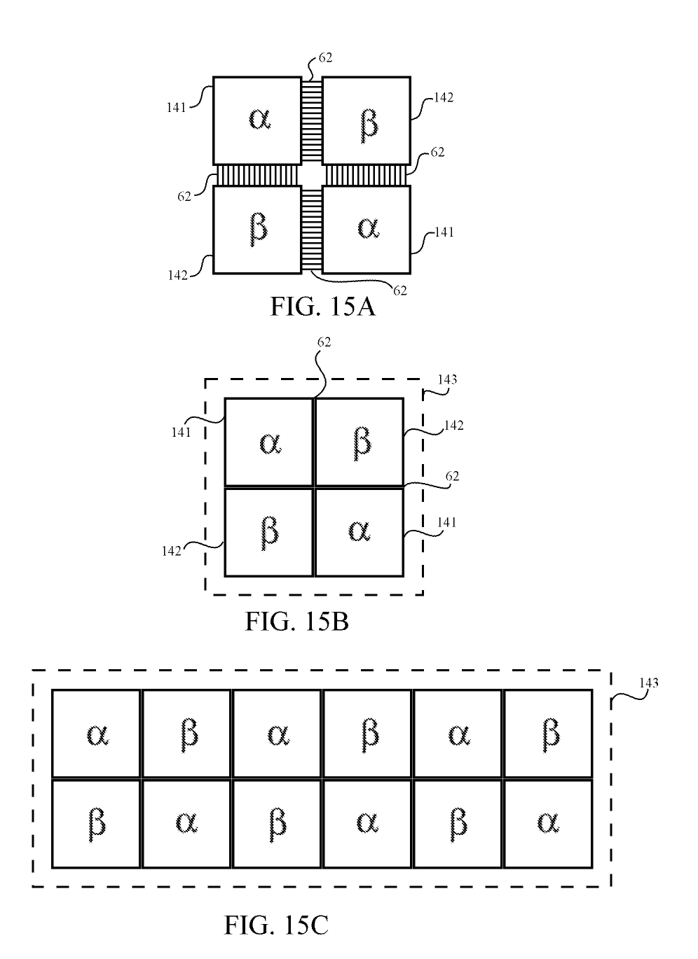

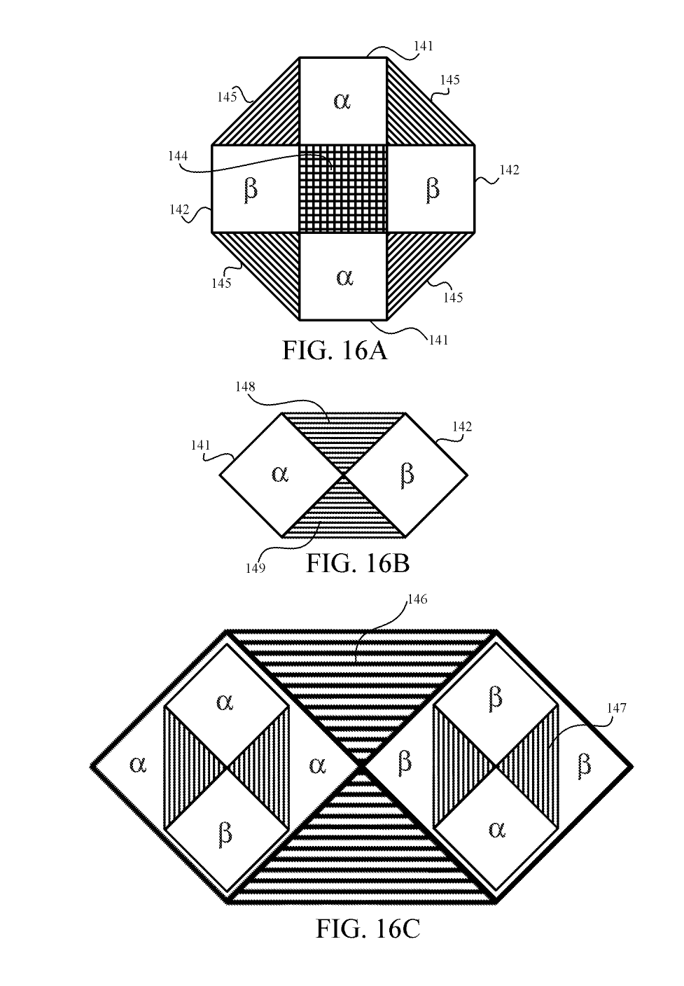

FIG. 15A shows four FCU components connected with four data buses. The diagram shows two type A FCU components and two type B FCU components. The data buses are shows exaggerated in the drawing so that the connection detail can be seen. Each data bus connects one axis or polarization.

FIG. 15B shows four FCU components that are adjacent and connected using optimally short data bus connections. The four FCU components in this example form a single larger FCU 143 shown inside the dotted line. This single larger FCU has both alpha FCU and beta FCU components and is referred to as a compound or AB type FCU.

FIG. 15C shows the A and B type FCUs tiled in a six by two layout. In this example, all twelve FCUs form a single larger FCU.

These examples illustrate the fractal composition of the FCUs as well as the extensibility of the FCU and fractal computation system. The example show tiling and nesting of FCUs that form a fractal structure.

In an exemplary embodiment, a fractal computing unit comprising:

a clock signal;
a propagation unit comprising: a plurality of signal channels; a plurality of phase switch units; and, a plurality of delay units;
at least one data signal comprising at least one wave having a frequency in accordance with the equation f=(frequency of said clock signal)/2ⁿ, wherein n is an integer and n≧1, and f is the frequency of said at least one wave; and,
at least one input, wherein said at least one input sending said at least one data signal to at least one signal channel of said plurality of signal channels;
wherein said plurality of delay units operationally coupled to a said plurality of signal channels,
wherein said data signal propagates to said plurality of signal channels, wherein at least one signal channel of said plurality of signal channels operationally coupled to at least one phase switch unit of said plurality of phase switch units, wherein said at least one phase switch unit having an operating frequency in accordance with the equation f=(frequency of said clock signal)/2ⁿ, wherein n is an integer and n≧1, and wherein f is the frequency of said operating frequency.

In an alternative embodiment, the four FCU components connect to each other to form a loop. The loop is comprised of FCU components connected in a loop with four separate side data buses 145. Each of the four separate buses in this loop connect to one type A FCU component and one type B FCU component. Two central buses 144 connect the two opposite type A FCU components and the two opposite type B FCU components. See FIG. 16A.

FIG. 16A shows four FCUs in an alternative arrangement using a central data bus as well as four side buses.

FIG. 16B shows a configuration of 2 FCU components joined by two data buses. A first data bus 148 and a second data bus 149. Again one data bus for each axis. In the example they are parallel.

FIG. 16C shows the configuration of FIG. 16B arranged fractally at different scales in a nested and fractal configuration. As can be seen from the illustration, the surface quadrilateral mesh 64 can be a different density at different scales, not all members of the surface quadrilateral mesh 64 at one scale need to connect to the surface quadrilateral mesh 64 of the higher scale. In the diagram, the data buses of the higher level FCU are of a lower density 146 than the higher density data buses 147 of the lower level FCU.

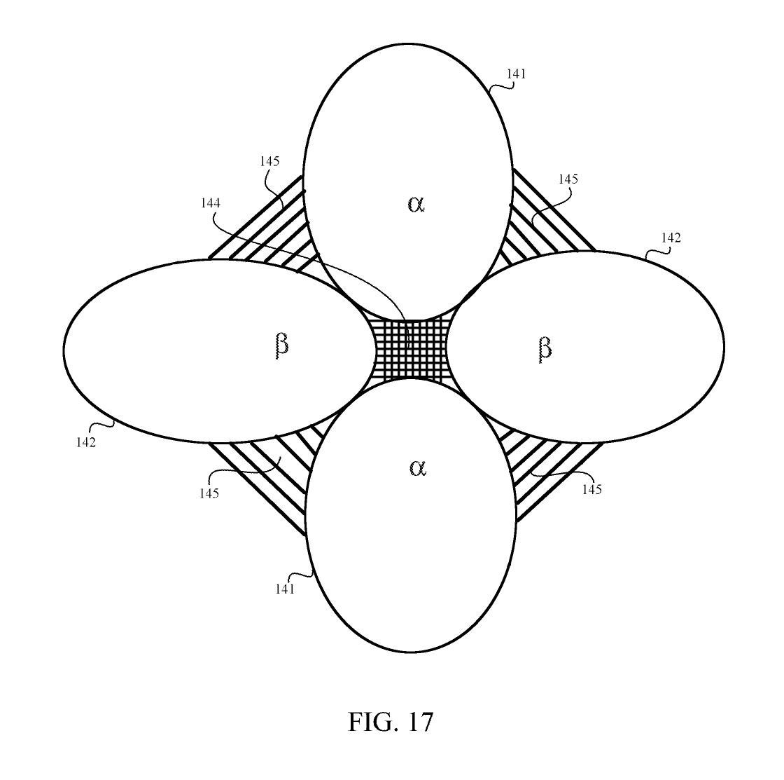

FIG. 17 shows four FCU components comprising a spheroid. In the illustration, the spheroid has been flattened out from top to bottom so that the individual components can be seen. The essential features are the FCU components type A and B, the four data buses connecting these components together in a ring and the central grid connecting opposite FCUs. The central grid in this configuration is optional.

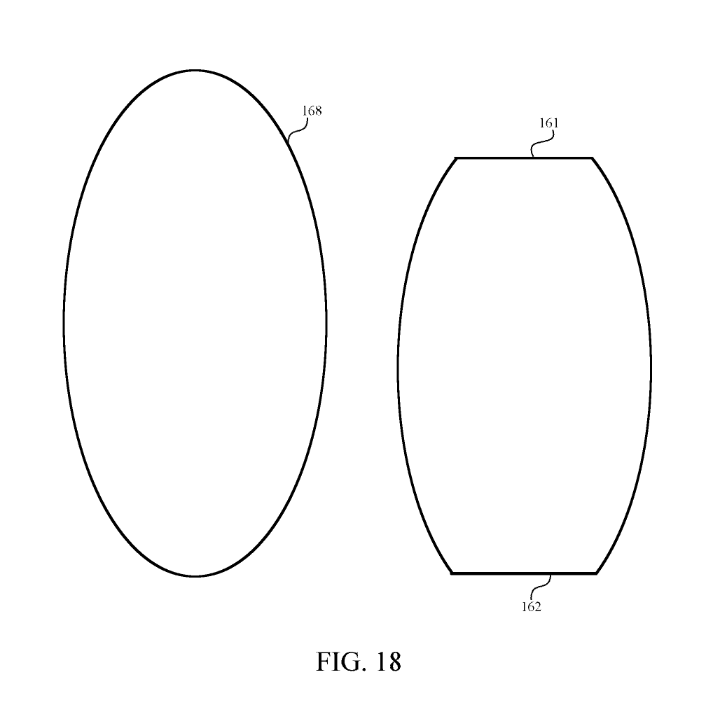

FIG. 18 shows the side view of the spheroid component. The complete spheroid 168 is shown on the left. Optionally, the top end 161 and bottom end 162 can be flattened for the data buses connecting the FCUs.

### Tiling

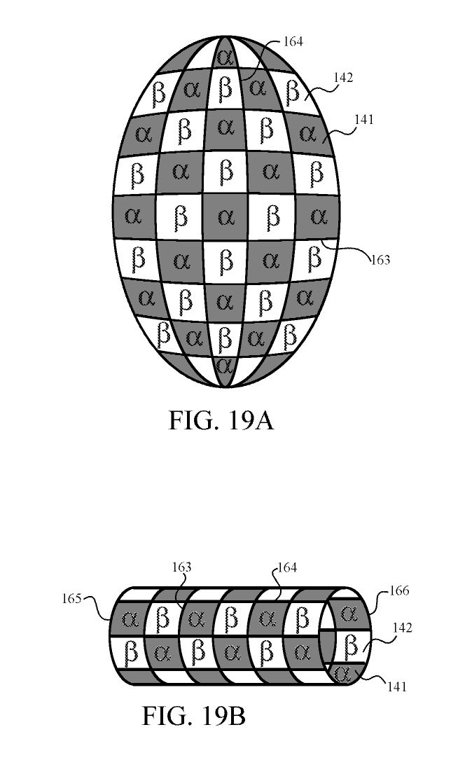

FIG. 19A shows a spheroid with tiled A and B components forming a uniform tiling. The sphere can be expanded by adding more tiles at any cross section of the spheroid. For example a set of FCU could be added to the central longitudinal cross section 164 of the spheroid. Similarly a set of FCUs could be added to the central latitudinal cross section 163 of the spheroid.

FIG. 19B shows a tubular arrangement of type A and type B components. This arrangement can be extended by adding new rings of FCU components onto either of the two ends 165, 166 of the cylinder or in a vertical cross section of the cylinder. Similarly the cylinder can be extended by adding a set of FCU components to a horizontal cross section of the cylinder.

### System

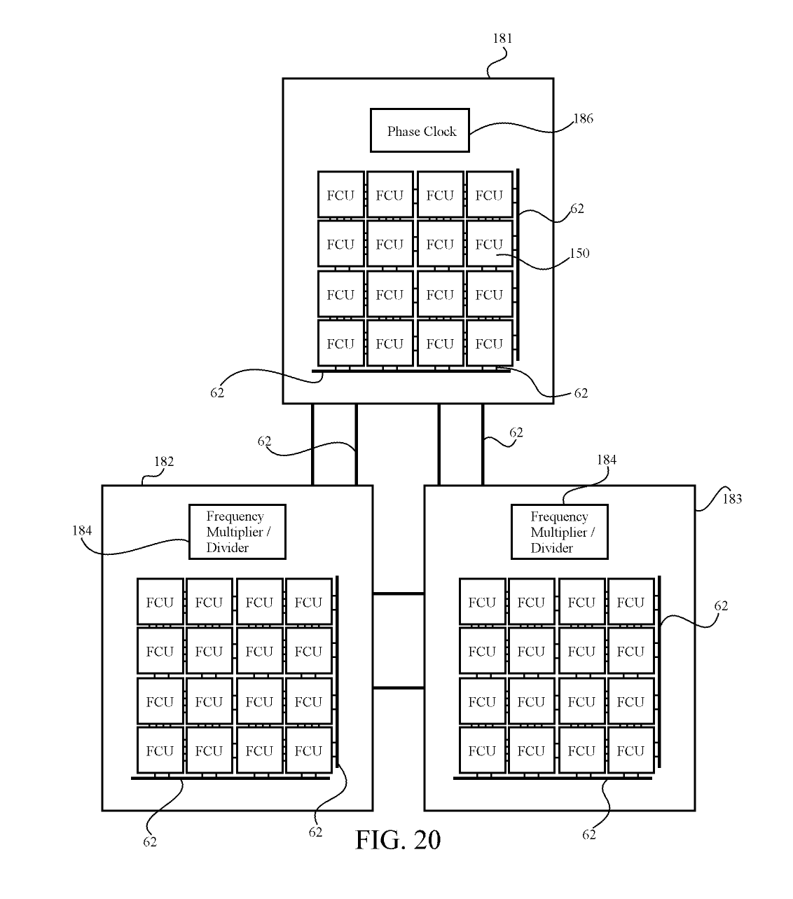

FIG. 20 shows three fractal computer systems 181. 182. 183 arranged together. Each system comprises multiple FCUs. These can be in any arrangement including random, tiled, and sequences of different tiling patterns, as well as hierarchical and nested configurations. A connected system preferably has a central phase clock 186 that is used to synchronize all data and computation throughout the system. At each sub system, the phase clock signal can be used unaltered, or it can be multiplied or divided by a frequency multiplier/divider unit 184 to provide a different set of frequencies for the computation in said subsystem.

### Phase Shift Components

In an exemplary embodiment, the phase shifter comprises a delay which is used to offset or shift the phase of all input frequencies by a fixed time amount. This time delay amount is equal to one quarter of the wave length period or multiples thereof of the operating frequency of said phase shifter.

If for example an input signal from a given input signal channel is to be output to a perpendicular signal channel which by definition is at 90′ to said input signal channel, then all input data signals are shifted by a fixed time delay equal to 90′ of the signal channel intersection frequency. By the same principle, if for example an input signal from a given input signal channel is to be output to a different parallel signal channel, which is at 180′ to said input signal channel, then all input data signals are shifted by a fixed time delay equal to 180′ of the signal channel intersection frequency. The phase shifter will shift all input signals by an amount equal to this time delay.

In an exemplary embodiment, the fractal computer FCU is comprised of at least one phase switch 206 comprising at least one phase shifter and at least one switch 205. Each phase switch 206 operates at a certain specific frequency known as the operating frequency of said phase switch 206. The switch 205 comprises a transistor or functional equivalent.

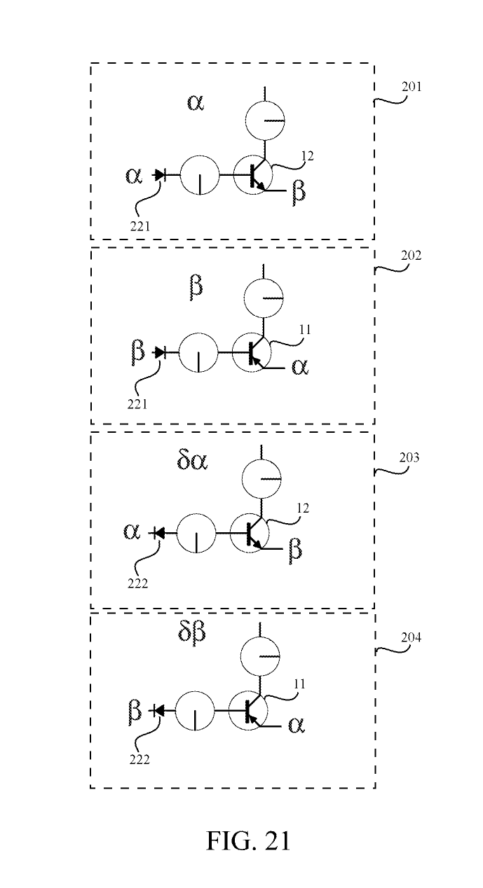

FIG. 21 shows the four switches 205 in combination with the phase shift components to form the four phase switch components 201, 202, 203, 204. The emitter, base and collector of the switch 205 are each at a different phase. The emitter is shown without a phase shift component as it has a phase shift of 0′. When there is a phase shift of 0′, the phase shift component can optionally be removed. The polarizer in series with the phase shifter allows the correct signal to be filtered for processing by the phase switch 206. Throughout this description electronic symbols are used to represent functionality. The functionality represented has equivalent functionality in an optical computer. For example the diode electrical symbol is equivalent to an optical polarizer. Similarly a transistor symbol is equivalent to an optical transistor in the optical fractal computer. Similarly for phase shifters, filters and modulators and demodulators and signal amplifiers.

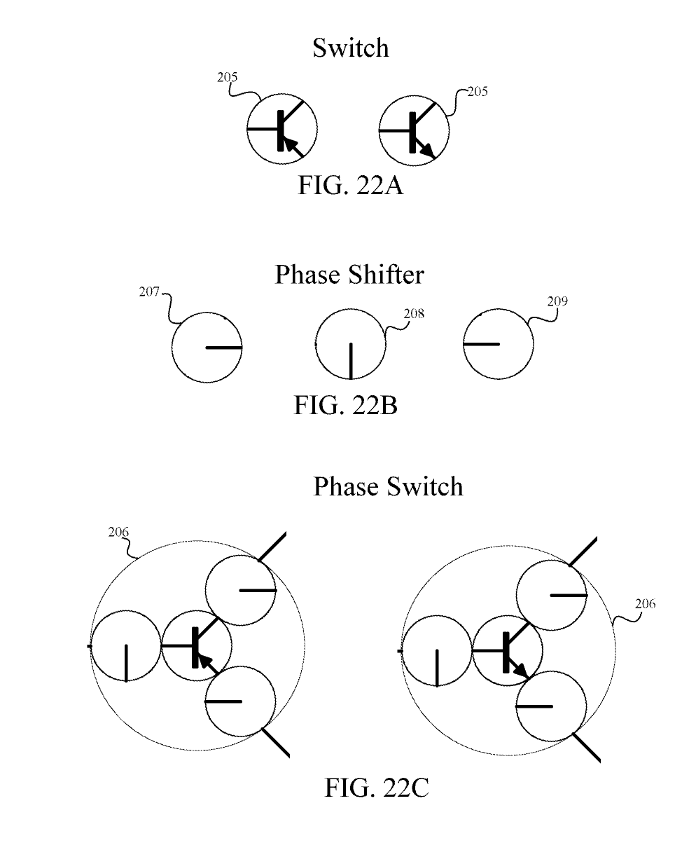

FIG. 22A, FIG. 22B and FIG. 22C shows the phase switch 206 derived from the switch 205 and the phase shifters. these are used by the three dimensional spatio-temporal fractal computer.

FIG. 22A shows the type A and type B switches 205.

FIG. 22B shows the phase shifters. Each phase switch 206 has optionally a phase shifter on each of the signal channels to and from the switch 205. The example shown uses phase shift values of 0′, 90′, 180′ and 270′. The phase switch 206 essentially sits at the center of three different time slices. Two of these time slices form the input and one forms the output. The time slices are synchronized at the switch 205 by the use of phase shifters

FIG. 22C shows the switch 205 and phase shifters connected to form a phase switch 206. The alpha phase switch is formed from a PNP transistor and the beta phase switch is formed from an NPN transistor.

In an alternative embodiment, a fractal computing unit (FCU) component constructed to function using polarized light, would operate in a similar fashion with respect to light polarization and fiber optic signal channels.

In an exemplary embodiment, both NPN and PNP transistor types are used. An NPN transistor is used for type A or Alpha FCUs. A PNP transistor is used for type B or Beta FCUs. Type A FCUs will operate during the Alpha and Delta Alpha phases of the phase clock. Type B FCUs will operate during the Beta and Delta Beta phases of the phase clock. These phases correspond with peaks on the phase clock signal. The emitter on the transistor is used for the output data signals. These output signals can be either + or Alpha signal or − or Beta signals. The transistor is considered to be floating in terms of the voltages used to activate the transistor switch 205. The voltages are derived from the peaks and troughs of the input data signals. The highest peak is the alpha or + signal. The lowest trough is the − or beta signal. These signals are phase shifted using a time delay so that they coincide with each other at the switch device. If the signals are coincident, the transistor conducts between the collector and emitter when a current is applied to the base.

The principal and context FCUs function differently with regard to the base signal. With regard to the NPN, a positive base signal will cause the transistor to conduct. This forms the principal component. With regards to the NPN, a negative base signal will cause the transistor to stop conducting. This forms the context component. The same principal applies for the PNP transistor component.

The phase switch 206 functions as either a high pass filter or a low pass filter. The detailed mechanism is as follows. An input data signal will comprise both positive and negative peaks. These are aligned with the phase shifter time delay. The output signal is polarized so that one half of the data is routed. This can be wither the + or the − component of the input data signals. In this way the set of data transmitted is half that of the full data set input. This filters out the operating frequency of the signal channel intersection and all frequencies below it and allows only frequencies that are double or multiples of double the signal channel intersection frequency to be transmitted to the output signal channel intersection. Even though the output data signal is polarized with respect to the current signal channel intersection, all voltages are in essence floating. The output wave still has peaks and troughs of these higher frequencies. These then from + and − components for signal channel intersections functioning at higher frequencies and the process continues.

### Wiring of Phase Switches to Surface Quadrilateral Mesh

In an exemplary embodiment, the connections of the phase switch 206 with the surface quadrilateral mesh 64 can be made in several different ways. Functionally, the transistor has two inputs and one output. The two inputs are collector and base and the output is the emitter. The collector is always connected to an incoming data signal channel. The emitter is always connected to an outgoing data signal channel. Phase shifters alter the phase of the signals to align with one of the 90′ 207, 180′ 208, or 270′ 209 phase shifts. The base can be connected in several different ways.

1) The base can be connected to the same input signal channel that the collector is connected to. The collector and base inputs filter out different parts of the incoming data signal by using different phase shift values in relation to the operating frequency of the phase switch 206. When both inputs are connected to the same signal channel in this manner, the base will have a phase shift value of 270′ 209.
2) The base can be connected to the same output signal channel that the emitter in connected to. The emitter and base use different phase shift value to differentiate the respective input and output signals from each other. When the input and output are connected to the same signal channel in this manner, the base will have a phase shift value of 180′ 208.
3) the base can be connected to the nearest parallel signal channel in the surface quadrilateral mesh 64 opposite from the signal channel that the collector is connected to. This type of connection is used for the data wave propagation mechanism and causes the data wave to propagate in a particular direction. When the inputs are connected to signal channels in this manner, the base will have a phase shift value of 270′.
4) the base can be connected to the nearest parallel signal channel in the surface quadrilateral mesh 64 opposite from the signal channel that the output emitter is connected to. This type of connection is used for the data wave propagation mechanism and causes the data wave to propagate in a particular direction. When the inputs are connected to signal channels in this manner, the base will have a phase shift value of 180′.
5) The base can be connected to the phase clock signal. Different phases of this signal can by synchronized with by the use of connections directly to the variable phase clock signals. Connections are equivalent to phase shift values of 90′, 180′ or 270′ in relation to the variable phase clock frequency. The actual time delay itself being the result of the data wave propagation, the distance traveled by the data wave and the variable phase wave. These phase clock connections can be further split into two types.
5a) The base of the type A FCU phase switches 206 can be connected to the variable phase clock input signal. The signal can be equivalent to phase shift values of 90′, 180′ or 270′.
5b) The base of the type B FCU phase switches 206 can be connected to the variable phase clock input signal. The signal can be equivalent to phase shift values can be 90′, 180′ or 270′

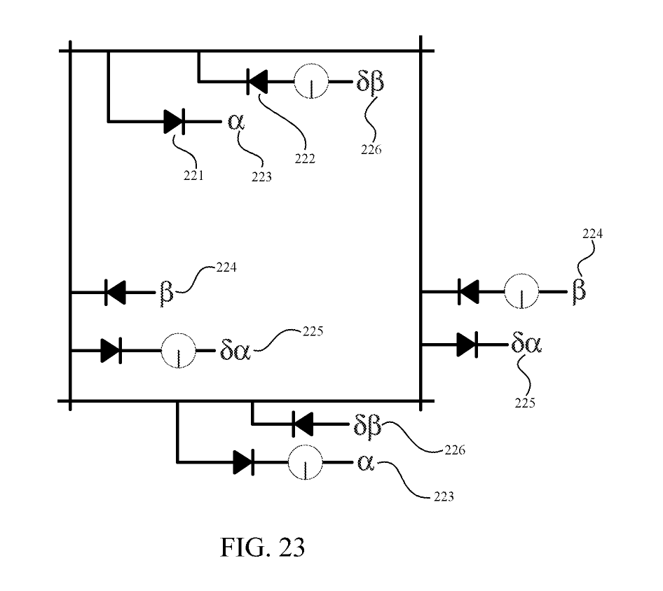

FIG. 23 shows how the different signals are extracted from the surface quadrilateral super mesh. These signals are used by the FCUs to perform computations. Each signal is either extracted from the signal channel directly via a polarizer 221, 222, or it is extracted, polarized and delayed to be in the correct phase.

TABLE 1
CONNECTION TYPES

| | |
|---|---|
| Principal | Context |

| Formula | Phase | Type | Formula | Phase | Type |
|---|---|---|---|---|---|
| α + β = δβ | α | α | δα + β = δβ | α | α |
| α + δα = δβ | α | α | δα + α = δβ | α | α |
| α + δα = β | β | α | δα + α = β | β | α |
| α + δβ = β | β | α | δα + δβ = β | β | α |
| β + δβ = α | α | β | δβ + β = α | α | β |
| β + δα = α | α | β | δβ + δα = α | α | β |
| β + α = δα | β | β | δβ + α = δα | β | β |
| β + δβ = δα | β | β | δβ + β = δα | β | β |

TABLE 2
COMPOUND COMPONENT COMPOSITION

| Name | Type | Output | Input | Base | Filter |
|---|---|---|---|---|---|
| Alpha Principal | NPN | Emitter | Collector | + | High Pass |
| Beta Principal | PNP | Emitter | Collector | + | High Pass |
| Alpha Context | NPN | Emitter | Collector | − | Low Pass |
| Beta Context | PNP | Emitter | Collector | − | Low Pass |

### Master Phase Clock

In an exemplary embodiment of the present invention, the master phase clock has two sets of output signal. The first set of signals is fixed with regard to the master phase clock frequency. This is known as the fixed phase clock. The second set of signals is variable with regards to the master phase clock frequency and can have any frequency determined by the equation f/(2ⁿ) where n≧0 and n is an integer and f is the master phase clock frequency. These are known as the variable phase clocks. There are four distinct phase clock signal pulses from each of the phase clocks that cycle from one to the next and then repeat continuously. These phase signals correspond to angular values of 0′, 90′, 180′ and 270′.

### Fixed Phase Clock

The fixed phase clock pulses are delivered to each of the signal channels. The fixed phase pulse quantizes the motion of the incoming data so that data that changes at intervals can be computed. The fixed phase pulse frequency is also used to modulate the data pulses by acting as a carrier wave. This in essence quantizes the input data signals.

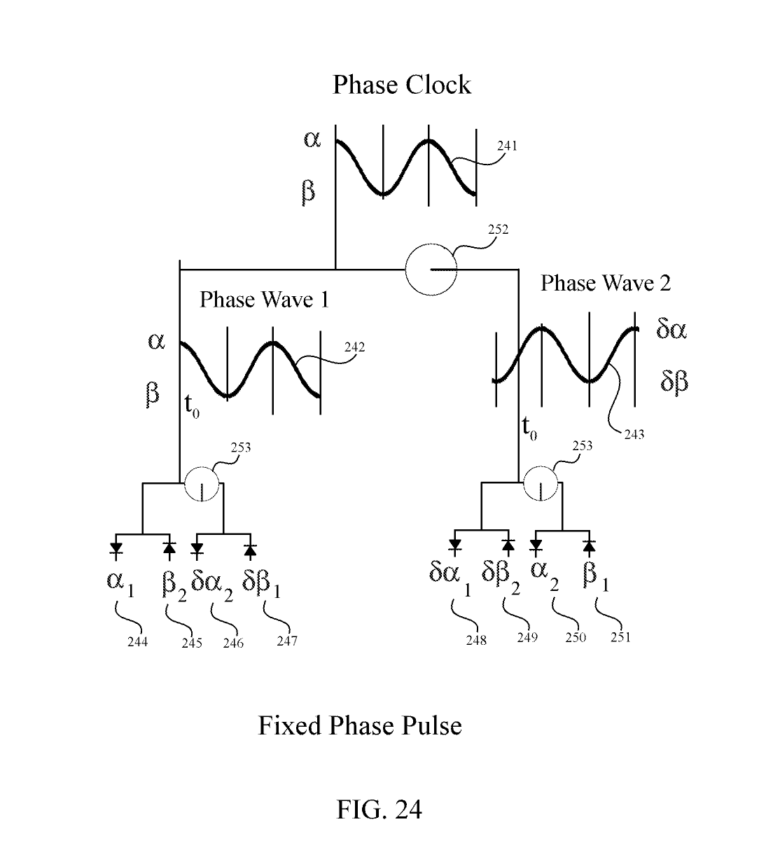

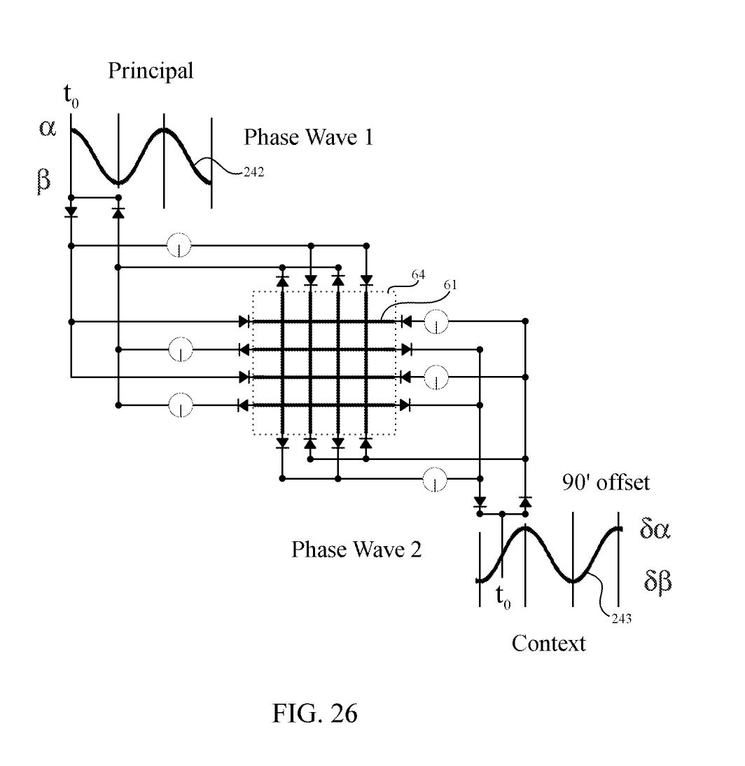

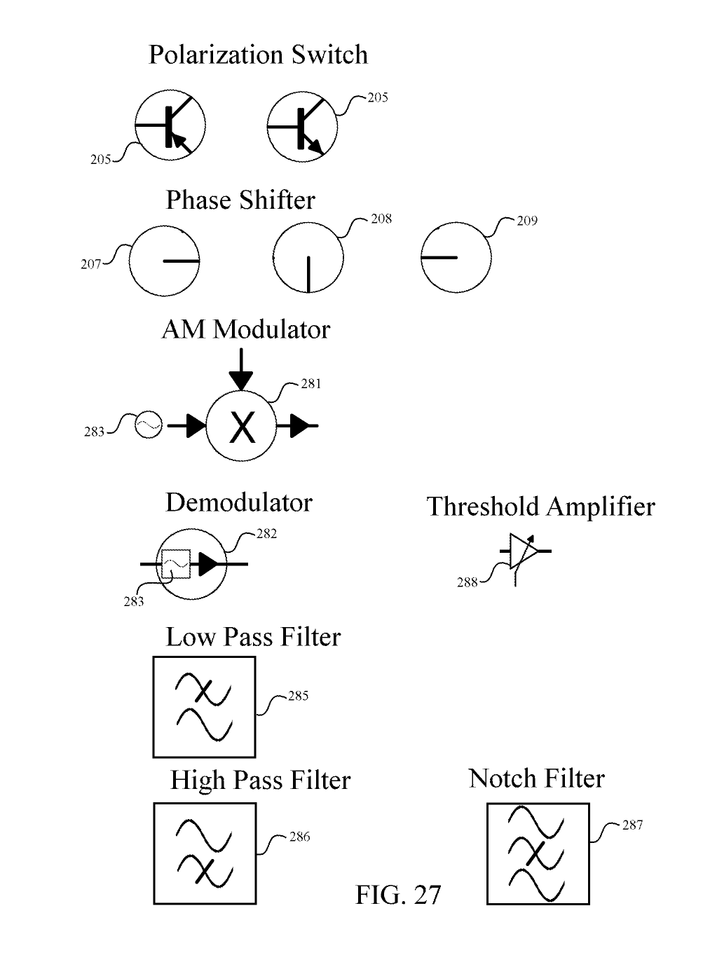

FIG. 24 shows the fixed phase clock signal 241. This fixed phase clock signal (at the top center) is divided into two. One of these two divided signals is shifted by a phase shift 252. For a 2 dimensional spatial-temporal computer this phase shift is 180′. For a three dimensional spatio-temporal computer this phase shift is 90′. for a four dimensional spatio-temporal computer, this phase shift is 60′. The first unshifted signal represents the principal signals 223, 224. The second shifted signal represents the context signals 225, 226. Following this each of the two signals 242, 243 is then further split in two with one of the two signals passing through a second phase shift 253 these signals are split in two again to form four signals each to provide a total of eight fixed phase signals 244, 245, 246, 247, 248, 249, 250, 251. Each of this eight signals is connected to one of the surface quadrilateral mesh 64 that form the surface quadrilateral super mesh 84 FIG. 26.

The first group of four signals is further divided into two groups. A first group comprising signals of a first polarization and phase shifted signals of a second polarization. These are coupled to along a first axis of the surface quadrilateral super mesh 84 to each of the two intertwined surface quadrilateral meshes 64 in an alternating manner. A second group comprising signals of a second polarization and phase shifted signals of a first polarization. These are coupled along a second axis of the surface quadrilateral super mesh 84 to each of the two intertwined surface quadrilateral meshes 64 in an alternating manner. The second group of four signals is further divided into two groups. A third group comprising signals of a first polarization and phase shifted signals of a second polarization. These are coupled to along a first axis of the surface quadrilateral super mesh 84 to each of the two intertwined surface quadrilateral meshes 64 in an alternating manner. A fourth group comprising signals of a second polarization and phase shifted signals of a first polarization. These are coupled to along a second axis of the quadrilateral super surface quadrilateral mesh 64 to each of the two intertwined surface quadrilateral meshes 64 in an alternating manner.

### Variable Phase Clock

The variable phase pulse provides a maximum resolution for pattern resolution. The variable phase pulse is delivered to each of the signal channel intersections. There are four electrical signal channels that span all signal channel intersections and provide the four variable phase pulses to each of the signal channel intersections. These signal channel intersection phase pulses are used by the data pulse phase switches 206.

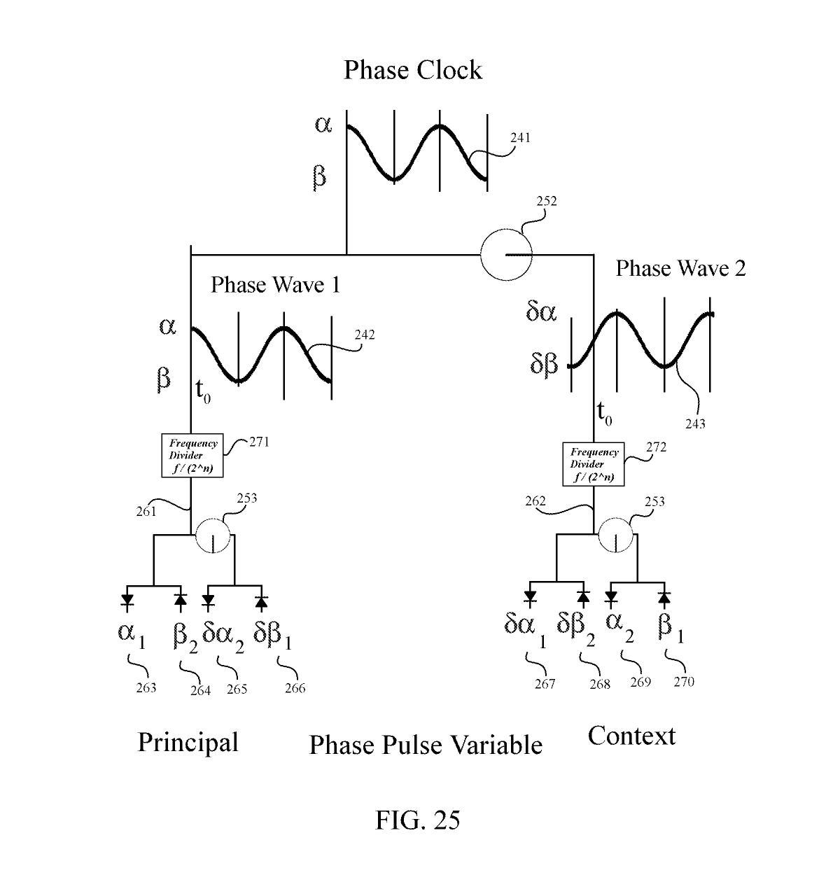

FIG. 25 shows the variable phase clock signal. This fixed phase clock signal (at the top center) is divided into. One of these two divided signals is shifted by a phase shift. For a two dimensional spatial-temporal computer this phase shift is 180′. For a three dimensional spatio-temporal computer this phase shift is 90′. for a four dimensional spatio-temporal computer, this phase shift is 60′. The first unshifted signal represents the principal signals. The second shifted signal represents the context signals. Each of these two fixed phase signals is then optionally run through a frequency divider 271, 272. This provides a variable phase signal 261, 262. Each of these two variable phase signals is further split into four signals to provide a total of eight variable phase signals 263, 264, 265, 266, 267, 268, 269, 270. Each of these eight signals is connected to the gate of one of the phase switches 206.

There are two phase clock signals. a) A first clock signal of a first frequency for the alpha and beta principal. b) a second clock signal of a second frequency for the alpha and beta context. Each of the two variable phase clocks comprise their own frequency which can be either the same as the other variable phase clock or different to the other phase clock.

There are several modes of operation in relation to the variable phase pulses as follows:

1) the frequency of the principal and context variable phase signal pulses are altered in unison.
2) the frequency of the principal and context variable phase signal pulses are altered in contrary directions. That is to say the principal variable phase signal will double while the context variable phase signal will half. Similarly the principal variable phase signal can half while the context phase signal will double.
For example, if there are 16 doublings in the fractal computer, then phase pulse A will last for time 1/16 and phase pulse B for time 16/1. The next step phase A is of time 1/8 and pulse B 8/1, following that 1/4 and 4/1 then 1/2 and 2/1 then 1/1 and 1/1 then 2/1 and 1/2 and so on. At each step the phase pulse A doubles in time whereas phase pulse B halves in time.
3) The frequency of the principal and context variable phase signal pulses are altered in unison as in mode one above but with a wrap around wherein the highest frequency wraps around to the lowest frequency and/or the lowest frequency can wrap around to the highest frequency.
When the phase pulse reaches the limit of this cycle i.e. phase pulse A is 16/1 and phase pulse B is 1/16 then the phase pulses can wrap around so A starts again at 1/16 and B at 16/1
4) The frequency of the principal and context variable phase signal pulses are altered in contrary directions as in mode two above but with a wrap around wherein the highest frequency wraps around to the lowest frequency and/or the lowest frequency can wrap around to the highest frequency.
5) The frequency of the principal and context variable phase signal pulses are altered in unison as in mode one above but with a frequency sweep so that the variable phase pulses are constantly sequencing through the frequencies in the same direction with wrap around.
6) The frequency of the principal and context variable phase signal pulses are altered in contrary directions as in mode two above but with sweep so that the variable phase pulses are constantly sequencing through the frequencies in contrary directions with wrap around.
7) The frequency of the principal and context variable phase signal pulses are altered in unison as in mode one above but with a frequency sweep so that the variable phase pulses are constantly sequencing through the frequencies in the same direction without wrap around but with an alternating forward then backward motion. When the phase pulse reaches the limit of this cycle i.e. phase pulse A is 16/1 and phase pulse B is 1/16 then the phase pulses can either b) they can reverse direction so that phase pulses A start to half in duration and phase pulses B start to double in duration.
8) The frequency of the principal and context variable phase signal pulses are altered in contrary directions as in mode two above but with sweep so that the variable phase pulses are constantly sequencing through the frequencies in contrary directions without wrap around but with an alternating forward then backward motion.
9) In a further mode of operation, the phase pulses can function in a smaller band of doublings and cycle around or oscillate back and forth in the same way as seven and eight above but with respect to the fewer doublings.

In an exemplary embodiment of the present invention, pulsed light is transmitted to all signal channel intersections simultaneously and detected by a polarized photo-diode. The timing and polarity would determine which of the four phases the phase pulse represented.

In a further exemplary embodiment, a combination of the electrical signal channel and polarized photo diode or transistor are used to deliver the phase pulses.

In a further exemplary embodiment, the phase pulses are delivered using an oscillating magnetic field.

FIG. 27 shows the components used in the phase switch 206. A modulator 281 is used to quantize the data signals with a carrier wave 283 before sending them to a signal channel. The demodulator 282 demodulates the quantized data signals for use by the phase switch 206. The threshold amplifier 288 is used to alter the amplitude of the signals sent to the gate of the switch 205. The purpose of the amplifier is to effectively change the trigger threshold of the switch 205. Alternatively, the switch 205 itself can use the programming signals to alter the trigger point at which it changes from data flowing state to a non data flowing state. In the data flowing state, signals at the input signal channel are routed to the output signal channel. Some of these routed signals are filtered with a wave filter. This filter can be a high pass filter 286, a low pass filter 285 or a notch filter 287.

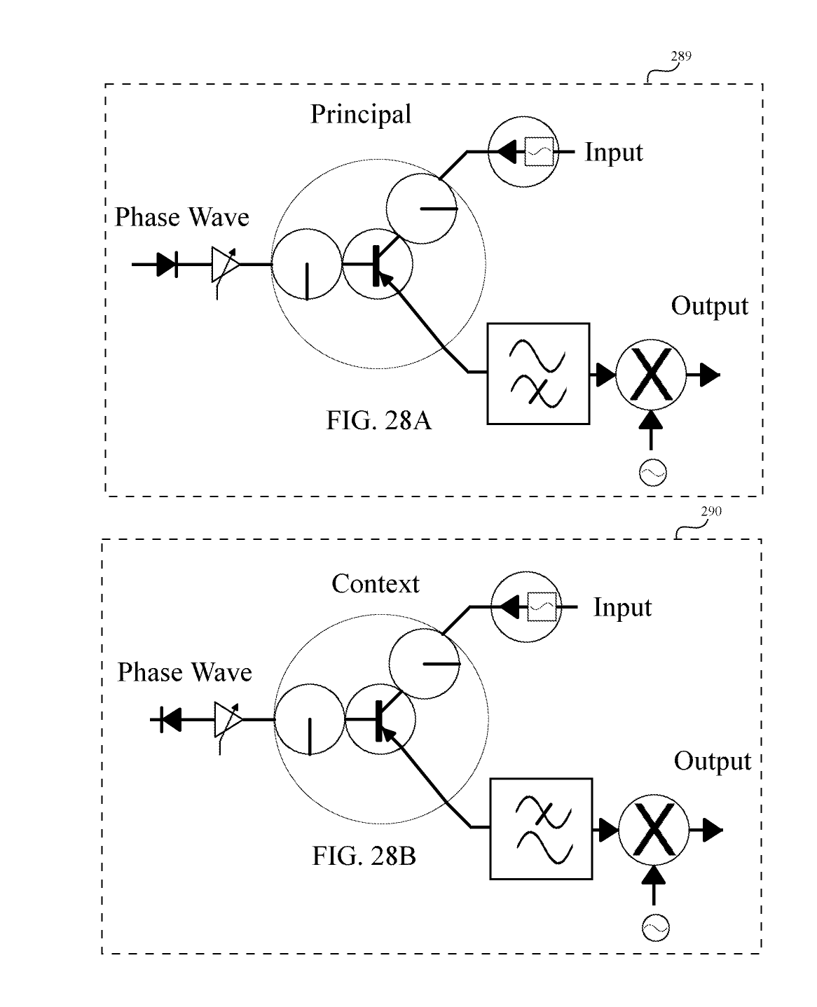

FIG. 28 This diagram shows extra detail and all optional components of the phase switches 289, 290 used to process the data signals, together with their interconnections. The phase shift component on the emitter has been omitted from the example in the diagram. Each of the phase shifters can be optionally removed if it's phase shift is 0′. The diagram shows an example of the connection using high pass and low pass filters. The filters can be optionally changed for notch filters while using a similar set of connections. The component shown in FIG. 28A represents the principal component 289. This component processes lower frequency component signals while allowing the higher frequency component signals to be filtered. The alternative embodiment that uses a notch filter will allow higher frequency signals that are part of a locally processed group of adjacent frequencies with respect to their position in the spectrum of doublings, to be conditionally routed while also routing all other signals that are lower but part of a non-adjacent group of signals.

The component shown in FIG. 28B represents the context component 290. This component processes higher frequency component signals while allowing the lower frequency component signals to be filtered. The alternative embodiment that uses a notch filter will allow lower frequency signals that are part of a locally processed group of adjacent frequencies with respect to their position in the spectrum of doublings, to be conditionally routed while also routing all other signals that are higher but part of a non-adjacent group of signals.

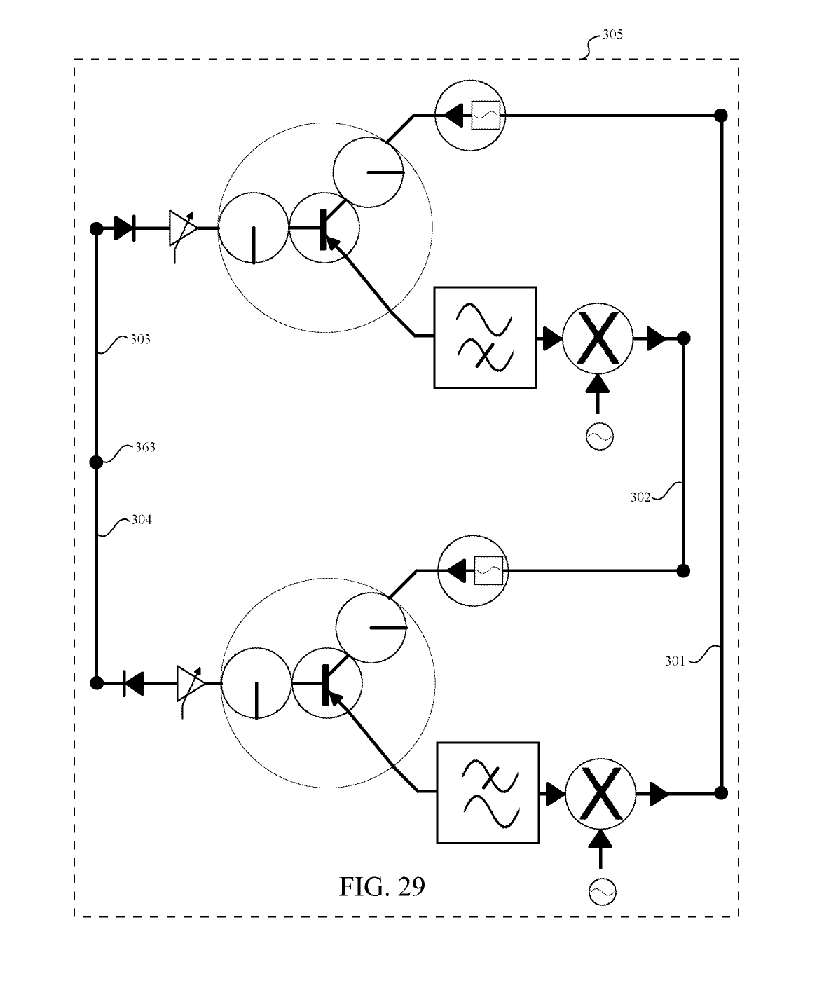

FIG. 29 shows the principal component and the context component connected together to form a pair 305. A pair forms the basis of a fractal computation unit or FCU. The two components work in a complementary manner with regard to the input and output data signals. In the example, the emitter of the principal component is coupled to the collector of the context component. This forms a first connection point 301. The diagram also shows the collector of the principal component connected to the emitter of the context component. This forms a second connection point 302. The diagram shows the two gate components connected together to form a third connection point 363. Optionally the two gate components can each connect to separate variable phase wave signal channels 303, 304.

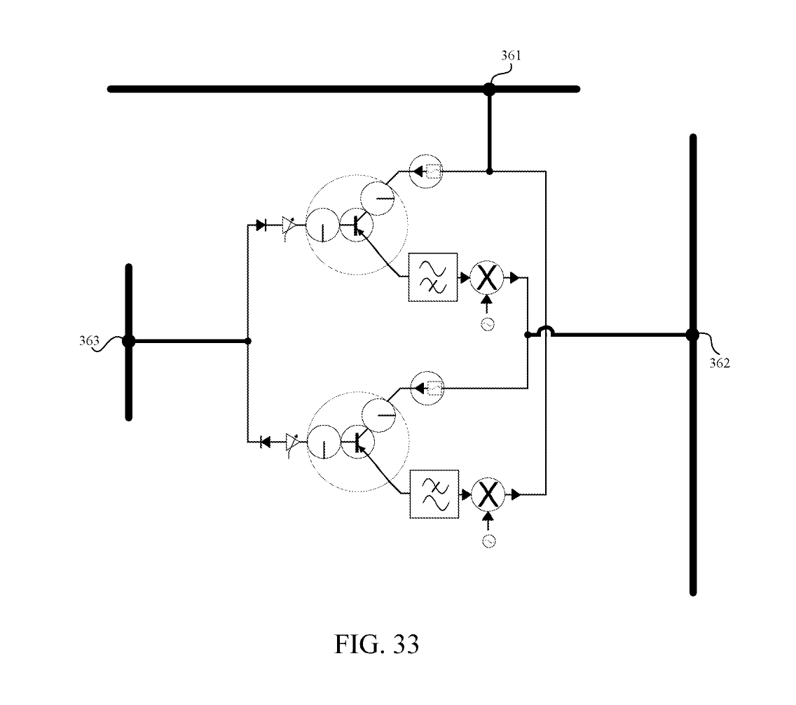

FIG. 33 shows the three connection points 361, 362, 363 connected to the signal channels of the surface quadrilateral super mesh 84. The first connection point is connected to a signal channel along a first axis. The second connection point is connected to a second signal channel. In the example, the second signal channel is perpendicular to the first signal channel. The second signal channel may also be adjacent and parallel to the first signal channel. The third connect point connects to a third signal channel in addition to the variable phase wave signal channels detailed earlier. The third connection point receives delayed data signals that have propagated through the propagation medium.

The unpropagated data wave connection and the propagated data wave connection go to perpendicular signal channels. The input and output can connect to the same or different signal channels. Initially, the threshold voltage of the phase switch 206 is high. In order for the switch 205 to activate, all three of the signals going to the base or gate of the transistor need to align. When all three are in alignment, this is just enough voltage for the gate to exceed the threshold voltage of the phase switch 206. When this is used in a circuit completion, the programming pulse will reduce the threshold level so that the threshold trigger will be lower. A lower threshold trigger puts the phase switch 206 into the branch information potential 443 group. Once this happens, it is only necessary for two of the signals to line up that is the phase wave and the unpropagated data wave. Eventually after more successful activations, only the unpropagated data wave will be required to activate the phase switch 206. At this point, the component belongs to the trunk information potential 442.

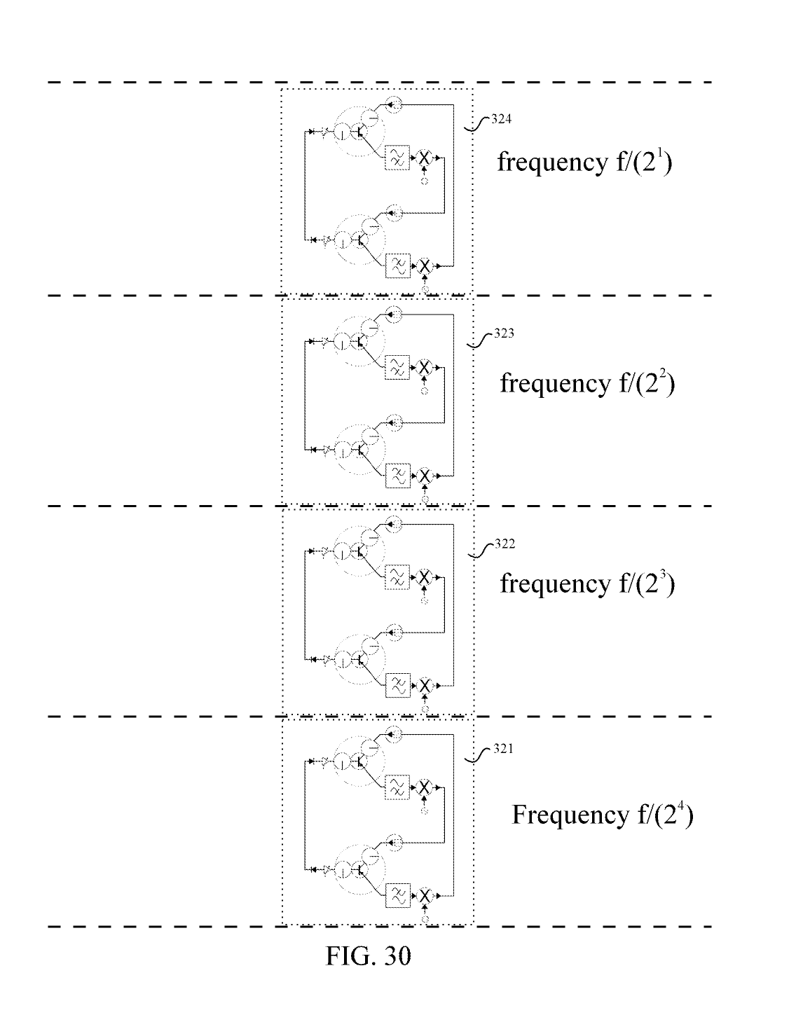

FIG. 30 shows the phase switch 206 components stacked in a group of four layers 321, 322, 323, 324. Each layer of this group has a different operating frequency in the spectrum of frequency doublings. The group is located at or near to the signal channel intersection points so that the interconnections can be made to the signal channels.

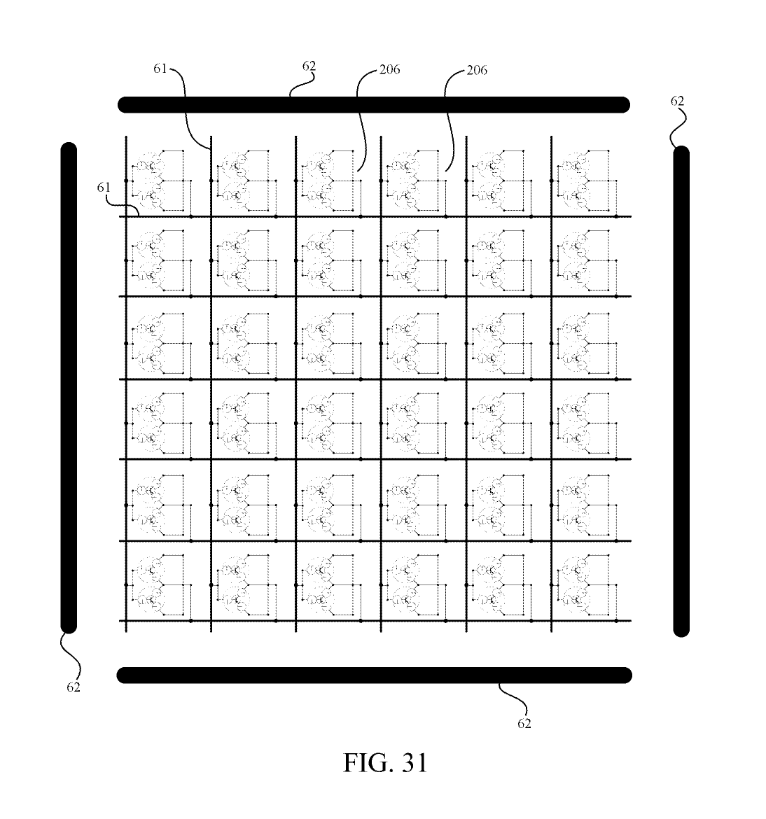

FIG. 31 shows a group of phase switches 206 connected throughout a surface quadrilateral super mesh. The super mesh in the diagram is a 6×6 super mesh. The pairs of phase switches 206 are shown connected to the super mesh at the intersection points. Also shown are the data buses on the axes of the super mesh.

Optionally, an alpha component of one operating frequency can be operationally coupled to a delta alpha component of a different operating frequency at each signal channel intersection. Same for beta and delta beta.

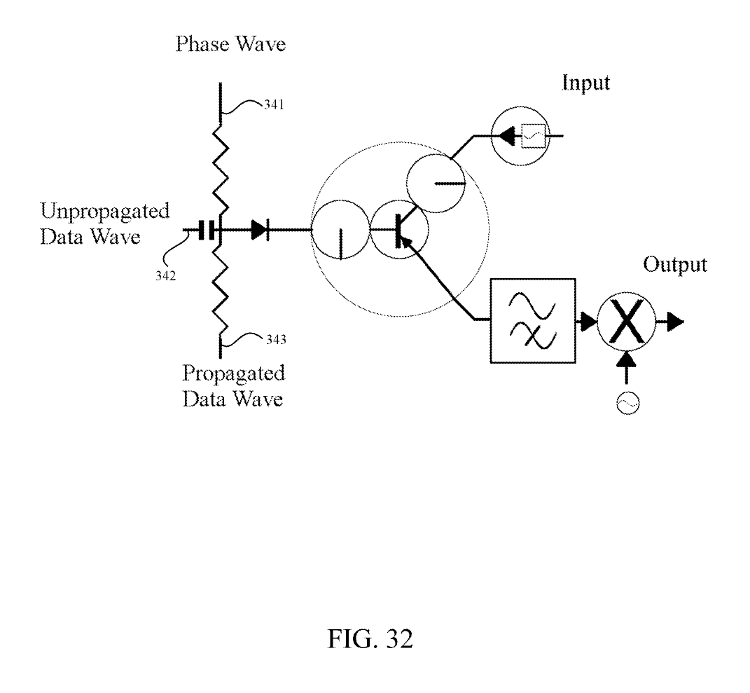

FIG. 32 shows a single phase switch 206 with four signals, three of which may have separate connection points as shown in the diagram. The propagated data wave 343 is already combined with the fixed phase wave. The unpropagated data wave 342 is also already combined with the fixed phase wave. The variable phase wave input 341 combined with the propagated data wave combined with the unpropagated data wave creates an interference signal. This interference signal changes depending on the precise location of the phase switch 206 as the propagated data wave changes its phase as it propagates further from its originating point.

At any given signal channel intersection there can also be one or a plurality of phase switches 206 that operate at the frequency of the data pulses and not at that of the carrier wave or phase pulse signals. Each of these data pulse phase switches 206 will have a demodulator circuit on the inputs such as an envelope detector that reconstitutes the original wave data from the quantized data packets. The output is connected to a modulator circuit that quantizes the output with the carrier wave. Any of the data pulse phase switches 206 along the length of a given signal channel can take the data pulses and use them to activate said switch 205 and route the quantized data pulses to the connected perpendicular signal channel. Even if the phase wave pulses are disabled, data pulses can still route in this manner. Such an intersection or signal channel intersection at which the data is routed at 90 degrees is a radiation point for the data wave. New waves of data are propagated from each of said intersections or signal channel intersections.

The fractal computing has a plurality of signal channels spatially arranged in the form of a surface quadrilateral mesh, wherein said plurality of signal channels logically divided into two functional groupings comprising: a first signal channel grouping and a second signal channel grouping, wherein said first signal channel grouping operationally coupled to said second signal channel grouping by said plurality of phase switch units and wherein, spatially, intersecting signal channels along the length of said at least one signal channel sequentially alternate between the two functional groupings; wherein said fractal computing unit further comprising:

a first variable clock signal derived from said clock signal;
a second variable clock signal derived from said clock signal;
a first signal channel of said first signal channel grouping;
a second signal channel of said second signal channel grouping;
a third signal channel of said first signal channel grouping, wherein said third signal channel adjacent to said first signal channel;
a fourth signal channel of said second signal channel grouping wherein said fourth signal channel adjacent to said second signal channel;
a gate signal channel group comprising, said first signal channel, said second signal channel, said third signal channel, said fourth signal channel; and,
a phase clock channel group further comprising:
a first variable phase clock signal channel, wherein said first variable phase clock signal channel receiving said first phase clock signal; and,
a second variable phase clock signal channel, wherein said second variable phase clock signal channel receiving said second phase clock signal;
wherein said at least one phase switch comprising:
a first delay unit;
a second delay unit;
a third delay unit;
a modulating unit having a carrier frequency equal to the frequency of said phase clock signal;
a demodulating unit having a carrier frequency equal to the frequency of said phase clock signal;
a filter unit;
a variable signal amplifier; and,
at least one switching unit comprising: at least one input; at least one output; and at least one gate;
wherein said at least one input operationally coupled by a demodulator unit to said first signal channel or by said first delay unit in combination with said demodulator unit to said first signal channel, wherein said at least one output operationally coupled by said filter unit in combination with said modulator unit to said second signal channel or by said second delay unit in combination with said filter unit in combination with said modulator unit to said second signal channel, and wherein said at least one gate operationally coupled by said variable signal amplifier to one signal channel of said gate signal channel group or by said third delay in combination with said variable signal amplifier to one signal channel of said gate signal channel group, wherein said at least one gate further operationally coupled to one signal channel of said phase clock channel group.

### Fractal Data and Data Signal Formats

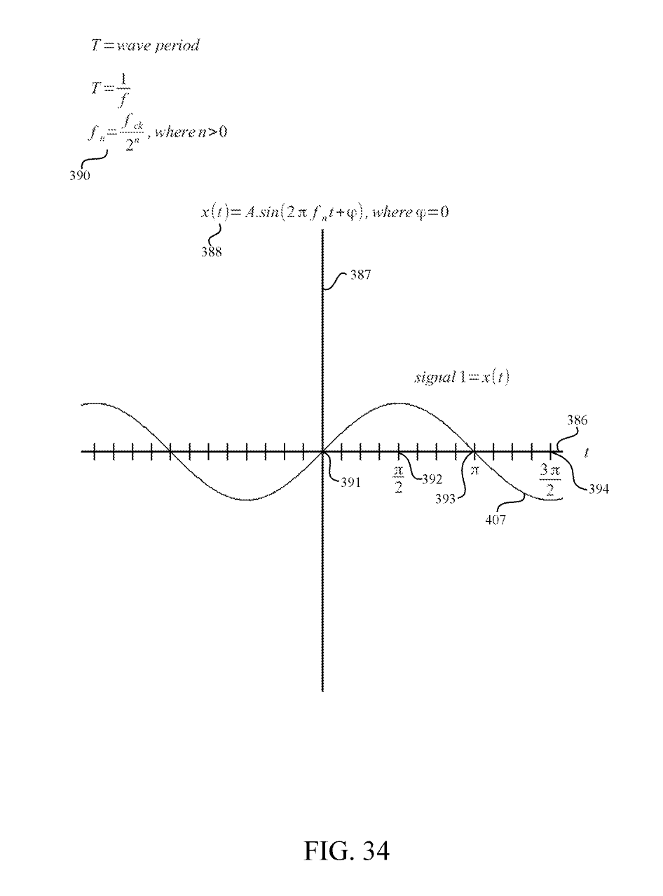

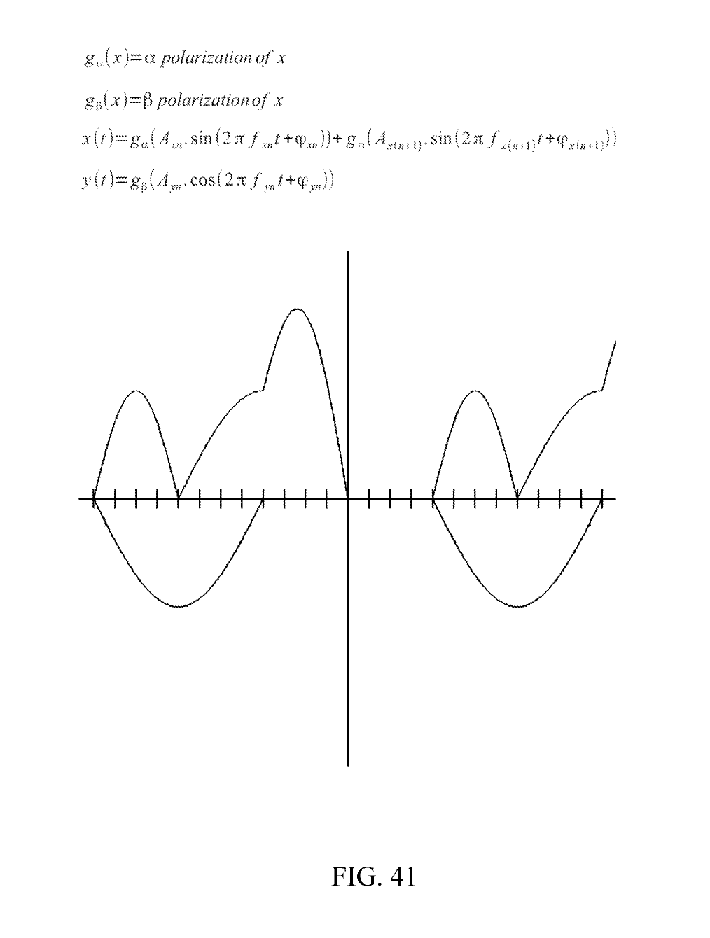

FIG. 34 thru FIG. 41 detail specifics of the data signals used in the functioning of the fractal computer. FIG. 34 shows a signal. This can be an input signal, an output signal or any of the communication signals that flow though the signal channels. The signal in this example is comprised of a single wave having a frequency, an amplitude and a phase shift. Time is represented by the x axis. 386. The diagram shows the four wave phase anles 391, 392, 393, 394 corresponding to points along the axis corresponding to phases of 0′, 90′, 180′ and 270′. 0′ or now is represented by the location of the y axis. Forward in time is off to the right of the diagram. Back in time is off to the left of the diagram. As the wave moves though time, it propagates from right to left. Amplitude and polarity are represented on the y axis 387. Positive polarity above the origin and negative polarity below the origin. The wave period is inversely proportional to the frequency. Each of the frequencies of the spectrum of doublings conforms to a conforming wave equation 390 and is denoted by fₙ where n is the sequential number of the doubling such as 1,2,3,4,5,6,7,8 and so on. fₙ Is derived from the phase clock signal f_{ck}. f₀ is the operating frequency of the clock and carrier wave and is not used for the data signals or wave components thereof. Each of the wave components of two signals in the examples correspond with a wave function 388, 389.

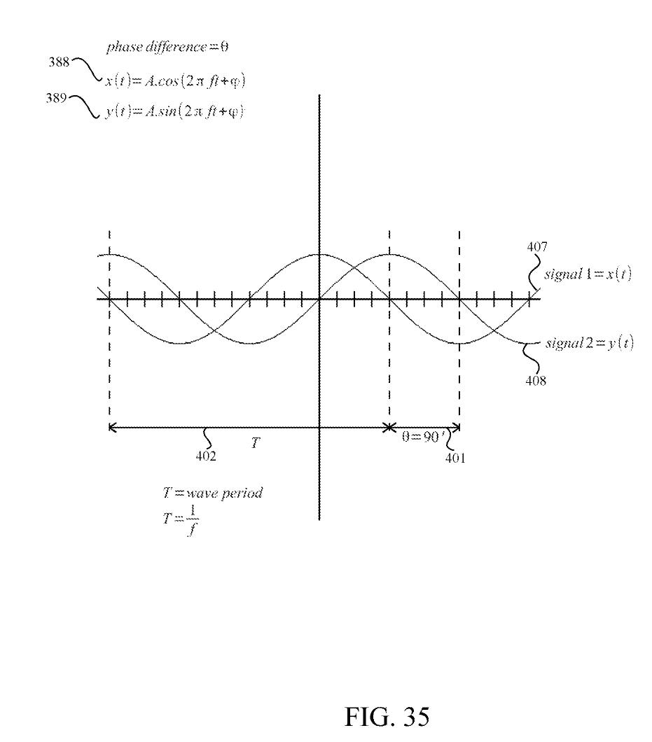

FIG. 35 shows two signals. Each signal has a single wave component of a single frequency. The two signals are out of phase by 90′ and represented in the digram by a phase shift 401 relative to the wave period 402. Each of the signals is a full wave 407, 408 and has both positive and negative polarizations.

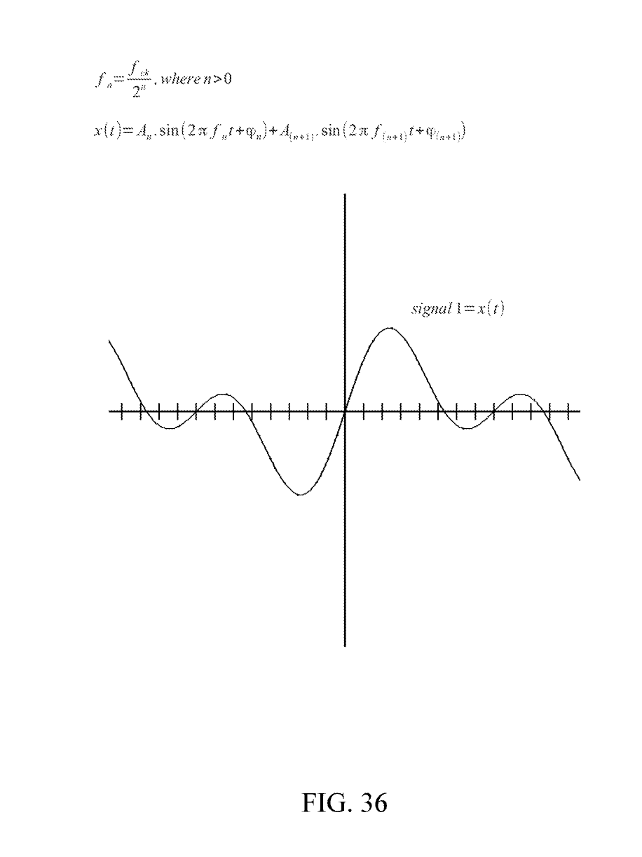

FIG. 36 shows a single signal comprising two adjacent waves.

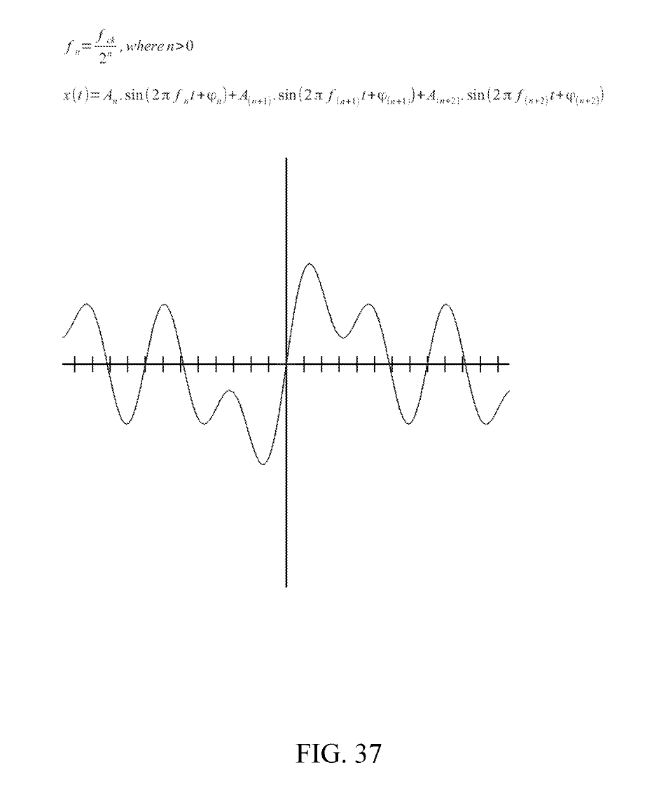

FIG. 37 shows a single data signal comprising three adjacent waves.

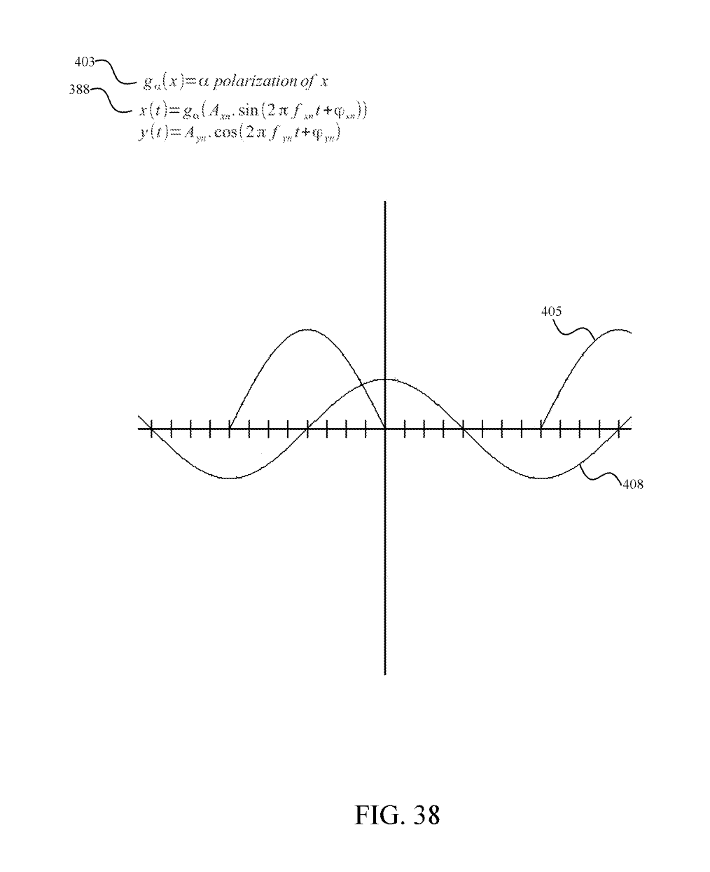

FIG. 38 shows two data signals. The first data signal is polarized 405 and the second data signal has both polarizations present 407 meaning that it is not polarized. At any point in the graph, the two signals can be made to coincide with opposite polarities. This is achieved by delaying one of the signals using a delay or phase shift. In the example provided, signal two can be delayed by 90′ (shifted to the right in the diagram) so that the peak of signal one aligns with the trough of signal two. This combination of signals forms a signal differential that is then used as the basis of the switching mechanism of the phase switch 206.

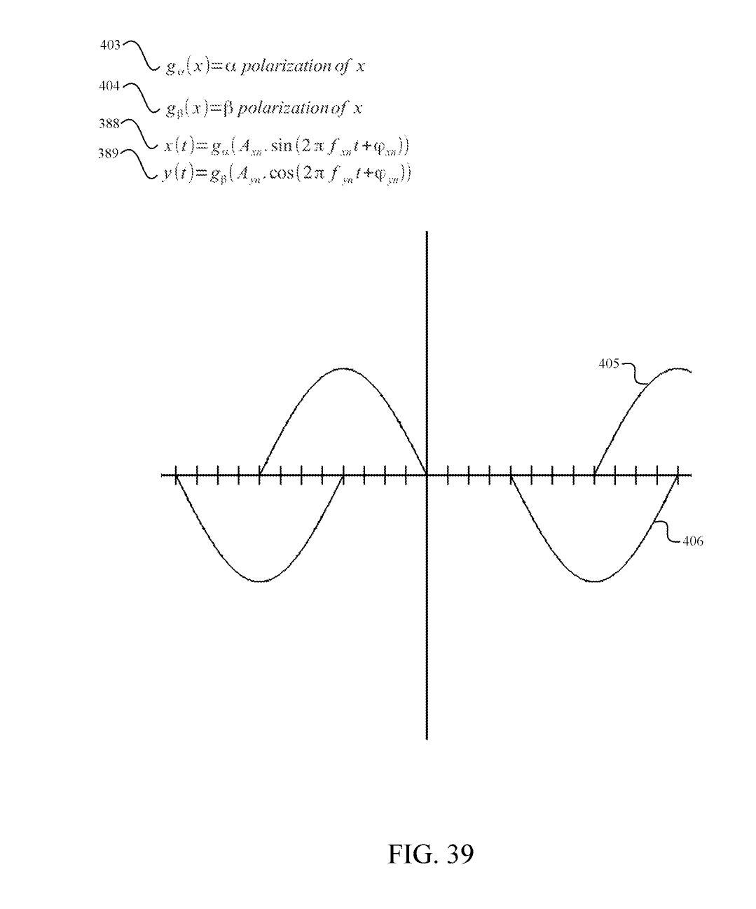

FIG. 39 shows two oppositely polarized signals having wave components of the same frequency. The polarization is represented by a polarization function 403, 404. Signal y can be delayed by 90′ so that the peaks and troughs align forming a signal differential. The amplitude of the signals is variable. The trigger point at which the phase switch 206 starts to channel data depends on the amplitudes of these data signals as well as the threshold trigger point set by the combination of gate amplifier and trigger threshold.

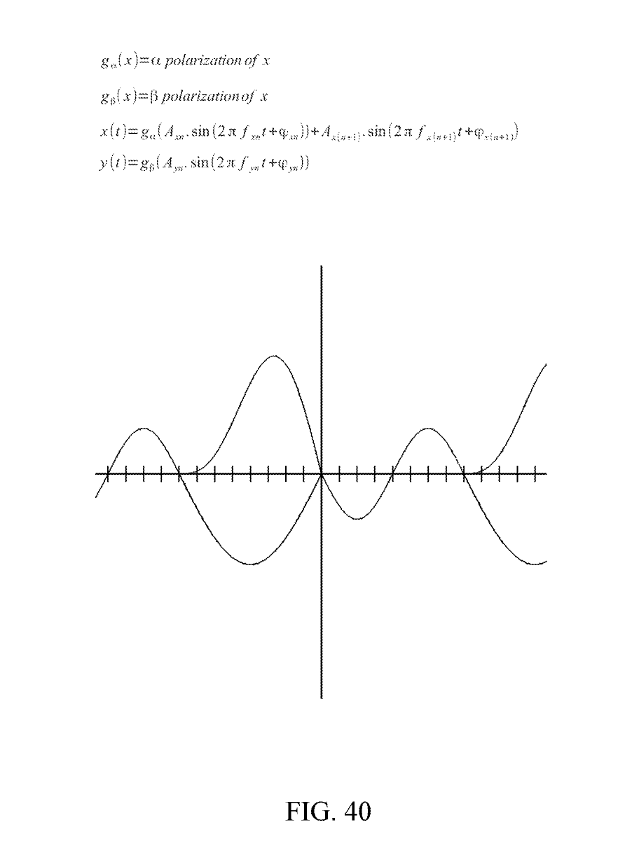

FIG. 40 shows a more complex pair of data signals formed from a polarized first wave of frequency f and its unpolarized adjacent doubled wave frequency f×2 in combination with a second oppositely polarized wave of frequency f.

FIG. 41 shows two polarized components forming a first data signal and a single polarized component forming a second data signal 405, 406.

This set of diagrams (FIG. 34 thru FIG. 41) illustrate how the parts of the wave are used to create a quaternary data signal. The relative frequency, phase, polarization and number of wave components in each signal are all relevant aspects of the relative quaternary fractal data signal.

The fractal data signal comprises one or more data pulses. Each data pulse comprises one or more waveform pulses wherein frequency conforms to 2ⁿ with respect to the lowest frequency said waveform pulse, where n is an integer value of 1 or higher. Said waveform pulse frequency is known as the operating frequency of said waveform pulse. Each waveform pulse further comprising oscillations of either a single polarization or alternating polarizations of a particular operating frequency. Said oscillations being done at regularly timed intervals determined by said operating frequency of said waveform pulse. Further said waveform pulse comprising one of the following: a half wave comprising positive polarization, a half wave comprising negative polarization or a full wave comprising both positive and negative polarizations. In other words, a full wave containing two polarized signals or a half wave containing a single polarized signal of one of type polarizations types. Multiple said waveform pulses of frequency 2ⁿ, where n is an integer value of 1 or higher, can be combined together into a single fractal data signal.

Essentially there are two structures represented in the data:

1) For any given pulse of duration t and frequency f, there can be multiple smaller pulses of duration t/2 and f×2, t/4 and f×4, t/8 and f×8, t/16 and f×16 and so on. Each being a doubling of the frequency and a halving of the pulse duration. Each higher frequency pulse fall within the time slice of the parent pulse half cycle to form a fractally encoded data tree of signals. Each data pulse is considered to be in two halves which are determined by the polarization. A positive half and a negative half. Each pulse can have both positive and negative components to the wave.
2) The other component of the data signal is the inverse of the first type. For every frequency f, there can be multiple larger pulses of duration t*2 and f/2, t*4 and f/4, t*8 and f/8, t*16 and f/16 and so on. Each being a halving of the frequency and a doubling of the pulse duration. Each lower frequency pulse has a time slice larger than that of the parent pulse half cycle. Each data pulse is considered to be in two halves which are determined by the polarization. A positive half and a negative half. Each pulse can have both positive and negative components to the wave.

The fractal computing unit has a plurality of signal channels operationally coupled to a plurality of three signal channel delay units, wherein each three signal channel delay unit of said plurality of three signal channel delay units operationally coupled to two adjacent parallel signal channels and a perpendicular signal channel; wherein said each three signal channel delay unit comprising a phase switch or a phase shift oscillator, or any combination thereof;

wherein said analog propagation unit further comprising:
a first phase shift unit;
a second phase shift unit;
a third phase shift unit;
a fourth phase shift unit;
a first fixed phase signal derived from said phase signal; and,
a second fixed phase signal derived from said phase signal and phase shifted by said first phase shift unit;
wherein said first signal channel grouping receiving a first fixed phase signal along a first axis and a second axis, and further receiving a second fixed phase signal along said first axis and said second axis wherein said second fixed phase signal shifted by a third phase shift unit; and,
wherein said second signal channel grouping receiving said second fixed phase signal along said said first axis and said second axis, and further receiving said first fixed phase signal along said first axis and said second axis, wherein said first fixed phase signal shifted by a fourth phase shift unit.

### Data Wave and Phase Wave Format

In an exemplary embodiment, quantized or amplitude modulated analog data is placed directly onto the electrical signal channels. The + and − polarizations of the waves traveling along the electrical wires, the frequency and amplitude of these waves all have specific function in the Fractal Computer.

In an alternative embodiment, analog data is transmitted along pathways using polarized light. Light polarity, pulse frequency and beam intensity all have specific function in the optical fractal computer. This method is optimal for the construction of the fractal computer. Light coded with data in this manner could be used to construct a fractal computer of the most complexity and of the fastest speeds. Light coded data can also be used for a four dimension spatial temporal fractal computer consisting of three spatial dimensions and one of time.

Each data signal comprises a wave of a single frequency or a plurality of waves of different frequencies taken from the set which includes all doublings of the lowest frequency. The fractal data signal pulse lasting the duration of the half wave of the lowest frequency or multiples thereof

In an alternative embodiment of the present invention, there are two full waves of the same frequency for each pulse offset by 90′ in a quadrature encoding. Each wave has a + component and a − component. Each full cycle therefor has 2 peaks and two troughs resulting in a total of four separate signals. These four signals correspond to the 4 types of the quaternary computer, alpha beta, delta alpha and delta beta. The ordering of the types with respect to the signals is important. The first + peak which corresponds with 0′ is equivalent to the alpha type. The second + peak which corresponds with 90′ is equivalent to the delta alpha type. The first − peak which corresponds with 180′ is equivalent to delta beta type. The second − peak which corresponds with 270′ is equivalent to the beta type. Each individual signal of said two data signals in a given signal channel is offset by 90′ with respect to the each individual signal of said two data signals flowing in the perpendicular signal channel.

The fractal computing unit has at least one data signal comprising:

a plurality of waves, wherein each wave of said plurality of waves having a frequency f derived from the following equation, f=(frequency of said phase clock signal)/2ⁿ where n is a positive integer and n≧1, and wherein said each wave synchronized with an external phase clock, and wherein a first polarized half wave of said each wave representing a first quaternary bit and a second polarized half wave of said each wave representing a second quaternary bit thus forming a quaternary fractal signal;
Data Signal Interaction with Phase Switch

Processing occurs in the fractal computer by alternating between type A FCU component and type B FCU component. Data is input into the signal channels where it can interact with any of the FCU components attached along the signal channel. At each point where a signal channel is attached to an FCU component, another signal channel exists perpendicular to the first signal channel. If the data interacts with the FCU component, it goes from the signal channel to the FCU component via an input to the FCU component. The FCU component then allows the data to flow to the nearby perpendicular signal channel via the FCU output and connection to the perpendicular signal channel. The data flowing through the FCU is polarized so that only the + or the − component of the input waveform is sent at the output of the FCU component. The FCU further comprises a delay that is a time delay equal to one quarter or multiples thereof of the wavelength of the operating frequency of which the FCU component is tuned. Each time the data rotates through 90′ a delay equivalent to 90′ of the frequency of the tuned FCU component is applied to all components of the input data.

### Strobe.

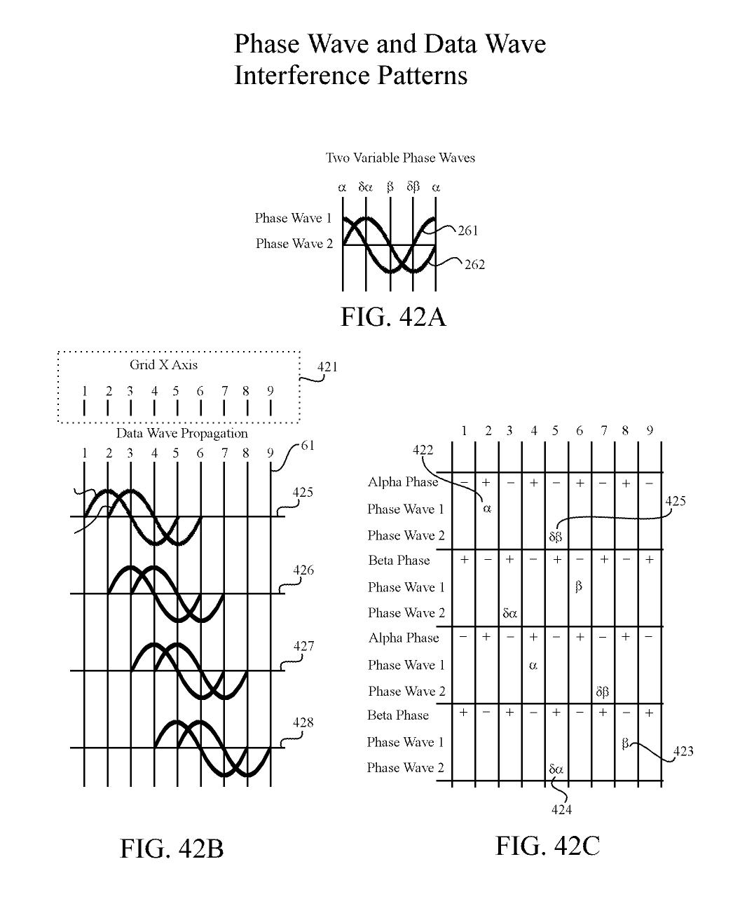

FIG. 42 shows the interference of the phase wave and the data wave. This interference provides the peaks and troughs which comprise the data signals. FIG. 42A shows the two variable phase waves. FIG. 42B shows two data signals propagating through a sequence of nine signal channels on one of the axes 421 of the surface quadrilateral super mesh 84. The signals are shown time sliced 425, 426, 427, 428 into for separate time quanta. The first signal starts at the top section of the chart at signal one. In the next time slice (which is synchronized with the clock), the first data signal is shown propagated to the second signal channel. This is shown as the second section of the chart in FIG. 42.B. The signal continues to propagate across to the right as shown in the third and fourth sections of the chart. FIG. 42C shows the effect of the variable phase wave with respect to the surface of the surface quadrilateral super mesh 84. The variable phase wave acts as a strobe to highlight different aspects of the data signal 422, 423, 424, 425 thus allowing the phase switches 206 to activate on the signal combination. As the frequency of the variable phase waves is altered by doubling or halving the variable phase waves, the strobe grid formed by the variable phase waves will change in density thus allowing either a higher resolution of processing or a lower resolution of processing to be performed. This mechanism also allows the use of a single set of phase switches 206 for the purpose of routing signals irrespective of the absolute frequency of the data signals. In this way the signal routing is frequency (as in scale) agnostic and represents a self similar fractal aspect of the computing mechanism. The critical part of the routing in this instance is controlled by the relative nature of the waves in the input data signals

Processing starts on one of the signal channels. It is then routed through 90′ by a type A or type B polarizing switch 205 to a perpendicular signal channel. Processing continues along the perpendicular signal channel to another polarizing switch 205. This one must be the opposite type from the earlier one. This is to achieve the type A, type B alternating processing. To achieve this alternating processing, the output of one polarizing switch 205 and the input to the next polarizing switch 205 in the sequence are on the same signal channel. It therefor follows that there need to be both types type A and type B FCU components present along each signal channel. The minimum for this is one of each type. Also to achieve the 90′ routing of the phase switch 206, the data buses must form a structure that can support this. Following this simple rule the minimum layout of the four FCU components can be determined. When arranged as four units on a flat surface to form an offset square with a central data bus, the data flows in a figure of 8 pattern alternating type A FCU component then type B FCU component then type A and so on.

The fractal computing unit comprises:

a first frequency divider;
a second frequency divider;
a first variable phase signal derived from said phase signal and divided by said first frequency divider unit, or derived from a second signal, or any combination thereof;
a second variable phase signal derived from said phase signal, wherein said phase signal phase shifted by a second phase shift unit and further divided by a second frequency divider unit or derived from a third signal, or any combination thereof; and,
an output signal, wherein said phase switch upon switching to an active state, routing said input signal to said output, wherein said switching to an active state triggered by an interference signal received on said gate of said phase switch, wherein said interference signal exceeds the trigger threshold of said phase switch, wherein said signal optionally amplified by said threshold amplifier, and wherein said threshold trigger optionally lowered by said programming signals; wherein said interference signal comprising a combination of said input signal, said propagated signal, said variable phase wave signal, and said fixed phase wave signal.

### Fractal Data Signal Routing

In an exemplary embodiment, the fractal computer unit possesses the capability to conditionally route data signals from an input signal channel to an output signal channel. This is done with the use of switches 205 each of which connect to a first signal channel and at least one signal channel that is perpendicular to said first signal channel.

The conditional routing of the data signals is determined by the composition of the input fractal data signal as well as the location and operational characteristics of the phase switches 206 along the path of the fractal data signal. Each half wave rectified component of said full wave signal can optionally be routed differently through the plurality of phase switches 206 acting as half wave rectifiers with regard to the other half wave of the full wave signal. Computation starts with two full waves of multiple frequencies on one each of two perpendicular signal channels respectively. A full wave signal activates a principal type phase switch 206. The signal is then routed by the phase switch 206 junction to a new signal channel. The wave is now a half wave as it has been filtered through the half wave rectified in the first principal phase switch 206. The full wave Signal also activates a context type phase switch 206. The signal is then routed by the phase switch junction to a new signal channel. The wave is now a half wave as it has been filtered through the half wave rectifier in the context phase switch 206.

This double thread will continue to lengthen until the system is reset. This double thread acts as a potential. At any time, this potential can be used to form other phase switches 206. These phase switches 206 can then route the signal further which enhances the potential and provides even more options for phase switches 206.

The fractal computing unit is characterized in that said FCU is a type A FCU, or a type B FCU, or a combined type AB FCU,

wherein said polarization of each phase switch of said type A FCU is a first polarization;
wherein said polarization of each phase switch of said type B FCU is a second polarization;
wherein said polarization of each phase switch of said type AB FCU is a first polarization or a second polarization.

### Trunk Information Potential

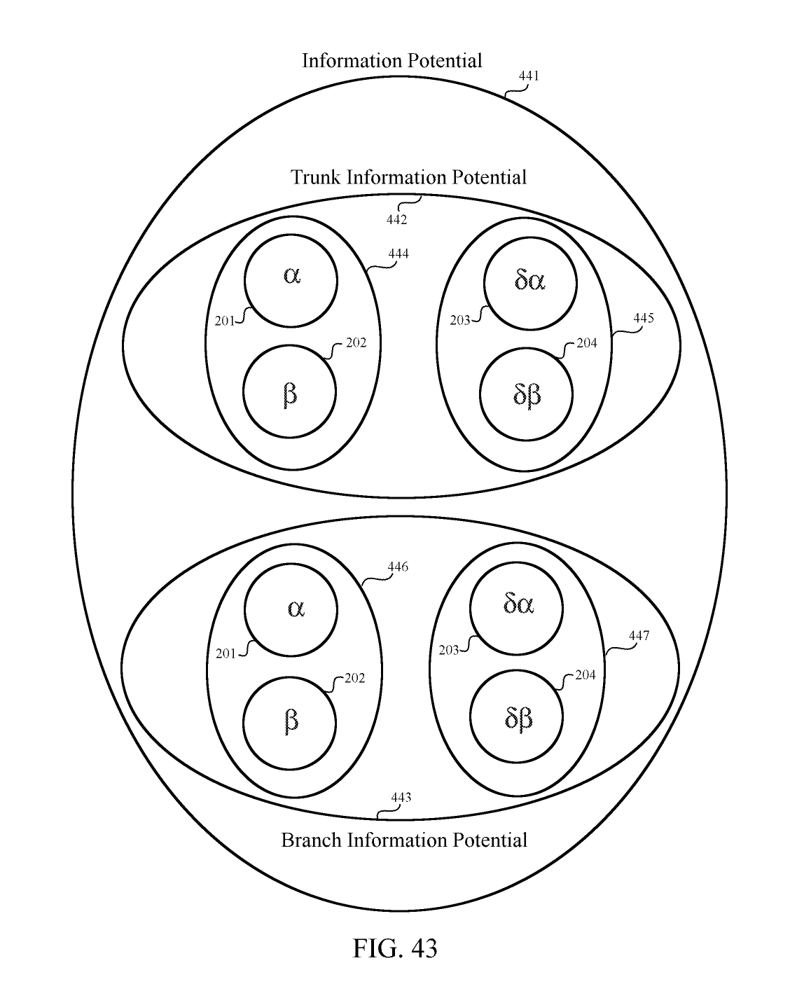

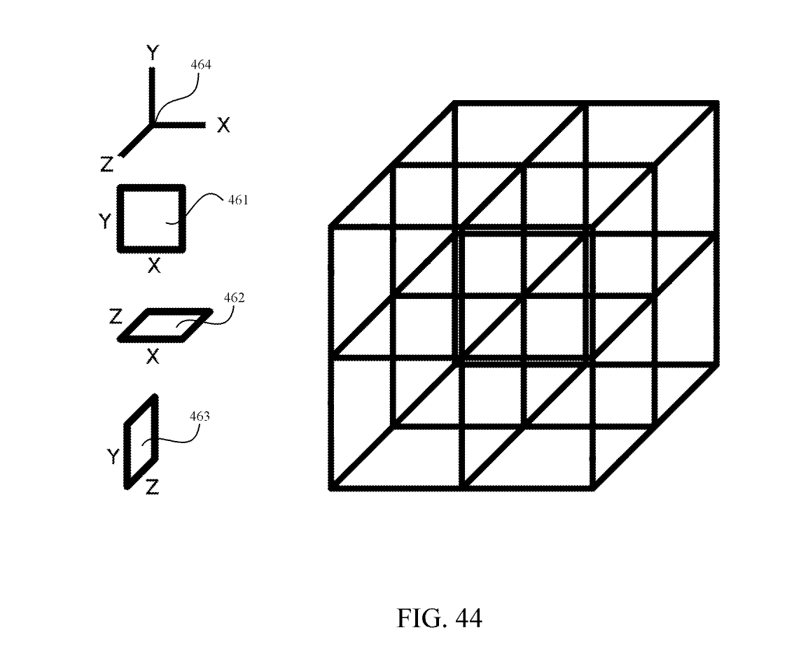

FIG. 43 shows the arrangement of the information potential 441 and the trunk 442, 444, 445, branch 443,446, 447, principal 444, 446 and context 445, 447 information potentials. As mentioned, data pulses do not need the phase pulses to be present to propagate through existing phase switches 206 that have a low trigger threshold. The carrier wave is sufficient as long as there is a closed circuit between the injection point and the output point. Any data pulses other than the carrier wave appearing at the output point are examples of a computation.

If however, the phase switches 206 do not form a complete closed circuit, then there is no path for the computation to complete. At this point, the phase wave is enabled so that a computation solution can be searched for. This allows the data waves at all signal channel intersections of the current computation to radiate. The data waves are in search of a phase switch 206 that can complete the circuit (if indeed such a solution to the present computation is possible). So at the end signal channel intersection of the trunk information potential 442 formed by phase switches 206 having a high trigger threshold, the wave will still propagate though phase switches 206 by utilizing the variable phase wave to increase the signal level so that the phase switch 206 can be switched to the on position by components in the input data signal. As long as there is a closed circuit (comprising both trunk information potential 442 and branch information potential 443) between the injection point and the output point, the data pulses can be routed to the output point. Any data pulses other than the carrier wave appearing at the output point are examples of a computation. If the output pulses match with a predefined pulse at the output location, then a direct current programming pulse is activated by the completion of the circuit. This programming pulse will strengthen the links in the phase switches 206 by lowering the trigger threshold. In this manner, the programming pulse will affect the outcome of future computation done using the same connection points and phase switches 206. The functional groupings in the information potential 441 are shown in FIG. 43. The information potential 441 is comprised of a trunk information potential 442 and a branch information potential 443. The trunk information potential 442 is further comprised of a trunk principal information potential 444 and a trunk context information potential 445. The trunk principal information potential 444 further comprises all the principal components and the trunk context information potential 445 comprises all the context components. In a principal phase shift component, the phase shift at the base of the transistor operates at twice the frequency of the phase shift at the collector. This compares two wave and phases that are relative to each other at the base and collector. In the context component, the operating frequency of the phase shifter at the base is half the operating frequency of the phase shifter at the collector.

As mentioned above, the phase clock is presented at each of the individual signal channels as well as at the base terminal of the data pulse phase switches 206. These form two distinct functions for the phase pulse. The phase pulse can be further split into two. In this arrangement, the signal channels have a 1 to 1 correspondence with the phase pulse. The phase pulse at the base terminal of the data pulse phase switches 206 can be an exact fraction of the main phase pulse. For example it can be half the frequency, a quarter of the frequency or an eighth of the frequency and so on. All fractions are in accordance with ½ⁿ where n is an integer. Altering the variable phase wave to the data phase switches 206 changes the nature of the circuit stem and branch information potential used to perform a computation. It can also be used to increase and decrease the resolution of a particular calculation. The relative speed of the base terminal phase signal to the main phase signal can thus be altered. It works very much like a strobe light with respect to the propagating waves and their interaction with the phase switches 206 at the signal channel intersections of the surface quadrilateral mesh 64. The base phase clock can be halved or any multiple thereof. In this way, the resolution of the computation can be enhanced or reduced.

The fractal computing unit further characterized in that said phase switch comprising quantum scale components and utilizing quantum effects.

### Shared Base Between Propogation Pulse and Real Data Pulse

The propagation mechanism allows for the momentary completion of a circuit the duration of which is equal to or greater than the length of 1 tick of the fixed phase clock. This momentary circuit completion is enough time to change the state of a phase switch 206 and to transfer a charge onto the polarization neighboring phase switch 206. The base of the transistor or gate of each of the phase switches 206 is connected to the phase clock signals. This essentially allows a particular path to be tested as the wave propagates outward. A small charge is transferred from phase switch 206 to the next one as this mechanism progresses. This charge serves to keep the phase switch 206 in the on position for a short period of time equal to one clock tick. Once a phase switch 206 has been located that allows a completion of the input data signal and pulse with the output data signal location and pulse, the programming circuit is completed. This allows a programming pulse to flow through the gate that was activated by the phase clock pulse.

The fractal computing unit is further characterized in that said FCU is a two dimensional spatio-temporal fractal computer unit, or a three dimensional spatio-temporal fractal computer unit, or a four dimensional spatio-temporal fractal computer unit, or an n-dimensional fractal computer unit, or any combination thereof;

wherein said two dimensional spatial-temporal fractal computing unit characterized in that said plurality of signal channels of said super mesh arranged forming a mesh of parallel signal channels, wherein said phase shift units comprising a phase shift selected from the group consisting of: 0′, 180;
wherein said three dimensional spatial-temporal fractal computing unit characterized in that said plurality of signal channels of said super mesh arranged forming a two dimensional surface quadrilateral mesh, wherein said phase shift units comprising a phase shift selected from the group consisting of: 0′, 90′, 180′, 270;
wherein said four dimensional spatial-temporal fractal computing unit characterized in that said plurality of signal channels of said super mesh arranged forming a three dimensional hexahedron mesh, wherein said phase shift units comprising a phase shift selected from the group consisting of: 0′, 60′, 120′, 180′, 240′, 300′;
wherein said n-dimensional spatial-temporal fractal computing unit characterized in that said plurality of signal channels of said super mesh arranged forming a three dimensional hexahedron mesh, wherein said phase shift units comprising a phase shift conforming to the equation x*360/n where n is the spatial-temporal dimension and x is an integer where x≧0.

### Four Dimensional Fractal Computer Detail

FIG. 44 shows a hexahedron super mesh 465 formed from three surface quadrilateral super meshes 84. The first surface quadrilateral super mesh 461 forms the X and Y axes of the hexahedron super mesh. The second surface quadrilateral super mesh 462 forms the X and Z axes of the hexahedron super mesh. The third surface quadrilateral super mesh 463 forms the Y and Z axes of the hexahedron super mesh. The signal channels intersect at the X,Y,Z axis intersections 464.

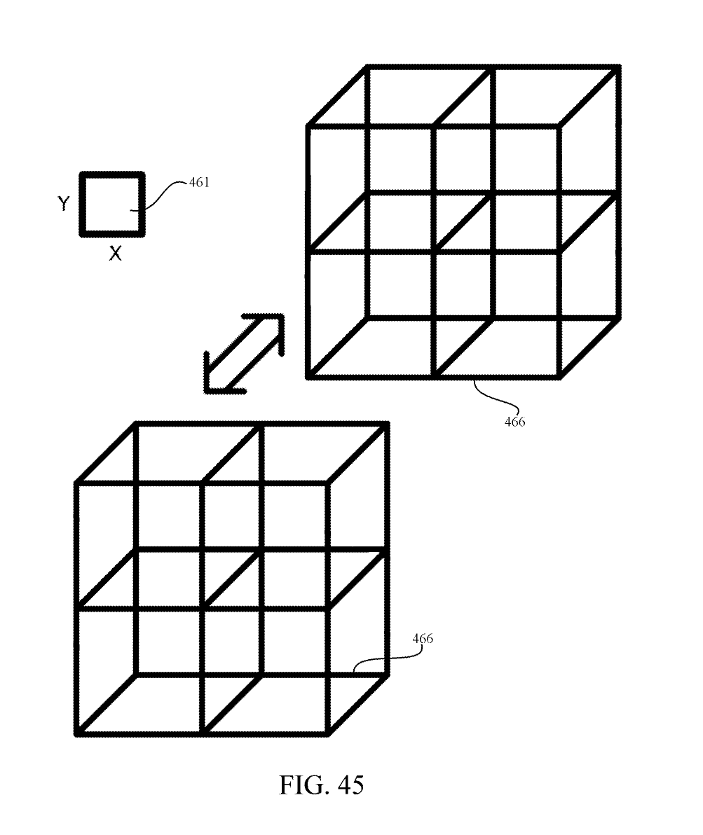

FIG. 45 shows two X,Y surface quadrilateral super meshes 461 being coupled together. The data bus 466 joining the super meshes can be very small or even removed entirely. The bus can be comprised of a thin film of material allowing the signals to propagate from one mesh to the other.

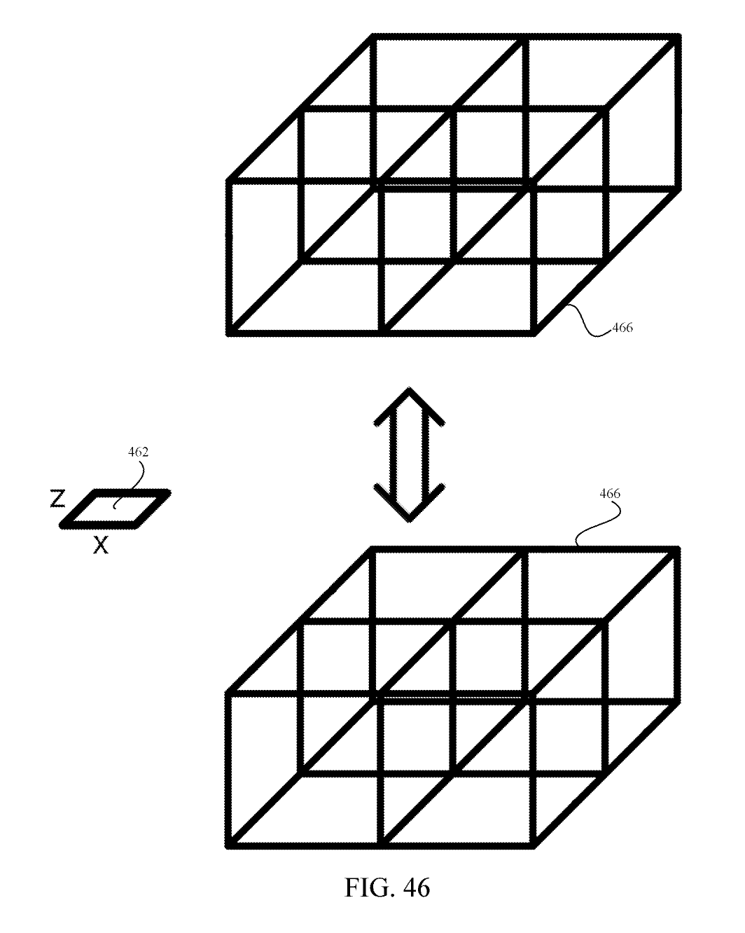

FIG. 46 shows two X,Z surface quadrilateral super meshes 462 being coupled together. The data bus 466 joining the super meshes can be very small or even removed entirely. The bus can be comprised of a thin film of material allowing the signals to propagate from one mesh to the other.

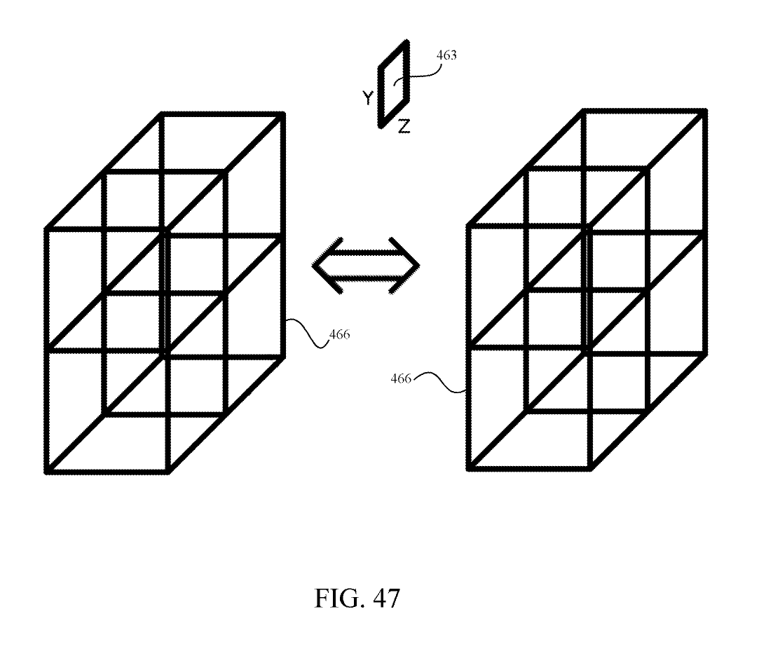

FIG. 47 shows two Y,Z surface quadrilateral super meshes 463 being coupled together. The data bus 466 joining the super meshes can be very small or even removed entirely. The bus can be comprised of a thin film of material allowing the signals to propagate from one mesh to the other.

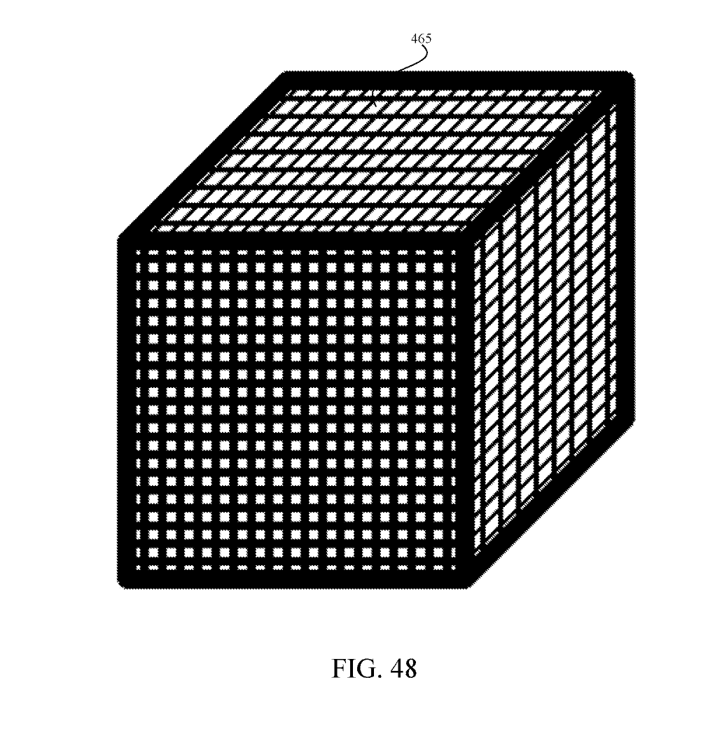

FIG. 48 shows a higher level view of the hexahedron super mesh 465. Each of the phase switches 206 are located at the intersection points of the three signal channels forming the X, Y and Z axes.

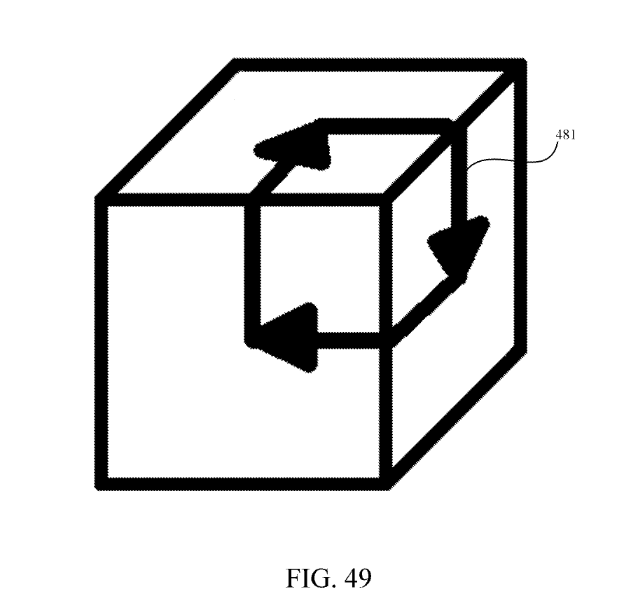

FIG. 49 shows the rotation 481 of the signals forming the principal components. The two types of polarization used for the four dimensional spatio-temporal fractal computer are rotating or circular polarizations.

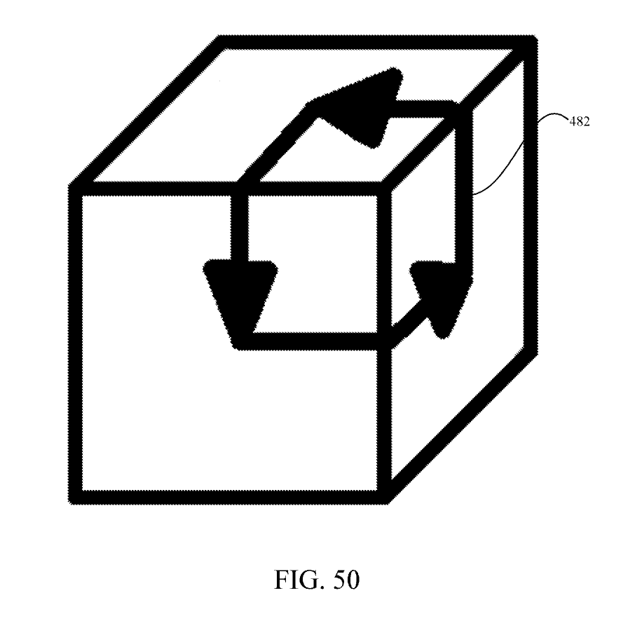

FIG. 50 shows the rotation 482 of the signals forming the context components.

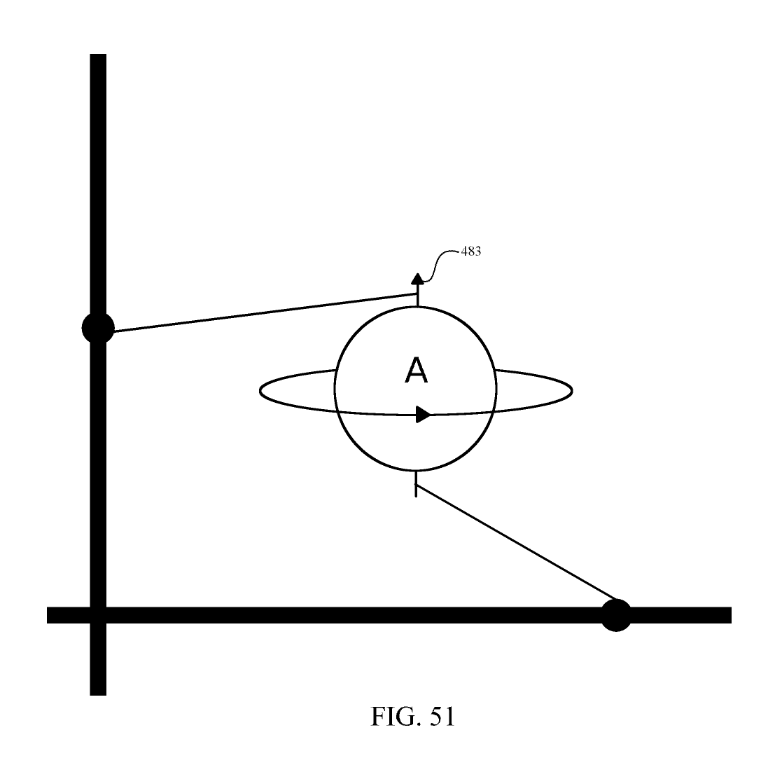

FIG. 51 shows the alpha phase switch 213 of the four dimensional spatio-temporal fractal computer represented as atoms or quantum scale components with an up spin 483.

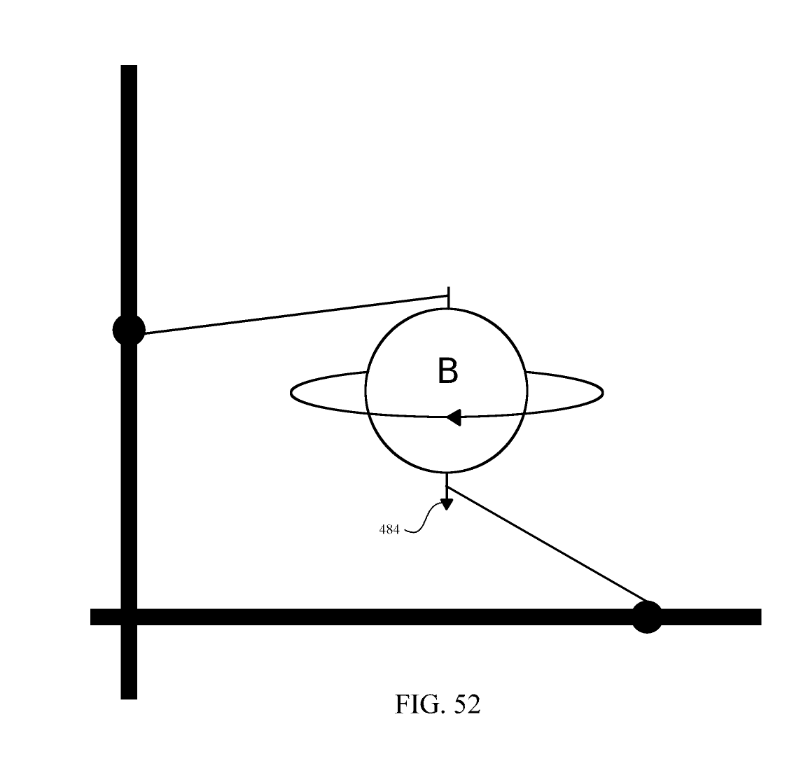

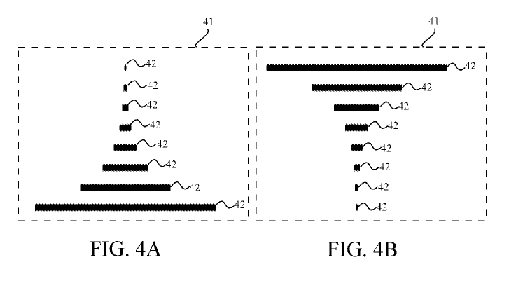

FIG. 52 shows the beta phase switch 214 of the four dimensional spatio-temporal fractal computer represented as atoms or quantum scale components with a down spin 484.

The fractal computing unit has a switching unit further comprising a threshold unit having a threshold characteristic selected from the group consisting of: automatically alterable by a signal produced by said fractal computing unit (FCU), alterable by an external signal, alterable by an external wave, alterable by a pulse, alterable and set at the time of manufacture, unalterable and set at the time of manufacture, or any combination thereof.

### Modes of Operation

A Fractal Computer system is capable of operating in two modes—learning mode and playback mode. The learning mode comprises a surface quadrilateral mesh 64, one or more polarization components, one or more phase shift components, and a phase clock. Information is processed in the form of data signals. The system of the playback mode comprises a surface quadrilateral mesh 64, one or more polarization components, one or more phase shift components process information in the form of data signals. In an exemplary embodiment both systems and both modes of operation will be present.

In an alternative embodiment of the fractal computer, only the playback mode is present.

The fractal computing unit is characterized in that said phase switch comprising an optical transistor selected from the group consisting of: optical transistor based on electromagnetically induced transparency in an optical cavity microresonator, optical transistor based on electromagnetically induced transparency using interacting Rydberg states, exciton-based optical transistor using indirect excitons composed of bound pairs of electrons and holes in double quantum wells with a static dipole moment, microcavity polaritons based optical transistor using exciton-polaritons inside an optical microcavity, optical transistor based on photonic crystal cavities with active Raman gain medium, optical transistor based on nanowire-based cavities employing polaritonic interactions, optical transistor based on silicon microring, optical transistor based on dual-mirror optical cavity using quantum interference.

### Basic Principle of Operation

The basic principle on which the fractal computing device operates is to match an input pattern in the form of a spread spectrum encoded fractal data pulse with another pattern in a similar format. The matching of the two patterns applies to both the content of the spread spectrum encoded data pulse (the pattern) as well as the locations of the patterns (which signal channel is used for the input and which signal channel is used for the output). Both the pattern and its location affect the computation performed. Once a pattern match along with a location match has been achieved, a circuit is completed forming a closed circuit though which current is able to flow. This circuit completion can mean one of two things depending on whether the fractal computer is in a learning mode at the time or in a playback more. In the learning mode, circuit completion is used to generate and route a programming signal pulse that is used to reinforce the links of the individual components that caused the data pulse to appear at the output location. In the playback mode, the circuit completion forms part of a larger system of computation in which the plurality of phase switches 206 used to form a closed circuit are part of a higher level compound phase switch.

The circuit is formed from a trunk part referred to as the trunk information potential 442 and a branch part that completes the circuit, known as the branch information potential 443. phase switch 206 components in the trunk information potential 442 do not require phase signals to channel the signals whereas phase switches 206 in the branch information potential 443 initially require the variable phase signals so that the trigger threshold can be lowered. Eventually a frequently used branch information potential 443 will mature into a part of the trunk information potential 442 with the corresponding change to the threshold trigger of the relevant phase switches 206.

An electric trunk information potential 442 can form a complete circuit for a set of given patterns. Patterns outside this set will not form a circuit through the trunk information potential 442. Data signals presented at the input of the trunk information potential 442 will not flow to the output location. The data is made to flow through the trunk information potential 442 by the use of high frequency electric pulses that flow throughout the surface quadrilateral mesh 64 and act as a carrier wave for the data signals. Using the high frequency pulses, the data signals are able to flow through the trunk information potential 442 and then propagate outward until a branch circuit is formed that allows the circuit to complete. At this point, the pulse generated from the circuit completion reinforces the links in the branch circuit. After many such reinforcements, the branch circuit link forms an extended part of the trunk information potential 442 by virtue of having a lower trigger threshold. The other factor in the determination of the location of the branch circuit phase switches 206, is the gate phase pulse which can be of varying frequency. The gate phase pulse will act as a filter to allow only branch completion circuits that have a given phase and frequency relationship relative to the originating data signal point, which is the usually the last signal channel intersection in the trunk information potential 442.

The fractal computing system has a fractal computing system comprising:

a two dimensional fractal computer unit (2-D FCU), or a three dimensional fractal computer unit (3-D FCU), or a four dimensional fractal computer unit (4-D FCU), or an n-dimensional fractal computer unit (N-D FCU), or any combination thereof,
wherein each said fractal computer unit (FCU) comprising said combination thereof, operationally coupled thus forming a multi-dimensional fractal computing system.

### Programming and Learning

The Fractal computer can be programmed in several different way. A first programming method where a closed circuit is formed and a programming pulse flows to each of the phase switches 206 thus reinforcing the links in the phase switches 206 and affecting future computation. A second programming method, where the individual phase switches 206 are preprogrammed at the time of manufacture by a variety of different methods in order to perform a set of predefined tasks. A third programming method as follows: providing three simultaneous inputs. These three simultaneous inputs determine which of the individual intersections is to be programmed. The frequencies of the three simultaneous input signals determine which two signal channel intersections in the intersection are to be programmed. There are two phase switches at each signal channel intersection programmed at each time, one for the + phase clock and one for the − phase clock signal thus forming programming of a phase switch pair. The programming signal inputs are 1) a first signal on a given signal channel, 2) a second signal on a perpendicular signal channel and 3) a third signal from the phase clock. A signal channel intersection thus programmed will allow data to flow through the phase switch 206 to the output when two simultaneous signals appear on the two inputs.

phase switches 206 at the signal channel intersections will gradually revert back to a higher trigger threshold. As a result, signal strength sill needs to be stronger for the given inputs to reach the threshold of the phase switches 206 at the signal channel intersections. Multiple programmings of a phase switch 206 at a signal channel intersection will slow down the rate at which the threshold trigger decays. Increasing the intensity of the input signals also reduces the rate at which the trigger threshold of the phase switches 206 at the signal channel intersections decay. At the highest intensity, the trigger threshold of the phase switches 206 at the signal channel intersections will become permanent and no longer decay.

In an alternative embodiment of the present invention, a means allowing a phase switch at a given signal channel intersection to be erased to a non-conducting state.

In an alternative embodiment of the present invention, the conductivity of phase switches at the signal channel intersection can be remembered or forgotten by the fractal computer by the use of a latch.

In an exemplary embodiment, various aspects of the phase switches 206 can be modified by data signals that coincide at a specific location on the surface quadrilateral mesh. The frequency and intensity of the two input data signals and output data signal will determine which part of the phase switch 206 is altered electronically. High intensity signals will form a permanent phase switch 206 with respect to the given set of coincident signals. Lesser signal strengths will result in a gradual decay to the conductivity and sensitivity of the phase switch 206. Even lower power signals will result in a steeper gradient of decay for the electrical conductivity. A phase switch 206 of a given frequency is selected by the frequency of the input data signal. The phase pulse determines whether the phase switch 206 is a type alpha, beta, Principal or Context. All four types would normally be present on the same signal channel intersection. The output signal in conjunction with the input signal determines the exact location on the X,Y surface quadrilateral mesh 64 that is to be programmed or electrically altered.

In an alternative embodiment, the same exact method is used in conjunction with data signals using optical switches and optical fibers or a mix thereof

In an alternative embodiment, the phase switches 206 and FCU are formed from a read only memory or ROM in which the phase switches 206 are preset so that the chip is pre-wired to perform a certain set of predefined computations.

In an alternative embodiment, the phase switches 206 and FCU are formed from random access memory or RAM chip that comprises electronically alterable memory cells at the intersection of the two input wires and 1 output wire. This memory cell will remember if an output is present at precisely the same time that the two phase shifted inputs are present. Each time the three way combination of signals is present, the memory in the memory cell becomes more permanent. The threshold value can be set using an electronically alterable memory cell or functional equivalent.

In an alternative embodiment, the phase switches 206 comprise an FGMOSFET device or functional equivalent. The state of the phase switch 206 can be altered by changing the conductivity of the FGMOSFET device.

A fractal computing system comprises:

a clock;
at least one signal comprising at least one wave wherein said at least one wave having a frequency in accordance with the equation f=(frequency said clock)/2ⁿ, wherein n is an integer and n≧1 and f is the frequency of said at least one wave;
a second wave having a frequency in accordance with the equation f=(frequency or said clock)/2ⁿ, wherein n is an integer and n≧1 and f is the frequency of said second wave; and,
means to conditionally route said at least one signal based on the relative frequency, or phase or polarity, or any combination thereof, of said at least one wave with respect to said second wave.

### Entropy

There are at least two main areas to entropy. The first relates to the process of emergence in that when the programming pulses are divided amongst the number of signal channel intersections in a chain, the chains with fewer signal channel intersections will emerge as a more efficient solution or pathway to achieving the pattern match or computational solution. The second main area is that even in the non learning state, the optimum solution will the the one with the lowest energy state and this will form a closed circuit with least energy first prior to solutions requiring higher energy to complete. Further, the emergence of a solution is further enabled by having multiple parallel processes providing outputs. Where the outputs are the same, the closed circuit current for a given circuit will increase thus creating a greater possibility for the closed circuit to complete. The net effect of this process is that a solution will emerge from a disparate set of inputs. Said solution being the most relevant and most efficient to match the plurality of inputs with the desired goal.

The fractal computer system is characterized in that said means to conditionally route comprising at least one crystal, wherein said crystal selected from the group consisting of: nanocrystal, quantum dot, periodically polled crystal, Lithium Niobate crystal, Lithium Tantalate crystal, twisted nematic liquid crystal, optical lattice crystal, rare earth doped laser crystal, rare earth ion doped crystal, indium tin oxide crystal, carbon nanotube crystal, graphene crystal, flouride doped tin oxide crystal, doped zinc oxide crystal, nanowire crystal, or any combination thereof.

### Local and Non Local Processing

The idea here is that processing can be performed using neighboring phase switches 206. The processing will rotate around a given signal channel intersection using local interactions only. Similarly processing can be effected by interactions among non-local signal channel intersections. This interaction uses the signal channels in conjunction with the interference patterns created between the data waves and the phase waves to effect non-local processing. The difference between the two is effected by the strobe frequency. At higher strobe frequencies, processing will occur locally. As the frequency doubles, processing will use signal channel intersections that are at multiples of this doubled frequency to complete. The degree to which a processing circuit can be tuned in this way affects the resolution on which the circuit is performing. It is also related to the spatial distribution of the processing signal channel intersections in a fractal processing circuit. Different upper and lower bounds of the variable phase frequency are able to tune the processing within a given spatial domain. This domain has a fractal distribution and many scales. Processing can even be made to be scale dependent by choosing different phase frequencies and frequency bands at different scales.

The fractal computing system is characterized in that said fractal computing system performing at least one application of artificial intelligence (AI) or operatively coupled to a system performing at least one application of artificial intelligence (AI), wherein said performing at least one application of artificial intelligence (AI) comprising: machine learning, speech recognition, natural language understanding, audition systems, computer vision systems, image processing, movement systems, robotics, artificial speech, face recognition systems, expert systems, medical diagnosis, robot control, language translation, machine driving or any combination thereof

Playback without Phase Clock

Only circuits formed from the trunk information potential 442 are able to effect computation. A computer built without a phase clock will have a limited use.

Playback with Phase Clock

Playback with the phase clock can be used to learn new computations. To change the resolution of the computation during playback with phase clock, the programming pulse can optionally be activated to all programming during playback.

The fractal computing system is characterized in that said means to conditionally route comprising at least one FCU,

wherein said fractal computing system further comprising a plurality of fractal computer units (FCUs)
wherein said plurality of fractal computer units are operationally coupled and further wherein the spatial distribution of said plurality of fractal computer units selected from the group consisting of: a sequentially repeating tiling pattern,
a sequentially repeating quadrilateral surface formed on the surface of a cylinder,
a sequentially repeating quadrilateral surface tiling pattern formed on the surface of a cube,
a sequentially repeating quadrilateral surface tiling pattern formed on the surface of a cuboid,
a sequentially repeating quadrilateral surface tiling pattern formed on the surface of a spheroid,
an arbitrary spatial distribution,
a periodically changing dynamic spatial distribution,
an expanding FCU distribution resulting from the dynamic addition of an FCU,
a contracting FCU distribution resulting from the dynamic removal of an FCU;
an expanding FCU distribution resulting from the dynamic addition of a plurality of FCUs,
a contracting FCU distribution resulting from the dynamic removal of a plurality of FCUs,
a dynamic spatial configuration of FCUs operationally coupled to a network,
a static spatial configuration of FCUs operationally coupled to a network,
a second plurality of fractal computer units operationally coupled to at least one fractal computer unit of said plurality of fractal computer units thus forming a nested parallel fractal computer system, or any combination thereof.

### Fractal Computing System

In another embodiment of the present invention, a fractal computing system comprising at least one fractal computing device. Said computing system may optionally be connected in combination with any other fractal computing device or a plurality of devices thereof, or any other computer device or a plurality thereof including but not limited to conventional CPUs, graphics processors, GPUs, RISC processors, conventional computer memory, EPROM memory, ROM memory, RAM memory, EAROM memory, optical memory devices, quantum computing devices, nano-computing devices, nano-crystals, quantum dot devices, CDROM storage, hard disk storage, conventional data bus, input/output devices, keyboard input device, mouse input device, microphone, audio processing device, speaker, video camera, video camera device, monitor output device.

The fractal computation comprising the steps of:

a) receiving a first plurality of inputs;
b) generating a plurality of signals from said plurality of inputs;
c) sending said plurality of signals along a first plurality of signal channels;
d) receiving said plurality of signals by an information potential, wherein said information potential comprising a first plurality of phase switches operationally coupled to said first plurality of signal channels;
e) comparing characteristics of said plurality of signals with characteristics of said first plurality of phase switches to generate a plurality of signal match characteristics;
f) altering said plurality of signals in accordance with said signal match characteristics;
g) routing said plurality of signals to a second plurality of signal channels in accordance with said signal match characteristic;
h) forming a plurality of closed loops (circuits) each comprising a second plurality of phase switches;
i) propagating said plurality of signals with a plurality of time delay units in synchronism with a phase clock signal;
j) creating said first plurality of inputs from a second plurality of inputs in combination with said plurality of signals;
k) advancing the phase clock signal; and,
l) repeating steps a) to k) until there are no further signals of said plurality of signals.

### Fractal Computation Method

An exemplary embodiment of the present invention is a method of processing data in a fractal manner. The fractal computation method can be performed in any number of dimensions. In an exemplary embodiment, the fractal computation method comprises a three dimensional spatial temporal method. The three dimensional spatial temporal fractal computation method comprises the following aspects: at least one phase wave, at least one fractally encoded polarized data wave, at least two perpendicular signal channels such as wire or optical fiber, at least one phase switch 206. Data is input in the form of a fractal data signal onto one of the signal channels. The data flows along this signal channel. phase switches 206, present on at least some of the signal channel intersections, will activate when part of the input data signal matches the operating frequency and relative phase of the phase shift polarization component in relation to the fixed phase wave and the variable phase waves.

### Circuit Completion

At a high level, the role of the system is to to complete a circuit. It does this by using two types of circuit known as the trunk information potential 442 and the branch information potential 443. The trunk information potential 442 comprises existing phase switches 206. The branch information potential 443 comprises newly created phase switches 206. The simplest form of computation is a single phase switch 206 which routes a single frequency. In this situation, the input data signal and the operating frequency of the phase switch 206 form a resonance. In more complex cases, sets of phase switches 206 (compound resonators) will act on a fractally encoded data signal to eventually complete a circuit. Circuit completion can be achieved with one of the following, a) a principal information potential circuit b) a context information potential circuit c) a mix of principal and context information potential circuits. In this way, the set of phase switches 206 can be viewed as a pattern recognizer that recognizes more complex patterns of which the fractal data signal is comprised. Matching of patterns in the fractal data signal with the sets of phase switches 206 will then complete a circuit which will appear as a single phase switch 206 operating at a different scale. This phase switch 206 may then form part of a much larger fractal pattern recognizer circuit and so on to create a large and complex fractal circuit structure. Eventually all of the data in the input stream will have been processed and in consequence filtered out from the routed signal. At this point, processing will have reached its end point as all input data will have been processed. The data from the principals is filtered out from the bottom up. The data pulses from the context tree are filtered out from the top down. As long as the fractal computer understands all the data presented (fractal circuits exist and can be completed in respect of all the input data), then all data points will be used up and no data will be left to process and the fractal computer will be waiting for new inputs.

The complexity of the input data is determined by the number of frequency doubling in the data. The more frequency doublings then the more complex the data and the more fractal segments the resulting pattern matches will need to successfully decode the input data stream. Complexity of the patterns is determined by the number of frequencies. Moire specifically the number of doublings that are used to create the data signal. The simplest data signal will use one frequency with no doublings. The most complex patterns will use the maximum number of doublings that are supported by the current fractal computer implementation

There can also be multiple input data streams from multiple different locations for multiple phase switches 206 in the fractal computer. In this situation, all of the input data will work together as a single entity in order to find the solution which is the removal of all data points in the input data streams and on completion to complete a circuit by the correlation with a high level phase switch 206.

Part of the process of the circuit completion, is the burn in effect from repeated firings of the same input and output waves. This will initially lead to the link being retained for a short period of time but degrading slowly. The more concurrent firings leads to greater length of time the link is retained leading to an eventual burn in or permanent link being formed. This mechanism leads to emergent behavior in the fractal computation leading to the most amount of re-use of phase switches at signal channel intersections in fractal computation at multiple scales.

### Pattern Based Routing

An example is to show how the phase switches 206 can recognize patterns in the input data and route a signal from input signal channel one to output signal channel two. This can be done using a single phase switch 206. Given an input voltage and a signal waveform that comprises the patterns to be matched, an output pulse can be generated when the input signal pattern matches a predefined pattern. The predefined pattern being determined by the phase switch 206 and its connections to the surface quadrilateral mesh 64.

At locations where the modified phase of the input data wave and the modified phase of the variable phase wave are concurrent, the phase modified input data wave is channeled to the perpendicular output signal channel by the phase switch 206. The phase switch 206 will stay in a conducting state or ‘on’ position for a period of time proportional to the operating frequency of the phase switch 206. During the ‘on’ state of the phase switch 206, the fractal data signal flows from the input signal channel to the perpendicular output signal channel. The data will be channeled in this manner only if a match to a predefined pattern as defined by the phase switch 206 exists for the specific combination of data input wave and variable phase wave.

Extending this further, if either the variable phase wave frequency or the input data wave frequency is doubled one or more times, then exactly the same concurrence can occur and the data can still be routed in the same manner by principal phase switches 206 that comprise high pass filters. This self similar routing with respect to one or more doubling of frequency is an aspect of the fractal computation method. Similarly, if either the phase wave frequency or the input data wave frequency is halved one or more times, then exactly the same concurrence can occur and the data can still be routed in the same manner by context phase switches 206 that comprise low pass filters. This self similar routing with respect to one or more halving of frequency is a further aspect of the fractal computation method. This fractal routing is delimited by an upper frequency determined by the context phase switch 206 and a lower frequency determined by the principal phase switch 206. The fractal routing is restricted to this band of frequencies as determined by the operating frequencies of the principal phase switch 206 and the context phase switch 206. These two frequencies act as book ends with respect to fractal signal routing and processing in the present fractal circuit. Fractal based routing is possible over a wide band of frequencies. When a fragment of the present data signal falls outside the present routing band, it may still be routed fractally but by another fractal circuit with a different set of delimiting frequencies and a different operating band or spectrum of frequencies. Outside of the current band so defined, a data signal can still be routed fractally but in relation to a different band of frequencies in which the data signal frequency falls between. The fractal routing so described relates specifically to self similarity across frequency.

The fractal computation method is characterized in that said information potential comprising:

a trunk information potential, wherein said trunk information potential further comprising:
a principal information potential with a threshold characteristic of less than trigger signal;
a context information potential with a threshold characteristic of less than trigger signal;
a branch information potential, wherein said branch information potential further comprising:
a principal information potential with a threshold characteristic of more than trigger signal;
a context information potential with a threshold characteristic of more than trigger signal;
wherein said principal information potential comprising a plurality of phase switch units having a threshold characteristic that matches the threshold characteristic of said principal information potential, and further wherein said context information potential comprising phase switch units having a threshold characteristic that matches the threshold characteristic of said context information potential;
and wherein steps a) to k) are repeated for each of:
said trunk information potential;
said branch information potential;
wherein the steps for said branch information potential further comprising:
growing said branch information potential from the end of said trunk information potential until a closed circuit is formed;
forming a polarized connection between said input signal channel and said output signal channel, said polarized connection forming the essence of a higher level phase switch formed from the plurality of phase switches;
sending a programming pulse to all phase switches in said closed circuit;
altering the threshold triggers with said programming pulse; and,
optionally repeating input signals to further program said threshold triggers.

### Self Similar Routing

At a given phase clock frequency an input of a given signal can be routed to an output. At the same clock frequency with an input frequency of twice the previous signal, said input can be routed to the first output and additional routing can be done to route the signal to a second output. The routing via signal patterns in this manner is self similar across frequency. Also if the circuitry and signal wave are held constant and the phase wave is doubled, this increases the resolution and achieves the same effect in relation to the spatial aspect, that is to say, the routing via signal patterns is self similar across doublings of the phase signal. Self similarity is directly relevant as by doubling the phase clock frequency, we have in effect doubled the resolution at which the input data signals are resolved across the collection of phase switches 206 (quantized spatial medium).

The fractal computation method can be extended to include a plurality of input data signals and a plurality of output data signals that are routed using a plurality of phase switches 206.

When a fragment of the input data signal, comprising sequentially one or more higher frequencies of one or more times double the frequency, interacts with a plurality of phase switches 206, then a more complex pattern can be matched. This input data signal or patten which comprises multiple frequencies can still be routed fractally, as long as all of the input signals are multiples of double or multiples of halve the base frequency.

The principal phase switches 206 are connected to the principal variable phase wave. Similarly, the context phase switches 206 are connected to the context variable phase wave. When either or both of these variable phase waves are altered to be a either a multiple of double the frequency or a multiple of half the frequency, a similar type of fractal signal routing happens with respect to a spatial aspect of the processing. The effect of this is to section off a certain geographic space for computation. That is to say phase switches 206 to perform signal routing in a particular spatial domain comprise phase switches 206 that are activated with respect to these altered variable phase waves. As the data wave propagates outward, this process of selection imposes a spatial organization on the individual phase switches 206 used in the fractal routing circuit. In this regard, the principal variable phase wave and the context variable phase wave act as bookends on the spatial domain for the fractal circuit. The principal variable phase wave acts as the maximum spatial bound for a principal pattern. The context variable phase wave acts a the minimum spatial bound for the context pattern. A similar fractal circuit at multiples of double the space from present processing is also possible, however the nearer circuit will be formed first due to the effects of emergence resulting from higher incidence of occurrence and stronger data signals from the data wave propagation. The emergent behavior will favor the nearest area as being the one most appropriate to contain the computation. The local area defined by these bounds (the local area) is used in preference to other similar areas (non-local areas) at multiples of the wave period length out. There is nothing to stop a non-local area being used in preference for example if the local area develops a fault, but it will take a little longer for the data waves to propagate to the other areas. If for example, the nearest fractal spatial domain or local area is incomplete or damaged in some regard, fractal processing may not be able to function in that spatial domain. In this situation, the fractal processing can be done by an adjacent fractal spatial domain of a multiple of double the spatial distance out. All distance are relative to the data wave emission point.

### Fractal Structure

Data can be processed anywhere inside this local spatial domain. Once computation is complete within the local domain, the resulting output signal can then be used by a larger spatial domain of which the smaller spatial domain is a part. Processing thus has a fractal distribution of circuit elements with regard to spatial composition.

The fractal computation method characterized in that the step ‘comparing characteristics of said plurality of signals with characteristics of said first plurality of phase switches to generate a plurality of signal match characteristics’, further comprising the steps of:
extracting a phase shifted input signal in accordance with a phase characteristic of said phase switch;
extracting an interference signal by combining a propagated input signal, a phase shifted input signal, and a variable phase signal;
extracting a switch activation signal by comparing said interference signal with a threshold characteristic of said phase switch;
demodulating said input signal to produce a demodulated input signal;
phase shifting said demodulated input signal in accordance with an input phase characteristic of said phase switch, to produce a phase shifted demodulated input signal;
comparing the polarity of said phase shifted demodulated input signal with a polarity characteristic of said phase switch, to produce a polarization match characteristic;
filtering said phase shifted demodulated input signal, in accordance with a filtering characteristic of said phase switch, to produce a filtered phase shifted demodulated input signal;
and further wherein step f) ‘altering said plurality of signals in accordance with said signal match characteristics’ further comprising the steps of:
routing said filtered phase shifted demodulated input signal to an output signal in accordance with polarization match characteristic and switching signal characteristic; and,
phase shifting output signal in accordance with an output phase shift characteristic of said phase switch, to produce a phase shifted output signal.

### Parallel Processing

A fractal data signal input can be precessed from end to end as a single pattern or it can be processed as smaller fragments. The actions of emergence over the fractal circuit will initially cause the creation of a plurality of fractal circuits each of which process a fragment of the fractal data signal input. This plurality of fractal processing circuits functions together as in effect a sequence of layers wherein each layer providing a higher level processing in relation to the fractal data signal input. The processing in each one of the layers can be completely independent from other layers. Where a plurality of layers interact to effect processing at a higher level, each lower processing layer and data fragment must have first completed its processing. The ability to process data in this manner is exactly equivalent to a parallel processing system wherein the input data can be processed in parts and in parallel.

The fractal computation method is performed using a fractal computing device or fractal computer system as described in the present invention.

The fractal computation method further comprises the steps of:
modifying threshold trigger of said second plurality of phase switches;
modifying the amplitude of said first variable phase signal;
modifying the amplitude of said second variable phase signal;
changing the frequency divider unit of said first variable phase signal in accordance with a predefined step sequence;
changing the frequency divider unit of said second variable phase signal in accordance with said predefined step sequence; and,
optionally activating said phase switch by a second input derived from a second phase switch of which both said phase switch and said second phase switch form an operationally related pair.

### Further Alternative Embodiments

In an alternative embodiment, the fractal computation units are manufactured from periodically poled optical crystals such as potassium titanyl phosphate (KTP), lithium niobate or lithium tantalate. The periodic polling will allow the alpha and beta polarization components to be placed in the closest proximity possible allowing for the highest possible performance of a fractal computation unit based on light.

In an alternative embodiment, the four dimensional fractal computer unit comprising three spatial dimensions and one time dimension, is constructed from optical crystals of a single type. These are placed adjacent to each other so that light can pass from one crystal to the next cleanly. Typically the best arrangement for this will be alternating A, B types of crystal creating a checker board effect in three dimensions. The polarizations are represented by contrary rotations please see FIG. 49 thru FIG. 52. A type A fractal computer unit will have components or crystals that process the light with regard to the first rotation or polarization. A type B fractal computer unit will have components or crystals that process light with regard to a second rotation which is contrary to said first rotation or a second polarization that is opposite to said first polarization. Light for effecting processing in this optical computer comprises circular or rotating polarizations.

In an alternative embodiment, the fractal computer system or fractal computer device is built from a hybrid mix comprising both electrical and optical components. Any electrical component could be replaced with its functionally equivalent optical component. Likewise any optical component could be replaced with a functionally equivalent electronic component.

In an alternative embodiment, data wave propagation can be implemented by using a second X,Y surface quadrilateral mesh 64 that is rotated at 45 degrees to the first surface quadrilateral mesh 81. Each signal channel intersection of the original X,Y surface quadrilateral mesh 64 intersects with each signal channel intersection of the new X,Y surface quadrilateral mesh 64. The new surface quadrilateral mesh 64 has signal channels that are interrupted with delay components for alpha type fractal computing unit or beta type fractal computing unit or any combination thereof. The delays for the alpha components are in the parallel signal channels whereas the delays for the beta components are in the perpendicular signal channels to said first group of parallel signal channels.

In an alternative embodiment, as more and more fractal computation units are assembled together to form more and more complex systems, the data grid connecting the individual units can be condensed into fewer signal channels. That is to say, the number of signal channels used to connect fractal computation units functioning at different scales can be consolidated into fewer signal channels. Similarly the same consolidation occurring inside a single fractal computation unit will result in an arrangement of signal channels forming a surface quadrilateral mesh 64 pattern that has a higher signal channel density in some areas than in others. For example one fractal computation unit may function between a certain range of frequencies for all of its computations. This fractal computation unit may be connected to another fractal computation unit, however the number of data lines can be consolidated. Typically this would be done by reducing based on powers of 2. for example 16 data lines in the smaller fractal computer unit could be condensed to a single data line when the two units are joined together.

In an alternative embodiment, the medium used to manufacture the fractal computing device is non-uniform and comprises gaps and/or non-linear distribution of A and B fractal computing units. The basic rule is that there need to be at least one of each type of FCU component on each axis. If there are more FCU components present the type A and type B FCU components can be in any arrangement respective to each other or even completely random. Although a surface quadrilateral mesh of alternating type A and type B FCU components is the optimum design configuration, the fractal computer will still function if this alternating pattern is not followed. If there are gaps in the surface quadrilateral mesh structure, then the fractal computation will compensate as best as it can by utilizing other non-local areas of the surface quadrilateral mesh 64 to perform the tasks that would be done by the missing components. This allows the fractal computer to achieve fault tolerance and to still function although not as optimally.

In an alternative embodiment, the data signals are encoded and decoded using analog frequency modulation carrier waves. This design approach would be useful where miniaturization is not as important a factor. This approach allows a significantly greater number of frequency doublings to be achieved allowing for much more powerful computation in some areas. The doubling is in respect to the data signal timing and not with regard to the individual carrier wave frequency of the frequency modulated signal.

In an alternative embodiment, the data signals are encoded and decoded using digital frequency modulation carrier waves. This design approach would be useful where miniaturization is not as important a factor. This approach allows a significantly greater number of frequency doublings to be achieved allowing for much more powerful computation in some areas. The doubling is in respect to the data signal timing and not with regard to the individual carrier wave frequency of the frequency modulated signal.

In an alternative embodiment, the data signals are encoded and decoded using digital signals without a carrier wave.

In an alternative embodiment, the layout of the fractal computing units is on a surface of a spheroid. Said spheroid can be extended by adding fractal computing units to any cross section of said spheroid.

In an alternative embodiment, the layout of the fractal computing units is on a surface of a cuboid.

In an alternative embodiment, the layout of the fractal computing units is on a surface of a tube. Said tube can be extended to be longer or wider in circumference. Said tube can also be extended by adding fractal computing units to any cross section of said tube.

In an alternative embodiment, the layout of the fractal computing units is tiled in a uniform pattern or sequence of uniform patterns. Tiling may be different at different scales.

In an alternative embodiment, the materials used to fabricate a fractal computing unit comprising fiber optic signal channels.

In an alternative embodiment, the fractal computer method and embodiments comprise atomic and/or quantum scale materials and effects. The theory and principles of operation are consistent with the general principles of both relativity and Bohmian mechanics, however, both theoretical areas are extremely complex and have not been included herein so as not to obscure the present invention. To this end, a Bohmian mechanics embodiment of the fractal computation method would be possible, the only limiting factor here is the state of current materials science and technology. Further, to the degree that quantum mechanics is consistent with Bohmian mechanics (currently both theories are in full agreement with all known experiments ever performed), a quantum embodiment of the current method and embodiments in the form of a quantum computer or optical quantum computer is also possible. The only limited factor being the current state of material science and technology in relation to the construction of such a computer. As is explained earlier, other embodiments, even those that are not currently available due to manufacturing limitation, are not excluded. The invention in not limited by the exemplary embodiments provided these are for illustration only.

The foregoing description of the embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. Further, In the foregoing specification the invention has been described with reference to specific exemplary embodiments thereof. It will, however, be evident that various modification and changes may be made thereto without departure from the broader spirit and scope of the invention as set forth in the appended claims. The specification and drawings are, accordingly, to be regarded in an illustrative rather than restrictive sense. While operations are depicted in the drawings in a particular order, this should not be understood as requiring that such operations be performed in the particular order shown or in sequential order, or that all illustrated operations be performed, to achieve desirable results.

Moreover, the separation of various system components in the embodiments described above should not be understood as requiring such separation in all embodiments, and it should be understood that the described components and systems can generally be integrated together in a single product or packaged into multiple products.

Thus, particular embodiments have been described. Other embodiments are within the scope of the following claims. For example, the actions recited in the claims can be performed in a different order and still achieve desirable results.

The fractal computation method is further characterized in that the step ‘changing the frequency divider unit in accordance with a predefined step sequence’ further comprising, either singularly or in combination thereof, the further steps of:
increasing said first frequency divider unit to further halve the frequency of said first variable phase signal;
increasing said first frequency divider unit to further halve the frequency of said second variable phase signal;
increasing said second frequency divider unit to further halve the frequency of said first variable phase signal;
increasing said second frequency divider unit to further halve the frequency of said second variable phase signal;
decreasing said first frequency divider unit to further halve the frequency of said first variable phase signal;
decreasing said first frequency divider unit to further halve the frequency of said second variable phase signal;
decreasing said second frequency divider unit to further halve the frequency of said first variable phase signal;
decreasing said second frequency divider unit to further halve the frequency of said second variable phase signal; and,
alternating modifying first frequency divider unit and second frequency divider unit.

Having described my invention, I claim:

1. A fractal computing unit (FCU) comprising:
a clock signal;
a propagation unit comprising: a plurality of signal channels; a plurality of phase switch units; and, a plurality of delay units;
at least one data signal comprising at least one wave having a frequency in accordance with the equation f=(frequency of said clock signal)/2ⁿ, wherein n is an integer and n≧1, and f is the frequency of said at least one wave; and,
at least one input, wherein said at least one input sending said at least one data signal to at least one signal channel of said plurality of signal channels;
wherein said plurality of delay units operationally coupled to a said plurality of signal channels,
wherein said data signal propagates to said plurality of signal channels, wherein at least one signal channel of said plurality of signal channels operationally coupled to at least one phase switch unit of said plurality of phase switch units, wherein said at least one phase switch unit having an operating frequency in accordance with the equation f=(frequency of said clock signal)/2ⁿ, wherein n is an integer and n≧1 and wherein f is the frequency of said operating frequency.

2. The fractal computing unit in claim 1, wherein said plurality of signal channels spatially arranged in the form of a surface quadrilateral mesh, wherein said plurality of signal channels logically divided into two functional groupings comprising: a first signal channel grouping and a second signal channel grouping, wherein said first signal channel grouping operationally coupled to said second signal channel grouping by said plurality of phase switch units and wherein, spatially, intersecting signal channels along the length of said at least one signal channel sequentially alternate between the two functional groupings;
wherein said fractal computing unit further comprising:
a first variable clock signal derived from said clock signal;
a second variable clock signal derived from said clock signal;
a first signal channel of said first signal channel grouping;
a second signal channel of said second signal channel grouping;
a third signal channel of said first signal channel grouping, wherein said third signal channel adjacent to said first signal channel;
a fourth signal channel of said second signal channel grouping wherein said fourth signal channel adjacent to said second signal channel;
a gate signal channel group comprising, said first signal channel, said second signal channel, said third signal channel, said fourth signal channel; and,
a phase clock channel group further comprising:
a first variable phase clock signal channel, wherein said first variable phase clock signal channel receiving said first phase clock signal; and,
a second variable phase clock signal channel, wherein said second variable phase clock signal channel receiving said second phase clock signal;
wherein said at least one phase switch comprising:
a first delay unit;
a second delay unit;
a third delay unit;
a modulating unit having a carrier frequency equal to the frequency of said phase clock signal;
a demodulating unit having a carrier frequency equal to the frequency of said phase clock signal;
a filter unit;
a variable signal amplifier; and,
at least one switching unit comprising: at least one input; at least one output; and at least one gate;
wherein said at least one input operationally coupled by a demodulator unit to said first signal channel or by said first delay unit in combination with said demodulator unit to said first signal channel,
wherein said at least one output operationally coupled by said filter unit in combination with said modulator unit to said second signal channel or by said second delay unit in combination with said filter unit in combination with said modulator unit to said second signal channel, and wherein said at least one gate operationally coupled by said variable signal amplifier to one signal channel of said gate signal channel group or by said third delay in combination with said variable signal amplifier to one signal channel of said gate signal channel group, wherein said at least one gate further operationally coupled to one signal channel of said phase clock channel group.

3. The fractal computing unit in claim 2, wherein said plurality of signal channels operationally coupled to a plurality of three signal channel delay units, wherein each three signal channel delay unit of said plurality of three signal channel delay units operationally coupled to two adjacent parallel signal channels and a perpendicular signal channel; wherein said each three signal channel delay unit comprising a phase switch or a phase shift oscillator, or any combination thereof;
wherein said analog propagation unit further comprising:
a first phase shift unit;
a second phase shift unit;
a third phase shift unit;
a fourth phase shift unit;
a first fixed phase signal derived from said phase signal; and,
a second fixed phase signal derived from said phase signal and phase shifted by said first phase shift unit;
wherein said first signal channel grouping receiving a first fixed phase signal along a first axis and a second axis, and further receiving a second fixed phase signal along said first axis and said second axis wherein said second fixed phase signal shifted by a third phase shift unit; and,
wherein said second signal channel grouping receiving said second fixed phase signal along said said first axis and said second axis, and further receiving said first fixed phase signal along said first axis and said second axis, wherein said first fixed phase signal shifted by a fourth phase shift unit.

4. The fractal computing unit in claim 2, wherein said at least one data signal comprising:
a plurality of waves, wherein each wave of said plurality of waves having a frequency f derived from the following equation, f=(frequency of said phase clock signal)/2ⁿ where n is a positive integer and n≧1, and wherein said each wave synchronized with an external phase clock, and wherein a first polarized half wave of said each wave representing a first quaternary bit and a second polarized half wave of said each wave representing a second quaternary bit thus forming a quaternary fractal signal;

5. The fractal computing unit in claim 2, comprising:
a first frequency divider;
a second frequency divider;
a first variable phase signal derived from said phase signal and divided by said first frequency divider unit, or derived from a second signal, or any combination thereof;
a second variable phase signal derived from said phase signal, wherein said phase signal phase shifted by a second phase shift unit and further divided by a second frequency divider unit or derived from a third signal, or any combination thereof; and,
an output signal, wherein said phase switch upon switching to an active state, routing said input signal to said output, wherein said switching to an active state triggered by an interference signal received on said gate of said phase switch, wherein said interference signal exceeds the trigger threshold of said phase switch, wherein said signal optionally amplified by said threshold amplifier, and wherein said threshold trigger optionally lowered by said programming signals; wherein said interference signal comprising a combination of said input signal, said propagated signal, said variable phase wave signal, and said fixed phase wave signal.

6. The fractal computing unit in claim 2, characterized in that said FCU is a type A FCU, or a type B FCU, or a combined type AB FCU,
wherein said polarization of each phase switch of said type A FCU is a first polarization;
wherein said polarization of each phase switch of said type B FCU is a second polarization;
wherein said polarization of each phase switch of said type AB FCU is a first polarization or a second polarization.

7. The fractal computing unit in claim 2, wherein said phase switch comprising quantum scale components and utilizing quantum effects;

8. The fractal computing unit in claim 2, characterized in that said FCU is a two dimensional spatio-temporal fractal computer unit, or a three dimensional spatio-temporal fractal computer unit, or a four dimensional spatio-temporal fractal computer unit, or an n-dimensional fractal computer unit, or any combination thereof;
wherein said two dimensional spatial-temporal fractal computing unit characterized in that said plurality of signal channels of said super mesh arranged forming a mesh of parallel signal channels, wherein said phase shift units comprising a phase shift selected from the group consisting of: 0′, 180;
wherein said three dimensional spatial-temporal fractal computing unit characterized in that said plurality of signal channels of said super mesh arranged forming a two dimensional surface quadrilateral mesh, wherein said phase shift units comprising a phase shift selected from the group consisting of: 0′, 90′, 180′, 270′;
wherein said four dimensional spatial-temporal fractal computing unit characterized in that said plurality of signal channels of said super mesh arranged forming a three dimensional hexahedron mesh, wherein said phase shift units comprising a phase shift selected from the group consisting of: 0′, 60′, 120′, 180′, 240′, 300′;
wherein said n-dimensional spatial-temporal fractal computing unit characterized in that said plurality of signal channels of said super mesh arranged forming a three dimensional hexahedron mesh, wherein said phase shift units comprising a phase shift conforming to the equation x*360/n where n is the spatial-temporal dimension and x is an integer where x≧0.

9. The fractal computing unit in claim 5, wherein said switching unit further comprising a threshold unit having a threshold characteristic selected from the group consisting of: automatically alterable by a signal produced by said fractal computing unit (FCU), alterable by an external signal, alterable by an external wave, alterable by a pulse, alterable and set at the time of manufacture, unalterable and set at the time of manufacture, or any combination thereof.

10. The fractal computing unit in claim 5, wherein said phase switch comprising an optical transistor.

11. The fractal computing system in claim 5, wherein said fractal computing system comprising:
a two dimensional fractal computer unit (2-D FCU), or a three dimensional fractal computer unit (3-D FCU), or a four dimensional fractal computer unit (4-D FCU), or an n-dimensional fractal computer unit (N-D FCU), or any combination thereof,
wherein each said fractal computer unit (FCU) comprising said combination thereof, operationally coupled thus forming a multi-dimensional fractal computing system.

12. A fractal computing system comprising:
a clock;
at least one signal comprising at least one wave wherein said at least one wave having a frequency in accordance with the equation f=(frequency of said clock)/2ⁿ, wherein n is an integer and n≧1 and f is the frequency of said at least one wave;
a second wave having a frequency in accordance with the equation f=(frequency of said clock)/2ⁿ, wherein n is an integer and n≧1 and f is the frequency of said second wave; and, means to conditionally route said at least one signal based on the relative frequency, or phase or polarity, or any combination thereof, of said at least one wave with respect to said second wave.

13. The fractal computer system of claim 12 wherein said means to conditionally route comprising at least one crystal, wherein said crystal selected from the group consisting of: nanocrystal, quantum dot, periodically polled crystal, Lithium Niobate crystal, Lithium Tantalate crystal, twisted nematic liquid crystal, optical lattice crystal, rare earth doped laser crystal, rare earth ion doped crystal, indium tin oxide crystal, carbon nanotube crystal, graphene crystal, flouride doped tin oxide crystal, doped zinc oxide crystal, nanowire crystal, or any combination thereof.

14. The fractal computing system of claim 12 wherein said fractal computing system performing at least one application of artificial intelligence (AI) or operatively coupled to a system performing at least one application of artificial intelligence (AI), wherein said performing at least one application of artificial intelligence (AI) comprising: machine learning, speech recognition, natural language understanding, audition systems, computer vision systems, image processing, movement systems, robotics, artificial speech, face recognition systems, expert systems, medical diagnosis, robot control, language translation, machine driving or any combination thereof.

15. The fractal computing system in claim 12, wherein said means to conditionally route comprising at least one FCU,
wherein said fractal computing system further comprising a plurality of fractal computer units (FCUs) wherein said plurality of fractal computer units are operationally coupled and further wherein the spatial distribution of said plurality of fractal computer units selected from the group consisting of: a sequentially repeating tiling pattern,
a sequentially repeating quadrilateral surface formed on the surface of a cylinder,
a sequentially repeating quadrilateral surface tiling pattern formed on the surface of a cube,
a sequentially repeating quadrilateral surface tiling pattern formed on the surface of a cuboid,
a sequentially repeating quadrilateral surface tiling pattern formed on the surface of a spheroid,
an arbitrary spatial distribution,
a periodically changing dynamic spatial distribution,
an expanding FCU distribution resulting from the dynamic addition of an FCU,
a contracting FCU distribution resulting from the dynamic removal of an FCU;
an expanding FCU distribution resulting from the dynamic addition of a plurality of FCUs,
a contracting FCU distribution resulting from the dynamic removal of a plurality of FCUs,
a dynamic spatial configuration of FCUs operationally coupled to a network,
a static spatial configuration of FCUs operationally coupled to a network,
a second plurality of fractal computer units operationally coupled to at least one fractal computer unit of said plurality of fractal computer units thus forming a nested parallel fractal computer system,
or any combination thereof.

16. A method of fractal computation comprising the steps of:
a) receiving a first plurality of inputs;
b) generating a plurality of signals from said plurality of inputs;
c) sending said plurality of signals along a first plurality of signal channels;
d) receiving said plurality of signals by an information potential, wherein said information potential comprising a first plurality of phase switches operationally coupled to said first plurality of signal channels;
e) comparing characteristics of said plurality of signals with characteristics of said first plurality of phase switches to generate a plurality of signal match characteristics;
f) altering said plurality of signals in accordance with said signal match characteristics;
g) routing said plurality of signals to a second plurality of signal channels in accordance with said signal match characteristic;
h) forming a plurality of closed loops (circuits) each comprising a second plurality of phase switches;
i) propagating said plurality of signals with a plurality of time delay units in synchronism with a phase clock signal;
j) creating said first plurality of inputs from a second plurality of inputs in combination with said plurality of signals;
k) advancing the phase clock signal; and,
l) repeating steps a) to k) until there are no further signals of said plurality of signals.

17. The method in claim 16 wherein said information potential comprising:
a trunk information potential, wherein said trunk information potential further comprising:
a principal information potential with a threshold characteristic of less than trigger signal;
a context information potential with a threshold characteristic of less than trigger signal;
a branch information potential, wherein said branch information potential further comprising:
a principal information potential with a threshold characteristic of more than trigger signal;
a context information potential with a threshold characteristic of more than trigger signal;
wherein said principal information potential comprising a plurality of phase switch units having a threshold characteristic that matches the threshold characteristic of said principal information potential, and further wherein said context information potential comprising phase switch units having a threshold characteristic that matches the threshold characteristic of said context information potential;
and wherein steps a) to k) are repeated for each of:
said trunk information potential;
said branch information potential;
wherein the steps for said branch information potential further comprising:
growing said branch information potential from the end of said trunk information potential until a closed circuit is formed;
forming a polarized connection between said input signal channel and said output signal channel, said polarized connection forming the essence of a higher level phase switch formed from the plurality of phase switches;
sending a programming pulse to all phase switches in said closed circuit;
altering the threshold triggers with said programming pulse; and,
optionally repeating input signals to further program said threshold triggers.

18. The method in claim 16 wherein step e) ‘comparing characteristics of said plurality of signals with characteristics of said first plurality of phase switches to generate a plurality of signal match characteristics’, further comprising the steps of:
extracting a phase shifted input signal in accordance with a phase characteristic of said phase switch;
extracting an interference signal by combining a propagated input signal, a phase shifted input signal, and a variable phase signal;
extracting a switch activation signal by comparing said interference signal with a threshold characteristic of said phase switch;
demodulating said input signal to produce a demodulated input signal;
phase shifting said demodulated input signal in accordance with an input phase characteristic of said phase switch, to produce a phase shifted demodulated input signal;
comparing the polarity of said phase shifted demodulated input signal with a polarity characteristic of said phase switch, to produce a polarization match characteristic;
filtering said phase shifted demodulated input signal, in accordance with a filtering characteristic of said phase switch, to produce a filtered phase shifted demodulated input signal;
and further wherein step f) ‘altering said plurality of signals in accordance with said signal match characteristics’ further comprising the steps of:
routing said filtered phase shifted demodulated input signal to an output signal in accordance with polarization match characteristic and switching signal characteristic; and,
phase shifting output signal in accordance with an output phase shift characteristic of said switch ing signal router, to produce a phase shifted output signal.

19. The method in claim 18 further comprising the steps of:
modifying threshold trigger of said second plurality of phase switches;
modifying the amplitude of said first variable phase signal;
modifying the amplitude of said second variable phase signal;
changing the frequency divider unit of said first variable phase signal in accordance with a predefined step sequence;
changing the frequency divider unit of said second variable phase signal in accordance with said predefined step sequence; and,
optionally activating said phase switch by a second input derived from a second phase switch of which both said phase switch and said second phase switch form an operationally related pair.

20. The method in claim 19 wherein the step sequence of the step ‘changing the frequency divider unit in accordance with a predefined step sequence’ further comprising, either singularly or in combination thereof, the further steps of:
increasing said first frequency divider unit to further halve the frequency of said first variable phase signal;
increasing said first frequency divider unit to further halve the frequency of said second variable phase signal;
increasing said second frequency divider unit to further halve the frequency of said first variable phase signal;
increasing said second frequency divider unit to further halve the frequency of said second variable phase signal;
decreasing said first frequency divider unit to further halve the frequency of said first variable phase signal;
decreasing said first frequency divider unit to further halve the frequency of said second variable phase signal;
decreasing said second frequency divider unit to further halve the frequency of said first variable phase signal;
decreasing said second frequency divider unit to further halve the frequency of said second variable phase signal; and,
alternating modifying first frequency divider unit and second frequency divider unit.
